(19) United States
(12) Patent Application Publication
(10) Pub. No.: US 2024/0177145 A1
(43) Pub. Date: May 30, 2024

(54) COMPUTER IMPLEMENTED TECHNIQUES FOR FACILITATING PROMOTIONAL CAMPAIGNS, MARKET-MAKING, AND REGULATORY COMPLIANCE ACTIVITIES RELATING TO BLOCKCHAIN-BASED DIGITAL ASSETS

(71) Applicant: Lucky Hive Ventures LLC, Norwell, MA (US)

(72) Inventors: Andrea Miele, Norwell, MA (US); Jessica Diorio Dunn, Milton, GA (US); Dean Wolf, Boulder, CO (US); Pratik Kadam, Kitchener (CA); Joseph Frank Ioia, Sunrise, FL (US)

(73) Assignee: Lucky Hive Ventures LLC, Norwell, MA (US)

(21) Appl. No.: 18/520,534

(22) Filed: Nov. 27, 2023

Related U.S. Application Data
(60) Provisional application No. 63/385,033, filed on Nov. 27, 2022.

(51) Int. Cl. G06Q 20/36

(52) U.S. Cl. CPC G06Q 20/3678

(57) ABSTRACT

Various aspects described herein for implementing computer implemented techniques for facilitating promotional campaigns, market-making, and regulatory compliance activities relating to blockchain-based digital assets. At least one aspect of the present disclosure is directed to techniques for managing and facilitating transactions in digital assets and physical collectibles using blockchain technology, including minting, revealing, and offering automated buyback functionalities for Non-Fungible Tokens (NFTs) and Physical Collectibles (RWAs).

### RELATED APPLICATION DATA

The present application claims benefit, pursuant to the provisions of 35 U.S.C. § 119, of U.S. Provisional Application Ser. No. 63/385,033 (Attorney Docket No. LUCKP001P), titled “COMPUTER IMPLEMENTED TECHNIQUES FOR FACILITATING PROMOTIONAL CAMPAIGNS ANDMARKET-MAKING ACTIVITIES RELATING TO BLOCKCHAIN-BASED DIGITAL ASSETS”, naming Miele et al. as inventors, and filed Nov. 27, 2022, the entirety of which is incorporated herein by reference for all purposes.

### BACKGROUND

The field of blockchain technology, particularly in relation to Non-Fungible Tokens (NFTs) and digital collectibles, has witnessed significant growth and interest. However, the market for NFTs and digital collectibles face several challenges inherent in existing blockchain systems. These challenges have notably shaped the direction of current technological developments.

Traditionally, blockchain systems often lacked efficient mechanisms for providing immediate financial liquidity for holders of NFTs and digital collectibles. This limitation makes the process of converting digital assets into a more liquid form complex and time-consuming for asset holders. The absence of quick liquidity solutions in blockchain technology not only hindered the flexibility and attractiveness of NFT investments but also restricted the broader adoption of these assets in conventional financial markets.

Another major challenge in the existing landscape is the limited capabilities in offer handling for digital collectibles, especially in scenarios where collections mint out at various percentages. Existing systems do not efficiently address the optimization of value realization for digital collectibles. This inefficiency often leads to suboptimal financial outcomes for collectors and creators alike, as they struggle to maximize the value of their digital assets within the constraints of the available blockchain infrastructure.

Furthermore, blockchain systems and platforms for NFTs and digital collectibles often fail to adequately respond to dynamic market conditions. The lack of mechanisms to balance supply and demand effectively in the marketplace often leads to potential oversupply or scarcity of digital assets. This imbalance posed a significant challenge, impacting the market stability and the perceived value of NFTs and digital collectibles.

The current state of blockchain technology, especially in relation to NFTs and digital collectibles, presents significant limitations in terms of asset liquidity, efficient offer handling, promotional capability and dynamic market response, and regulatory compliance.

### BRIEF DESCRIPTION OF THE DRAWINGS

FIG. 1 illustrates a simplified block diagram of a specific example embodiment of a portion of a computerized data network.

FIG. 2 shows an example data network architecture embodiment of a Data Network 200.

FIG. 3 is a simplified block diagram of an exemplary client system Mobile Device 300 in accordance with a specific embodiment.

FIG. 4 illustrates an example embodiment of a System Server 480 which may be used for implementing various aspects/features described herein.

FIG. 5 illustrates an example of a functional block diagram of a Colony Platform Server System 500 in accordance with a specific embodiment.

FIG. 6 shows an example flow diagram of an NFT Minting Procedure 600 in accordance with one embodiment.

FIG. 7 shows an example flow diagram of an NFT Reveal Procedure 700 in accordance with one embodiment.

FIG. 8 shows an example flow diagram of an NFT Marketplace Sell Procedure 800 in accordance with one embodiment.

FIG. 9 shows an alternate embodiment of an NFT Buyback Procedure 900.

FIG. 10 shows an example flow diagram of an NFT Reveal/Buyback Procedure 1000 in accordance with one embodiment.

FIG. 11 shows a flow diagram of an NFT Collection Mint-Reveal-Buyback procedure illustrating one example embodiment of an NFT Collection Mint-Reveal-Buyback procedural flow which is executed by one or more components of the Colony Platform.

FIG. 12 shows a flow diagram of an NFT Buyback procedure illustrating one example embodiment of a flow which is executed by one or more components of the Colony Platform.

FIGS. 13-19 illustrate representations of various types of NFT collection campaign configuration parameters and associated data relating to different example embodiments of NFT collection campaigns

FIG. 20 shows an example embodiment of a system interaction and flow diagram demonstrating various interactions between the Colony Platform's Backend components (2001) & Front End components (2005) components and Smart Contract components (2003, 2010, 2011, 2012, 2013) of the blockchain layer.

FIG. 21 shows an example embodiment of a Mint-Buyback Funds Distribution Procedure, illustrating various functionalities and procedural flows of the Colony Platform relating to the distribution of revenue generated from an NFT mint, in accordance with predefined rules.

FIG. 22 shows an example of a Buyback Offer NFT Collection Procedure 2200

FIG. 23 shows an example of a Buyback Offer Collectible Drop Procedure 2300, demonstrating a specific embodiment executed by one or more components of the Colony Platform.

FIG. 24 shows an example embodiment of a Collectibles Tokenization Procedure.

FIG. 25 shows an example embodiment of a Tokenized Collectibles Drop configuration process.

FIG. 26 shows an example embodiment of a Buyer-side Tokenized Collectibles Drop Flow.

FIG. 27 shows an example embodiment of a Buy Packs (Collectibles Drop) Flow.

FIG. 28 shows an example embodiment of a tokenized Collectibles Drop Funds Distribution Procedure.

FIG. 29 shows an example embodiment of a Physical Collectible Asset Claim Procedure.

FIG. 30 shows an example embodiment of a Digital Asset Return/Refund Regulatory Compliance Procedure.

FIGS. 31-65 illustrate example screenshots of various graphical user interfaces (GUIs) which are configured or designed to facilitate activities relating to one or more of the Colony Platform's features, procedures and/or process flows disclosed herein.

### DETAILED DESCRIPTION OF EXAMPLE EMBODIMENTS

### Overview

Various aspects described or referenced herein are directed to different methods, systems, and computer program products for implementing computer implemented techniques for facilitating promotional campaigns, market-making, and regulatory compliance activities relating to blockchain-based digital assets.

At least one aspect of the present disclosure is directed to computer-implemented methods, systems and techniques for managing and facilitating transactions in digital assets and physical collectibles (RWA real world assets) using blockchain technology, including minting, revealing, and offering automated buyback functionalities for Non-Fungible Tokens (NFTs) and Physical Collectibles (RWAs), as well as providing secure storage and regulatory compliance solutions within a unified platform. In at least one embodiment, the computer-implemented methods, systems and techniques described herein may be offered or provided by way of an online system or platform (herein the “Colony Platform”).

The Colony Platform is a pioneering integration of internet and blockchain technology, enhancing user experiences, market stability, and regulatory compliance with respect to both digital asset (e.g., NFT) transactions and tokenized physical collectible transactions. The Colony Platform hosts a dynamic blend of a launchpad and marketplace functionality, providing an integrated platform for the creation, sale, and exchange of both physical collectibles and NFTs. This dual functionality allows it to cater to a wide array of users, from creators and collectors to traders and investors. The inclusion of gamified elements in the platform enhances user engagement. This approach not only makes the experience more enjoyable but also incentivizes participation and interaction within the platform, creating a vibrant and active community.

The Colony Platform tackles the challenge of bridging the physical and digital worlds through its “phygital” approach: tokenizing physical assets on-chain. This strategy enables physical collectibles to be traded and managed in the digital realm in real time, expanding their accessibility and market reach.

The Colony Platform addresses the critical issue of supply-demand dynamics, across both the NFT and Collectibles markets. For example, for NFT's: by creating deflationary NFT collections and by utilizing a significant portion (e.g., 75%) of mint revenue for funding NFT buyback offers, this helps to facilitate a stable and balanced market that is less prone to the volatility often seen in the NFT space. Post-mint, the Colony Platform provides NFT purchasers/owners with a virtual safety net, enabled via instant liquidity buyback offers for their NFTs. This feature adds a layer of financial security and stability, ensuring that NFT owners are not left vulnerable post-launch.

For Collectibles, the Colony's approach to tokenizing physical assets simplifies the selling process for vendors and enhances the buying experience for consumers, while providing collect holders and buyers the unique opportunity for an immediate buyback offers once a collection is launched, based on a wide variety of criteria—set by the original collection holder—providing both opportunity and the ability to balance the supply and demand. Sellers benefit from an expanded market, no longer limited by geographical constraints, while buyers enjoy the convenience of purchasing rare and valuable items from anywhere globally.

Notably, the Colony Platform provides automated buyback offer functionality as well as automated regulatory compliance solutions. The automated buyback offer functionality enabled by the Colony Platform introduces a suite of significant benefits, advantages, and use cases that enhance the value and utility of NFTs and tokenized assets across various sectors. Examples of some of the various benefits, advantages, and use cases of the automatic buyback offer functionality may include, but are not limited to, one or more of the following (or combinations thereof):
Instant Liquidity for NFT Collections and NFT-Tokenized Physical Collectibles: One of the primary benefits of the automated buyback offer functionality is the provision of instant liquidity for both NFT collections and NFT-tokenized physical collectibles. This feature allows NFT owners to quickly convert their digital or tokenized physical assets into liquid assets. Such instant liquidity is particularly advantageous in markets where asset values can fluctuate rapidly, providing NFT owners with a reliable and immediate exit strategy. This functionality ensures that collectors and investors can manage their portfolios with greater confidence, knowing they have the option to liquidate assets without the usual delays or uncertainties associated with finding a buyer in the open and/or secondary market.
Regulatory Compliance for Businesses Launching NFT Collections: In the realm of legal and regulatory compliance, the automated buyback offer functionality may be deployed or adapted to provide regulatory compliance services for businesses launching NFT collections, helping to ensure that businesses are operating in compliance with relevant legal and regulatory standards, particularly those relating to consumer protection laws and regulations governing digital asset transactions. This service provides a much-needed solution for mitigating the risk of non-compliance, and offering a compliant framework for businesses to operate within legal boundaries while still leveraging the benefits of blockchain technology.
Automated Market Maker (AMM) Functionality for Non-Fungible Digital Assets/Tokens: The automated buyback offer functionality may also be adapted to serve as an automated market maker (AMM) for Non-Fungible digital assets or tokens. For instance, it can be configured to maintain a specified minimum floor value for an NFT collection. This may be accomplished, for example, by configuring a buyback offer smart contract to automatically generate and submit a “minimum floor” buyback offer (eg, $1) for each NFT in the collection. This essentially provides a guarantee to the owners of the NFT's of the collection that they are able to sell each of their NFT's for the specified minimum floor value (eg $1) offered by the buyback offer smart contract. Accordingly, this serves as a disincentive for any NFT owner to sell their NFT for less than $1. By setting a “minimum floor” buyback offer (e.g., $1) for each NFT in the collection, the smart contract ensures that the value of these assets does not fall below this threshold. This approach not only provides a safety net for NFT owners but also stabilizes the market, discouraging owners from selling their NFTs at undervalued prices. This functionality is particularly beneficial in maintaining the economic stability of NFT ecosystems, especially in volatile market conditions.
Use in Online Gaming Environments for Lottery-Type Functionality—In online gaming environments, the automated buyback offer functionality may be deployed to enable innovative lottery-type applications and use cases. For example, in one embodiment, users may mint or purchase “lottery ticket” NFTs from a specific collection, wherein ownership of a lottery ticket NFT provides the owner with a future opportunity to redeem, surrender, swap, or exchange the lottery ticket NFT for newly minted NFT having randomly generated traits and attributes from a second NFT collection. A buyback offer smart contract may be deployed to determine a composite trait score and corresponding buyback offer amount for the newly minted NFT, and to submit or present a buyback offer to purchase the newly minted NFT for the buyback offer amount. One advantage of implementing an NFT lottery-type gaming system in this manner is that it can be deployed and operated in a legally compliant manner, without violating jurisdictional/regulatory gambling laws.
Use cases involving Marketing and Promotional Campaigns relating to NFT collections: The Colony Platform's automatic buyback offer functionality, enabled by smart contracts, may be advantageously leveraged in various types of marketing and promotional campaigns relating to NFT collections, and further enables the ability to launch new types of innovative and creative promotional and marketing campaigns, greatly enhancing the appeal of NFTs to potential buyers. For example, for new NFT collection launches, the Colony Platform enables the ability to introduce limited-time enhanced buyback offers, incentivizing early purchases and generating significant initial buzz. For instance, offering a higher buyback rate during the first week of a new collection's launch encourages swift acquisitions, amplifying launch excitement. In another use case example, the Colony platform may be utilized to incorporate promotional buyback tiers based on user engagement. Actions such as sharing the NFT on social media or participating in community events can temporarily elevate the buyback value, fostering a more engaged and active community. Seasonal or event-based buyback promotions further extend the platform's marketing capabilities. Aligning buyback offers with events like Christmas or Halloween can lead to themed marketing campaigns, where NFTs tied to these events may carry higher buyback values, enhancing seasonal sales. Collaborations with influencers or notable brands represent another strategic use case. For example, exclusive NFTs released through these partnerships, accompanied by special buyback offers, can garner widespread attention and appeal. leveraging the influencers' reach and reputation. In another example use case, the Colony Platform may provide functionality for rewarding loyal/frequent collectors with improved buyback offers, reinforcing loyalty and encouraging ongoing engagement with the platform's collections. Such loyalty rewards not only appreciate longstanding collectors but also motivate continued participation in future collections. In this way, the buyback offer functionality of the Colony platform melds marketing ingenuity with blockchain technology, creating a multifaceted approach that enhances the attractiveness, value, and engagement of NFT collections.

One aspect disclosed herein is directed to different methods, systems, and computer program products for managing a Non-Fungible token (NFT) buyback process in a digital asset management platform. In at least one embodiment, various method(s), system(s) and/or computer program product(s) may be operable to cause at least one processor to execute a plurality of instructions stored in non-transient memory for: Initiating a connection between a user's digital wallet and a Buyback Smart Contract Interface, wherein the digital wallet contains at least one NFT: Submitting a request by the user to receive a buyback offer for an identified NFT, wherein the NFT can be in an unrevealed or revealed state; Logging the buyback offer request with a timestamp for recordkeeping purposes by the smart contract; Checking the eligibility of the identified NFT for a buyback offer, wherein the system evaluates if the NFT qualifies based on predefined criteria, including its status within the collection as unrevealed or revealed; Confirming the availability of a buyback offer for the specific NFT through the smart contract; Calculating a buyback offer amount for the identified NFT, where the amount for an unrevealed NFT may be randomly selected from a pool of predetermined amounts, and for a revealed NFT, the amount may be based on a calculated rarity score, a composite trait score, or randomly selected from predetermined buyback offer amounts; Presenting the calculated buyback offer, including the offer amount and terms, to the user via the platform; Providing the user with the opportunity to review the buyback offer and decide whether to accept or decline it; Transferring the NFT from the user's wallet to a designated blockchain address, such as a burn address, if the user accepts the buyback offer; Transferring funds corresponding to the buyback offer amount to the user's wallet upon the completion of the NFT transfer; Logging the completion of the transaction and updating the NFT's status in the smart contract's records; Maintaining the NFT in the user's wallet if the user declines the buyback offer, with the NFT retaining its status and eligibility for future buyback opportunities; and Offering the user the option to initiate another buyback offer request for the identified NFT following a declined offer.

Another aspect disclosed herein is directed to different methods, systems, and computer program products for processing return or refund requests for digital assets, specifically Non-Fungible tokens (NFTs), in compliance with consumer protection laws and regulations. In at least one embodiment, various method(s), system(s) and/or computer program product(s) may be operable to cause at least one processor to execute a plurality of instructions stored in non-transient memory for: Establishing a connection between a user's digital wallet and a Digital Asset Return/Refund Smart Contract Interface to initiate a return or refund request for a specific NFT: Initiating a return or refund request by the user for a specific NFT, involving the user identifying the NFT within their digital wallet and formally requesting a refund through the platform's interface: Accessing the user's Know Your Customer (KYC) information to verify the user's identity and ensure the legitimacy of the return/refund request: Utilizing the user's KYC information to identify jurisdiction-specific laws and regulations applicable to the return/refund request; Retrieving historical transaction details of the identified NFT from the blockchain to establish its provenance and transaction history; Evaluating the return/refund eligibility of the identified NFT based on jurisdictional laws and regulations, as well as the historical blockchain transaction details; Considering various criteria to determine eligibility for a return/refund, including time window for returning the digital purchase, blockchain transaction history, original purchaser verification, consumption of NET content, and original purchase agreement terms; Deciding whether the identified NFT is eligible for return/refund based on the assessments made in the previous steps; Initiating the processing of the Digital Asset Return/Refund Request upon confirming the eligibility of the NFT: Presenting a Confirmation Graphical User Interface (GUI) to the user. showing predicted transaction details for the refund, for the user's review and authorization: Facilitating the transfer of the identified NFT from the user's wallet to a designated return wallet or address via a smart contract; Transferring the predetermined refund amount to the user's wallet concurrently with the NFT transfer; and Recording the details of the return/refund transaction in a database, including information about the returned NFT, refund amount, and transaction timestamps.

Another aspect disclosed herein is directed to different methods, systems, and computer program products for managing a buyback offer for tokenized collectible Non-Fungible tokens (NFTs) within a digital asset management platform. In at least one embodiment, various method(s), system(s) and/or computer program product(s) may be operable to cause at least one processor to execute a plurality of instructions stored in non-transient memory for: Identifying a tokenized Collectible NFT and its associated Drop collection, along with the smart contract(s) governing the collection: Determining if the Buyback Offer window for the identified tokenized Collectible Drop collection is currently open, based on predefined periods set in the collection's smart contract: Evaluating any restrictions or conditions that may prevent presenting a Buyback Offer for the identified tokenized Collectible NFT, according to the terms and conditions outlined in the smart contract and any collection-specific rules: Checking whether traits of the identified tokenized Collectible NFT have been revealed, and proceeding with the buyback process based on this revelation status: Calculating the Buyback Offer price for the identified tokenized Collectible NFT, using either predetermined values specific to each NFT in the collection or dynamically based on current market prices and historical sales data: Determining the terms of the Buyback Offer, including the Buyback Offer price and expiration date, in line with platform policies and smart contract rules: Presenting the Buyback Offer to the holder of the identified tokenized Collectible NFT through the platform's interface: Receiving the tokenized Collectible NFT holder's response to the Buyback Offer, either accepting or rejecting it: If the Buyback Offer is accepted, executing the buyback transaction, including transferring the tokenized Collectible NFT from the user's wallet to a designated wallet/address of the Drop creator and depositing the Buyback Offer payment into the user's wallet: and Recording the details of the Buyback Offer presentation, the user's response, and the transaction execution in a database, ensuring accurate and complete recordkeeping.

Another aspect disclosed herein is directed to different methods, systems, and computer program products for managing a tokenized collectibles drop in a blockchain-based online platform. In at least one embodiment, various method(s), system(s) and/or computer program product(s) may be operable to cause at least one processor to execute a plurality of instructions stored in non-transient memory for: initiating a user login to an online platform, wherein the user navigates to a collectibles drop page: enabling the user to purchase one or more unrevealed packs, each pack comprising at least one tokenized collectible trading card, wherein the purchase is recorded on a blockchain; transferring the purchased digital assets to the user's blockchain account or wallet: closing the drop purchase window upon selling out of the collectibles drop or reaching a predetermined time, thereby concluding the sales phase of the collectibles drop: opening a reveal window at a designated time or date, enabling users to reveal traits and details of their purchased tokenized collectible NFTs: presenting the user with an option to reveal the purchased tokenized collectible NFT: updating the tokenized collectible NFT to publicly reveal the NFT card's metadata and traits upon user's election to reveal: dynamically determining a buyback offer value for the revealed tokenized collectible NFT based on its metadata: presenting a swap/buyback offer to the user for the revealed tokenized collectible NFT: providing the user with options to list the revealed tokenized collectible NFT for sale, accept the buyback offer, decline the buyback offer, or initiate a claim for the corresponding physical collectible: executing a buyback transaction, wherein the tokenized collectible NFT is transferred from the user's wallet to a designated wallet upon acceptance of the buyback offer, and a payment is transferred to the user's wallet; maintaining the revealed tokenized collectible NFT in the user's wallet if the buyback offer is declined; and initiating a claim procedure for the corresponding physical collectible if elected by the user.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described, or reference herein will sometimes be described in singular form for clarity. However, it should be noted that particular embodiments include multiple iterations of a technique or multiple instantiations of a mechanism unless noted otherwise.

Moreover, it will be appreciated that, via the use of specifically configured computer hardware and software, the problems which are solved and/or overcome by the various Colony Platform features and functionality described herein are necessarily rooted in computer technology in order to overcome problems specifically arising in the realm of computer networks and blockchain networks. For example, specifically configured blockchain network-based computer hardware and software components (e.g., smart contracts, cryptographic wallets, etc.) are utilized in order to implement one or more of the Colony Platform features and functionality described herein on one or more blockchain networks such as the Ethereum blockchain network, for example. Such problems and limitations specifically arise in the realm of computer networks, and the solutions to these Colony Platform environment problems and limitations (e.g., as described herein) are necessarily rooted in computer technology.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a hard disk drive, CD ROM or Flash drive. The software code instructions may also be downloaded over the Internet.

Components included in one embodiment can be used in other embodiments in any appropriate combination. For example, any of the various components described herein and/or depicted in the Figures may be combined, interchanged or excluded from other embodiments. As understood herein, a decentralized market for in-game objects that is not controlled by any company can be more trusted by users, making the in-game items more valuable. A system supporting such a market advantageously can be used to support object creation between different platforms that a game is played on, so that, for example, if a user acquires an item in a PC version of a game, the user can transfer the item to a user who is playing a console version of the same game. Such a system may also be used to transfer items or in-game currency between a set of games that has that set of items or in-game currency in common.

In an aspect, an article of manufacture includes at least one computer storage that is not a transitory signal and that in turn includes instructions executable by at least one processor to access a data structure containing information related to non-monetary content, and to access at least a first blockchain containing information related to ownership of content represented in the data structure. The instructions are executable to use the information in the blockchain and data structure to obtain content represented in the data structure.

In some examples, the instructions can be executable to access a blockchain containing information related to publishers of content in the data structure, and to use the information related to publishers of content to obtain content represented in the data structure. Example instructions may be further executable to access a blockchain containing information related to retailers of content in the data structure, and to use the information related to retailers of content to obtain content represented in the data structure. Still further, example instructions may be executable to access a blockchain containing information related to distribution rights related to content in the data structure, and to use the information related to distribution rights to obtain content represented in the data structure. In some implementations, the blockchain containing information related to publishers, the blockchain containing information related to retailers, and the blockchain containing information related to distribution rights are implemented by a single third blockchain. In other implementations, the blockchain containing information related to publishers, the blockchain containing information related to retailers, and the blockchain containing information related to distribution rights are implemented by respective separate third, fourth, and fifth blockchains. The data structure representing content may be a blockchain such as the first blockchain or a second blockchain different from the first blockchain.

In another aspect, a system includes a processor-executed rule module that includes instructions about how a processor-accessible ownership blockchain and a processor-accessible data structure (such as a content blockchain) are added to and how the validity of the blockchains is verified. The instructions also include a type of content information that can be stored in the content blockchain. The system includes the processor-accessible ownership blockchain, which includes a chain of ownership blocks having information related to ownership of content in the processor-accessible content blockchain. The information related to ownership of content includes information of a type of content indicated in the content blockchain that is owned. The system further includes the processor-accessible content blockchain with information about the content for which the system can track ownership as reflected in a series of content blocks.

In examples, content ownership indicated in the ownership blockchain indicates particular pieces of content. In other examples, content ownership indicated in the ownership blockchain indicates units of a particular type of content. In non-limiting embodiments content ownership indicated in the ownership blockchain indicates ownership for fractional units of content.

If desired, the instructions in the processor-executed rule module provide a mapping of a new value to a type that it is assigned. The mapping of a new value to a type may be based at least in part on weightings of plural respective types so that statistically over time a number of new values created of a given type is proportional to that type's respective weighting. In some examples, the mapping can be executed at least in part based on a modulo of an identification of a new value and mapping different types to modulo values depending on their respective weightings.

Content represented in the processor-accessible content blockchain may include one or more of: video game objects, video games, video content, audio content. In another aspect, a method includes independently tracking ownership of content using an ownership blockchain, independently tracking, using a content data structure such as a content blockchain, content related to ownership of content indicated in the ownership blockchain, and managing alteration of the blockchains using a rule module.

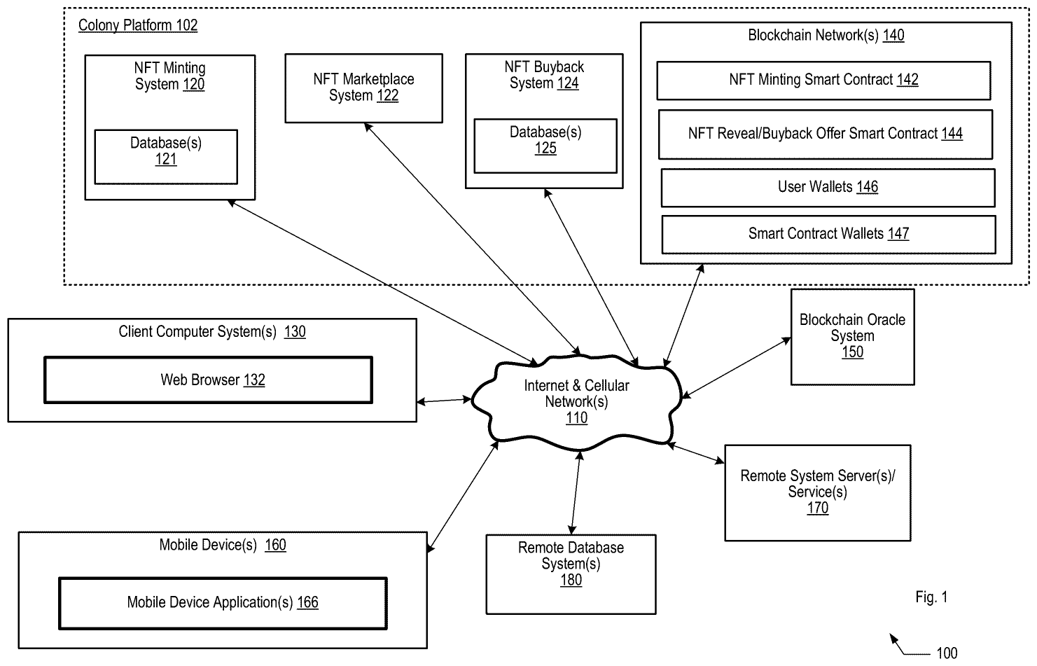

FIG. 1 illustrates a simplified block diagram of a specific example embodiment of a portion of a computerized data network which includes specifically configured blockchain network-based computer hardware and software components for facilitating, enabling, initiating, and/or performing one or more of the Colony Platform features and functionality described and/or referenced herein.

According to different embodiments, the Data Network portion 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Data Network may include one or more of the following types of systems, components, devices, processes, etc. (or combinations thereof):
Colony Technology System Platform 102 (herein “Colony Platform”)—According to different embodiments, the Colony Platform may be configured or designed to include and/or communicate with various types of computerized systems components, and networks, such as, for example, one or more of the following (or combinations thereof):
NFT Minting System 120: In at least one embodiment, the NFT Minting System may be operable to perform and/or implement various types of non-fungible token (“NFT”) minting-related functions, operations, actions, and/or other features such as those described or referenced herein. This system is responsible for creating NFTs. It includes software and hardware configured for minting and managing digital assets and their assumed value on a blockchain. The system incorporates algorithms and user interfaces for initiating the minting process. In at least one embodiment, the NFT Minting System may include at least one database (121) and/or database system configured or designed to store data relevant to the minting process, such as user information, digital asset details, minting parameters, transaction records, buyback offer table data, composite trait scores, etc.
NFT Marketplace System 122: In at least one embodiment, the NFT Marketplace System may be configured or designed to provide functionality for enabling secondary exchanges, sales, and purchases of Non-Fungible and/or fungible blockchain-based tokens, including, for example, ERC-721 tokens, ERC-1155 tokens, etc.
NFT Buyback System 124—In one embodiment, the NFT Buyback System is designed to facilitate the buyback of NFTs. It may include mechanisms for setting buyback terms, executing buyback transactions, and managing the financial aspects of buyback operations. In at least one embodiment, the NFT Buyback System may be operable to provide various types of automated market maker (“AMM”) functionality with respect to non-fungible and/or fungible blockchain-based tokens, including, for example, functionality for automatically and/or dynamically generating one or more buyback offers for NFTs associated with one or more NFT collections. In at least one embodiment, the NFT Buyback System may include at least one database (125) and/or database system configured or designed to store data relevant to the NFT buyback processes, such as NFT trait/attribute data, digital asset details, buyback window parameters, buyback offer parameters, transaction records, buyback offer table data, NFT composite trait score data, etc.
Blockchain Network(s) 140. This represents the underlying blockchain infrastructure that supports NFT minting, trading, and buyback. It ensures secure, transparent, and immutable recording of transactions. According to different embodiments, various components of the Blockchain Network(s) may include, but are not limited to, one or more of the following (or combinations thereof):
   NFT Mint Smart Contract(s) 142: A smart contract on the blockchain that automates the NFT minting process. It defines the rules and conditions under which NFTs are minted and ensures compliance with these rules.
   NFT Reveal/Buyback Offer Smart Contract(s) 144: This smart contract manages the reveal phase of NFTs and the buyback offers. It may automate the process of revealing NFT attributes and executing buyback agreements.
   User Wallet(s) 146: Digital wallets used by participants of the network to store and manage their NFTs and cryptocurrencies.
   Smart Contract Wallet(s) 147: Specialized wallets that interact with smart contracts on the blockchain. These may be used for automated transactions, such as buybacks or payments related to NFT trading.
Utilizing these various systems, components, and resources, the Colony Platform is able to provide various types of features and functionality which may be advantageously leveraged in one or more different types of use cases, such as, for example:
   Instant liquidity for NFT collections and NFT-tokenized physical collectibles
   Regulatory compliance services for businesses/entities involved with the minting, purchase and/or sale of NFTs
   Automated market maker (AMM) functionality for Non-Fungible digital assets/tokens
   Gaming and promotional applications in online gaming environments
   Marketing and promotional campaigns for NFT collections and tokenized Physical Collectible Drops.
Blockchain Oracle System(s) 150. A system that provides external data to the blockchain smart contracts, enabling them to interact with off-chain data for informed decision-making. In one embodiment, the Oracle System may be configured or designed to include functionality for providing a data feed that may bring data from the server system's (off-chain) database to the blockchain (on-chain).
Client Computer System(s) (130): This includes personal computers that users utilize to interact with the NFT platform. They are equipped with software to access the blockchain network and perform NFT-related transactions.
Web Browser (132): The browser software on client systems, facilitating access to web-based interfaces of the NFT platform.
Mobile Device(s) (160):
Mobile Device Application(s) (166): Applications installed on mobile devices specifically designed for interacting with the NFT platform.
Internet & Cellular Network(s) (110): The communication infrastructure enabling connectivity between various components of the system, including client devices, servers, and the blockchain network.
Remote Database System(s) (180): External databases that the system may interact with for additional data storage and retrieval purposes.
Remote System Server(s)/Service(s) 170. These are off-site servers or services that support the Colony Platform, providing additional computational resources, storage, or specialized functionalities. Examples of various remote system server(s)/service(s), may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Device(s) 160—Mobile/portable computing devices such as smartphones, tablets, laptop computers, notebook computers, etc. which users employ to access the Internet and blockchain networks.
Etc.

In at least one embodiment, Data Network portion 100 integrates various components, including blockchain technology, smart contracts, databases, user interfaces (both web and mobile), and remote services, to create a comprehensive ecosystem for NFT minting, trading, and buyback operations.

As described in greater detail herein, different embodiments of Data Networks may be configured, designed, and/or operable to provide various different types of operations, functionalities, and/or features generally relating to Colony Platform technology. Further, as described in greater detail herein, many of the various Colony Platform features and functionality disclosed herein may provide may enable or provide different types of advantages and/or benefits to different entities interacting with the Data Network(s).

The Colony Platform is a pioneering and multifaceted computerized technology system platform which leverages innovative blockchain technology to provide a unique, integrated solutions for the facilitating the tokenization, trading, buying, selling, exchange, buyback, and management of blockchain-based digital assets (e.g., NFTs) and tokenized NFTs representing physical collectibles. Example features and benefits provided by and/or enabled by the Colony Platform may include, but are not limited to:
Automated Buyback Offers: Provides a novel mechanism where NFT owners receive instant liquidity through automated buyback offers after the reveal of NFT traits.
Enhanced Market Dynamics: Addresses supply and demand issues in NFT launches, preventing oversupply and ensuring fair pricing.
Tokenization of physical collectibles into tokenized digital assets (NFTs).
Vault Service: Secure storage for physical collectibles, with the option for owners to tokenize these items for global trading.
Community and Engagement: Fosters a vibrant community through gamified experiences and a user-friendly interface.
Regulatory compliance services for businesses/entities involved with the minting, purchase and/or sale of NFTs
Automated market maker (AMM) functionality for Non-Fungible digital assets/tokens
Gaming and promotional applications in online gaming environments
Marketing and promotional campaigns and activities for NFT collections and tokenized Physical Collectible Drops.

The Colony Platform adapted to transform the Physical Collectibles market and NFT market by harnessing the power of SWAP/buyback mechanisms implemented via blockchain networks. The Colony Platform dual-vertical market approach provides for the tokenization of physical collectibles, creating a more efficient resale market. Additionally, the platform addresses supply-demand dynamics in the NFT space, fostering an engaging and gamified experience for creators, collectors, and traders in both Collectibles and NFTs. In the Physical Collectibles (RWAs) vertical, the Colony Platform reimagines the collectibles market by seamlessly tokenizing physical assets. The platform empowers collectors to securely and transparently drop, trade and vault tokenized physical collectibles.

An important aspect of the Colony Platform's technology relates to its novel mint, reveal, and buyback mechanisms, which, for example, may be configured or designed to support the ERC-721S The SWAP Protocol. Together, these mechanisms provide significant benefits and advantages for NFT launches, such as, for example:
Balancing Supply and Demand: Intelligently assessing market dynamics to prevent oversupply or scarcity, aligning interests of creators and buyers and fostering market dynamics.
Risk Mitigation: Mitigating launch risks for founders, artists, and brands, while ensuring a safe and transparent environment for buyers.
Gamified User Experience: Incorporating gamified elements into the user interface, enhancing engagement and fostering a vibrant community.
Innovative Smart Contracts: The Colony Platform's smart contracts support the ERC-721S protocol, and provide a secure, transparent, and efficient foundation for the tokenization of physical collectibles and NFT mints, enhancing the overall collectibles experience.
Efficient Resale Market: The Colony Platform enhances the Collectibles market by streamlining the resale process, providing collectors with a more dynamic and liquid marketplace for their treasured assets.
NFT Innovation: In the NFT vertical, the Colony Platform introduces a gamified approach to NFT mints. addressing supply-demand dynamics for creators and collectors alike.
Real-Time Insights: The Colony Platform includes functionality for providing NFT creators with access to real-time platform and market data, empowering informed decisions on collection size, pricing, and demand.

According to different embodiments, at least some Colony Platform component(s) may be configured, designed, and/or operable to provide a number of different advantages and/or benefits and/or may be operable to initiate, and/or enable various different types of operations, functionalities, and/or features, such as, for example, one or more of those described and/or referenced herein. According to different embodiments, at least a portion of the various functions, actions, operations, and activities performed by one or more Colony Platform component(s) may be initiated in response to detection of one or more conditions, events, and/or other criteria satisfying one or more different types of minimum threshold criteria, such as, for example, one or more of those described and/or referenced herein. According to different embodiments, at least a portion of the various types of functions, operations, actions, and/or other features provided by at least one Colony Platform component may be implemented at one or more client systems(s), at one or more mobile device(s), at one or more System Servers (s), and/or combinations thereof.

According to different embodiments, the Data Network portion 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Data Network may include one or more types of systems, components, devices, processes, etc. (or combinations thereof) described and/or referenced herein.

In at least one embodiment, the Colony Platform component(s) may be operable to utilize and/or generate various different types of data and/or other types of information when performing specific tasks and/or operations. This may include, for example, input data/information and/or output data/information. For example, in at least one embodiment, the Colony Platform component(s) may be operable to access, process, and/or otherwise utilize information from one or more different types of sources, such as, for example, one or more local and/or remote memories, devices and/or systems. Additionally, in at least one embodiment, the Colony Platform component(s) may be operable to generate one or more different types of output data/information, which, for example, may be stored in memory of one or more local and/or remote devices and/or systems. Examples of different types of input data/information and/or output data/information which may be accessed and/or utilized by at least one Colony Platform component may include, but are not limited to, one or more of those described and/or referenced herein.

According to specific embodiments, multiple instances or threads of at least one Colony Platform component may be concurrently implemented and/or initiated via the use of one or more processors and/or other combinations of hardware and/or hardware and software. For example, in at least some embodiments, various aspects, features, and/or functionalities of at least one Colony Platform component may be performed, implemented and/or initiated by one or more of the various systems, components, systems, devices, procedures, processes, etc., described and/or referenced herein.

In at least one embodiment, a given instance of at least one Colony Platform component may access and/or utilize information from one or more associated databases. In at least one embodiment, at least a portion of the database information may be accessed via communication with one or more local and/or remote memory devices. Examples of different types of data which may be accessed by at least one Colony Platform component may include, but are not limited to, one or more of those described and/or referenced herein.

According to different embodiments, various different types of encryption/decryption techniques may be used to facilitate secure communications between one or more devices, systems, and/or components of the Data Network. Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well known hardware-based and/or software-based security components, and/or any other known or yet to be devised security and/or hardware and encryption/decryption processes implemented in hardware and/or software.

According to different embodiments, one or more different threads or instances of at least one Colony Platform component may be initiated in response to detection of one or more conditions or events satisfying one or more different types of minimum threshold criteria for triggering initiation of at least one instance of at least one Colony Platform component. Various examples of conditions or events which may trigger initiation and/or implementation of one or more different threads or instances of at least one Colony Platform component may include, but are not limited to, one or more of those described and/or referenced herein.

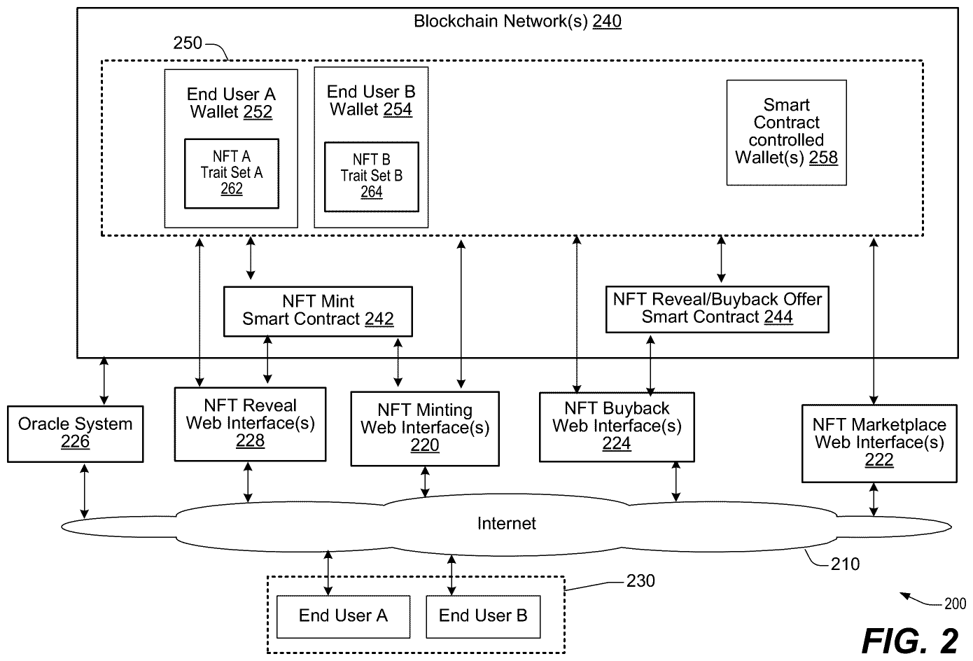

FIG. 2 shows an example data network architecture embodiment of a Data Network 200 which may be utilized for facilitating, enabling, initiating, and/or performing one or more of the Colony Platform features and functionality described and/or referenced herein.

As illustrated in the example embodiment of FIG. 2, the Data Network 200 may include a plurality of different types of components, devices, modules, processes, systems, etc., which, for example, may be implemented and/or instantiated via the use of hardware and/or combinations of hardware and software. For example, as illustrated in the example embodiment of FIG. 2, the Data Network may include one or more of the following types of systems, components, devices, processes, etc. (or combinations thereof):
Oracle System(s) 226. According to different embodiments, blockchain oracles are entities that connect blockchains to external systems, thereby enabling smart contracts to execute based upon inputs and outputs from the real world. Oracles provide a way for the decentralized Web3 ecosystem to access existing data sources, legacy systems, and advanced computations. Decentralized oracle networks (DONs) enable the creation of hybrid smart contracts, where on-chain code and off-chain infrastructure are combined to support advanced decentralized applications (dApps) that react to real-world events and interoperate with traditional systems. In at least one embodiment, the Oracle System provides external data to the smart contracts, enabling them to interact with off-chain data sources and make informed decisions.
NFT Reveal Web Interface(s) 228 which, for example, may be configured or designed to provide functionality for facilitating communications and transactions (e.g., relating to NFT reveal functionality) between End Users and components/assets of the Blockchain networks(s), including web interfaces designed for the NFT reveal process, allowing users to interact with the reveal functionality.
NFT Minting Web Interface(s) 220 which, for example, may be configured or designed to provide functionality for facilitating communications and transactions (e.g., relating to NFT minting functionality) between End Users and components of the Blockchain networks(s), including web interfaces facilitating the NFT minting process, and providing a user-friendly platform for creating NFT collections.
NFT Buyback Web Interface(s) 224 which, for example, may be configured or designed to provide functionality for facilitating communications and transactions (e.g., relating to NFT buyback functionality) between End Users and components/assets of the Blockchain networks(s), including graphical user interfaces (GUIs) which are specifically configured or designed for managing and executing NFT buyback offer and NFT buyback operations.
NFT Marketplace Web Interface(s) 222 which, for example, may be configured or designed to provide functionality for facilitating communications and transactions (e.g., relating to NFT marketplace functionality) between End Users and components/assets of the Blockchain networks(s), including interfaces designed for the NFT marketplace, allowing users to buy, sell, and trade NFTs, and receive and accept NFT buyback offers generated by the Colony Platform and/or by buyback smart contracts.
NFT Mint smart Contract 242. A smart contract specifically designed for minting NFTs on the platform, automating the minting process according to predefined rules. In at least one embodiment, the NFT Mint smart Contract 242 may be configured or designed to provide functionality for facilitating blockchain network-related communications and transactions relating to various aspects of NFT reveal functionality and/or NFT minting functionality described and/or referenced herein.
NFT Reveal/Buyback Offer Smart Contract 244, which, for example, may be configured or designed to provide functionality for facilitating blockchain network-related communications and transactions relating to various aspects of NFT buyback offer functionality described and/or referenced herein. In at least one embodiment, the NFT Reveal/Buyback Offer Smart Contract may be configured or designed to manage the processes relating to the reveal phase of NFTs, and to handle processes relating to buyback offers and NFT buybacks, automating these processes based on smart contract logic.
Cryptographic Blockchain Wallets 250, which, for example, may include:
   End User Wallets 252, 254.
   Smart Contract controlled wallets 258. These are specialized wallets controlled by smart
Fungible and Non-Fungible blockchain tokens such as, for example, NFT A 262, NFT B 264. In at least one embodiment, each non-fungible token may have associated therewith a respective set of traits or properties (e.g., Trait Set A, Trait Set B, etc.).
Blockchain Network(s) 240
End User Devices 230
Internet & Wireless Data Network(s) 210
Etc.

According to specific embodiments, various component(s) of the Data Network 200 may be accessible to various entities such as, for example: individual persons, corporate or business entities, system administrators, online content providers, online publishers, merchants, artists, copyright holders, etc. In at least one embodiment, the Data Network 200 may include a plurality of components operable to perform and/or implement various types of functions, operations, actions, and/or other features such as, for example, one or more of those described and/or referenced herein.

In at least some embodiments, Data Network 200 may include additional systems, components, devices, processes, etc., such as, for example, one or more of the following (or combinations thereof):
Database(s)
Gaming Engine(s)
Asset Management System(s)
Payment and Transaction System(s)
Database Query/Response System(s)
And/or other systems, components, devices, functionality described and/or referenced herein.

In at least one embodiment, one or more of the databases may be queried via the use of various types of programming languages and/or protocols such as, for example, one or more of the following (or combinations thereof):
HTML
XML
MySQL
MongoDB
Node.js
Perl
Ajax
JavaScript
Etc.

In at least one embodiment, various component(s) of the Data Network 200 may be configured or designed to include functionality for facilitating, enabling, initiating, and/or performing one or more of the following operation(s), action(s), and/or feature(s) (or combinations thereof):
Monitor user behaviors and activities.
Identify brand-related information associated with user-accessible content that the user is accessing. has requested access to, and/or has interest in.
Facilitate online sale, transfer, and/or exchange of whole or fractional ownership interests of fungible and/or non-fungible blockchain network token(s).
Manage and track buyback-related activities relating to fungible and/or non-fungible blockchain network token(s).
Manage reporting.
Monitor and confirm regulatory compliance activities.
Facilitate configuration, tracking, and management of online promotional campaigns relating to fungible and/or non-fungible blockchain network token(s).
Transact online fungible and/or non-fungible blockchain network token -related minting, revealing, purchasing/selling, and buyback offer(s).
Transact Database queries/responses.
Manage website registration and login services (e.g., WEB2 and WEB3).
Provide query disambiguation.
Etc.

According to specific embodiments, multiple instances or threads of one or more component(s) of the Data Network 200 may be concurrently implemented and/or initiated via the use of one or more processors and/or other combinations of hardware and/or hardware and software. For example, in at least some embodiments, various aspects, features, and/or functionalities of the Colony Platform features and functionality may be performed, implemented and/or initiated by one or more systems, components, systems, devices, procedures, processes, etc. (or combinations thereof) described and/or referenced herein.

In at least some embodiments, various aspects, features, and/or functionalities relating to the Colony Platform features and functionality described herein may be performed, implemented and/or initiated by one or more of the following types of systems, components, systems, devices, procedures, processes, etc. (or combinations thereof):
Inventory Management system(s)
Online Order management/tracking system(s).
Shopping cart system(s).
Databases.
Database query interface(s)
Merchant interface component(s)
Publisher/Content Provider interface component(s).
Customer Interface component(s).
Administrative interface component(s).
Sales channel partner interface component(s).
Blockchain explorer interface(s).
Smart contract interface(s).
Cryptographic blockchain wallet interface(s).
etc.

According to different embodiments, one or more different threads or instances of one or more component(s) of the Data Network 200 may be initiated in response to detection of one or more conditions or events satisfying one or more different types of minimum threshold criteria for triggering initiation of at least one instance of data network component(s). Various examples of conditions or events which may trigger initiation and/or implementation of one or more different threads or instances of one or more component(s) of the Data Network 200 may include, but are not limited to, one or more types of conditions and/or events described or referenced herein.

In at least one embodiment, a given instance of one or more component(s) of the Data Network 200 may access and/or utilize information from one or more associated databases. In at least one embodiment, at least a portion of the database information may be accessed via communication with one or more local and/or remote memory devices. Examples of different types of data which may be accessed by one or more component(s) of the Data Network 200 may include, but are not limited to, one or more different types of data, metadata, and/or other information described and/or referenced herein.

In at least one embodiment, a given instance of one or more component(s) of the Data Network 200 may access and/or utilize information from one or more associated databases. In at least one embodiment, at least a portion of the database information may be accessed via communication with one or more local and/or remote memory devices. Examples of different types of data which may be accessed by one or more component(s) of the Data Network 200 may include, but are not limited to, one or more of the following (or combinations thereof):
Brand-related information;
Asset availability information;
Pricing information;
User behavior and analytic information;
Performance information;
Asset Inventory information;
Promotional Campaign information;
NFT Buyback information;
User profile information;
Etc.

It will be appreciated that the various embodiments of the data network 200 disclosed herein are but a few examples from a wide range of data networks embodiments which may be implemented. Other embodiments of the data networks (not shown) may include additional, fewer and/or different components/features that those illustrated and described herein.

For example, in at least one embodiment, the Colony Platform may include one or more of the following (or combinations thereof):
At least one Mint smart contract template which may be used for creating a plurality of individually customized Mint smart contracts for minting different NFT collections. In at least one embodiment, the Mint smart contract template may be used to instantiate and configure an individually customized Mint smart contract per collection/project/use case,
At least one Reveal/Buyback Offer smart contract which may be used for creating a plurality of individually customized Reveal/Buyback Offer smart contracts for different NFT collections. In at least one embodiment, the Reveal/Buyback Offer smart contract template may be used to instantiate and configure an individually customized Reveal/Buyback Offer smart contract per collection/project/use case.

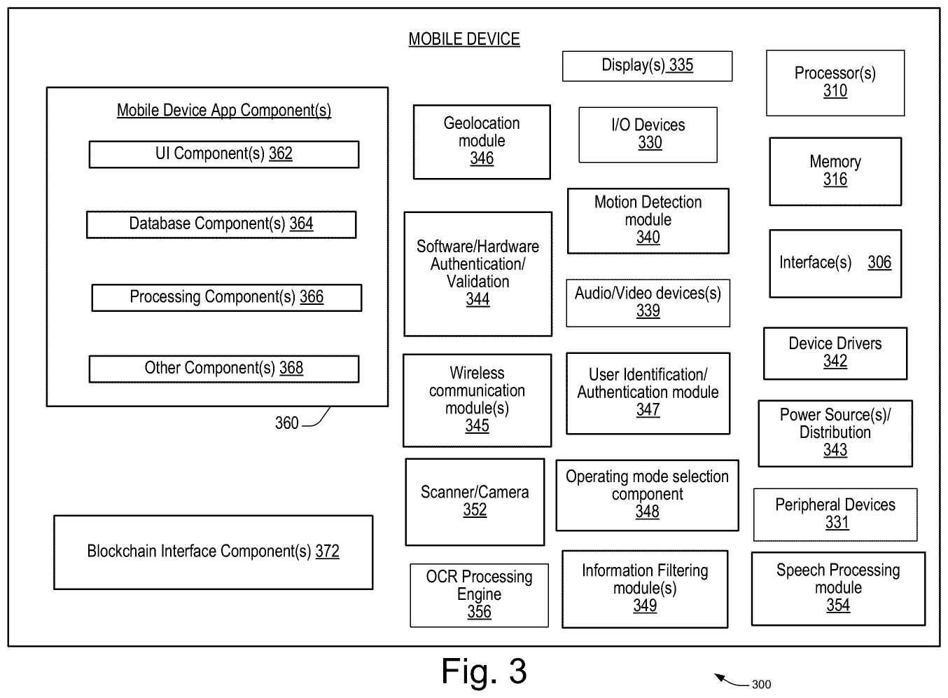

FIG. 3 is a simplified block diagram of an exemplary client system Mobile Device 300 in accordance with a specific embodiment.

As illustrated in the example of FIG. 3 Mobile Device 300 may include a variety of components, modules and/or systems for providing various functionality. For example, as illustrated in FIG. 3, Mobile Device 300 may include Mobile Device Application components (e.g., 360), which, for example, may include, but are not limited to, one or more of the following (or combinations thereof):
UI Components 362 such as those illustrated, described, and/or referenced herein.
Database Components 364 such as those illustrated, described, and/or referenced herein.
Processing Components 366 such as those illustrated, described, and/or referenced herein.
Other Components 368 which, for example, may include components for facilitating and/or enabling the Mobile Device to perform and/or initiate various types of operations, activities, functions such as those described herein.

In at least one embodiment, the client system may include Mobile Device App Component(s) which support communications and interactions with one or more blockchain networks. In at least one embodiment, the Mobile Device Application component(s) 360 may also be operable to perform and/or implement various types of Colony Platform related functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more systems, components, systems, devices, procedures, processes, etc. (or combinations thereof) described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more types of conditions and/or events described or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 300 may further include, but is not limited to, other types of components, modules and/or systems such as, for example, one or more of the following (or combinations thereof):
At least one processor 310. In at least one embodiment, the processor(s) 310 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 316, which, for example, may include volatile memory (e.g., RAM), non-volatile memory (e.g., disk memory, FLASH memory, EPROMs, etc.), unalterable memory, and/or other types of memory. In at least one implementation, the memory 316 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various Colony Platform features and functionality described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the Colony Platform features and functionality described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 306 which, for example, may include wired interfaces and/or wireless interfaces. In at least one implementation, the interface(s) 306 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™). 802.16 (WiMax), 802.22, Cellular standards such as CDMA, CDMA2000, WCDMA, Radio Frequency (e.g., RFID), Infrared, Near Field Magnetics, etc.
Device driver(s) 342. In at least one implementation, the device driver(s) 342 may include functionality similar to at least a portion of functionality implemented by one or more computer system driver devices such as those described herein and/or generally known to one having ordinary skill in the art.
At least one power source (and/or power distribution source) 343. In at least one implementation, the power source may include at least one mobile power source (e.g., battery) for allowing the client system to operate in a wireless and/or mobile environment. For example, in one implementation, the power source 343 may be implemented using a rechargeable, thin-film type battery. Further, in embodiments where it is desirable for the device to be flexible, the power source 343 may be designed to be flexible.
Geolocation module 346 which, for example, may be configured or designed to acquire geolocation information from remote sources and use the acquired geolocation information to determine information relating to a relative and/or absolute position of the client system.
Motion detection component 340 for detecting motion or movement of the client system and/or for detecting motion, movement, gestures and/or other input data from user. In at least one embodiment, the motion detection component 340 may include one or more motion detection sensors such as, for example, MEMS (Micro Electro Mechanical System) accelerometers, that can detect the acceleration and/or other movements of the client system as it is moved by a user.
User Identification/Authentication module 347. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 335. According to various embodiments, such display(s) may be implemented using, for example, LCD display technology, OLED display technology, and/or other types of conventional display technology. In at least one implementation, display(s) 335 may be adapted to be flexible or bendable. Additionally, in at least one embodiment the information displayed on display(s) 335 may utilize e-ink technology (such as that available from E Ink Corporation, Cambridge, MA, www.eink.com), or other suitable technology for reducing the power consumption of information displayed on the display(s) 335.
One or more user I/O Device(s) 330 such as, for example, keys, buttons, scroll wheels, cursors, touchscreen sensors, audio command interfaces, magnetic strip reader, optical scanner, etc.
Audio/Video device(s) 339 such as, for example, components for displaying audio/visual media which, for example, may include cameras, speakers, microphones, media presentation components, wireless transmitter/receiver devices for enabling wireless audio and/or visual communication between the client system 300 and remote devices (e.g., radios, telephones, computer systems, etc.). For example, in one implementation, the audio system may include componentry for enabling the client system to function as a cell phone or two-way radio device.
Other types of peripheral devices 331 which may be useful to the users of various client systems, such as, for example: PDA functionality; memory card reader(s); fingerprint reader(s); image projection device(s); social networking peripheral component(s); etc.
Information filtering module(s) 349 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 349 may also be adapted to display, in real-time, filtered information to the user based upon a variety of criteria such as, for example, geolocation information, contextual activity information, and/or other types of filtering criteria described and/or referenced herein.
Wireless communication module(s) 345. In one implementation, the wireless communication module 345 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 344 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Operating mode selection component 348 which, for example, may be operable to automatically select an appropriate mode of operation based on various parameters and/or upon detection of specific events or conditions such as. for example: the mobile device's current location: identity of current user: user input: system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 352) which may be configured or designed for use in scanning identifiers and/or other content from other devices and/or objects such as for example: mobile device displays, computer displays, static displays (e.g., printed on tangible mediums), etc.
Blockchain Interface Component(s) 372 which may be configured or designed to include functionality for enabling the Mobile Device to communicate with, and initiate transactions on one or more blockchain networks.
OCR Processing Engine (e.g., 356) which, for example, may be operable to perform image processing and optical character recognition of images such as those captured by a mobile device camera, for example.
Speech Processing module (e.g., 354) which, for example, may be operable to perform speech recognition, and may be operable to perform speech-to-text conversion.
Etc.

According to a specific embodiment, the mobile device may be adapted to implement at least a portion of the features associated with the mobile game service system described in U.S. patent application Ser. No. 10/115,164, which is now U.S. Pat. No. 6,800,029, issued Oct. 5, 2004, (previously incorporated by reference in its entirety). For example, in one embodiment, the mobile device may be comprised of a hand-held game service user interface device (GSUID) and a number of input and output devices. The GSUID is generally comprised of a display screen which may display a number of game service interfaces. These game service interfaces are generated on the display screen by a microprocessor of some type within the GSUID. Examples of a hand-held GSUID which may accommodate the game service interfaces are manufactured by Symbol Technologies, Incorporated of Holtsville, New York.

The game service interfaces may be used to provide a variety of game service transactions and gaming operations services. The game service interfaces, including a login interface, an input/output interface, a transaction reconciliation interface, a ticket validation interface, a prize services interfaces, a food services interface, an accommodation services interfaces, a gaming operations interfaces, a multi-game/multi-denomination meter data transfer interface, etc. Each interface may be accessed via a main menu with a number of sub-menus that allow a game service representative to access the different display screens relating to the particular interface. Using the different display screens within a particular interface, the game service representative may perform various operations needed to provide a particular game service. For example, the login interface may allow the game service representative to enter a user identification of some type and verify the user identification with a password. When the display screen is a touch screen, the user may enter the user/operator identification information on a display screen comprising the login interface using the input stylus and/or using the input buttons. Using a menu on the display screen of the login interface, the user may select other display screens relating to the login and registration process. For example, another display screen obtained via a menu on a display screen in the login interface may allow the GSUID to scan a finger print of the game service representative for identification purposes or scan the finger print of a game player.

The user identification information and user validation information may allow the game service representative to access all or some subset of the available game service interfaces available on the GSUID. For example, certain users, after logging into the GSUID (e.g. entering a user identification and a valid user identification information), may be able to access a variety of different interfaces, such as, for example, one or more of: input/output interface, communication interface, food services interface, accommodation services interface, prize service interface, gaming operation services interface, transaction reconciliation interface, voice communication interface, gaming device performance or metering data transfer interface, etc.; and perform a variety of services enabled by such interfaces. While other users may be only be able to access the award ticket validation interface and perform EZ pay ticket validations. The GSUID may also output game service transaction information to a number of different devices (e.g., card reader, printer, storage devices, gaming machines and remote transaction servers, etc.).

In addition to the features described above, various embodiments of mobile devices described herein may also include additional functionality for displaying, in real-time, filtered information to the user based upon a variety of criteria such as, for example, geolocation information, casino data information, player tracking information, etc.

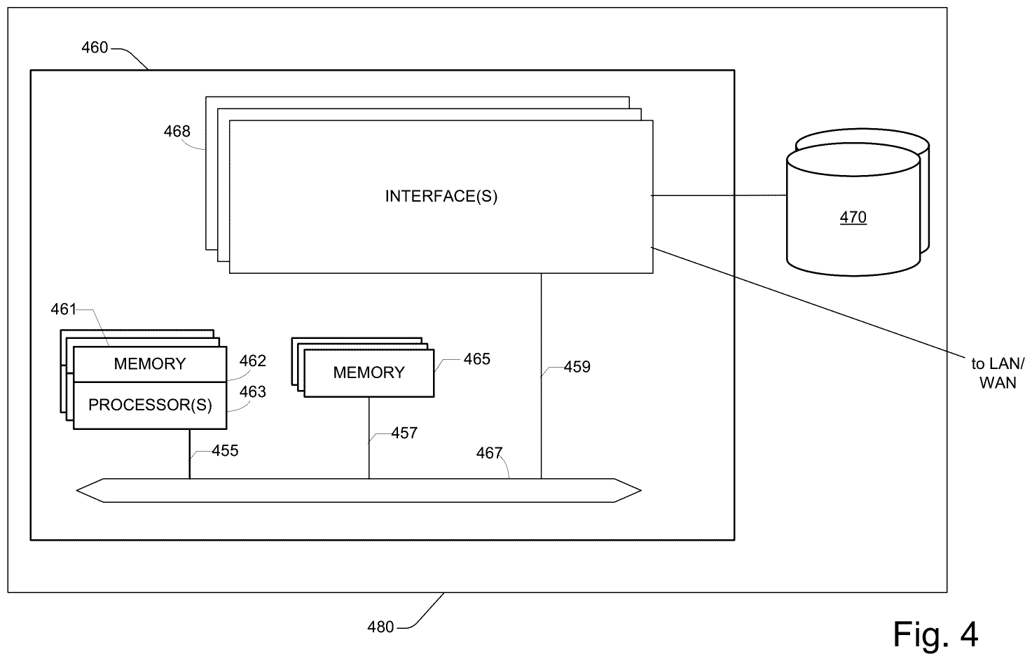

FIG. 4 illustrates an example embodiment of a System Server 480 which may be used for implementing various aspects/features described herein. In at least one embodiment, the System Server 480 includes at least one network device 460, and at least one storage device 470 (such as, for example, a direct attached storage device).

In one embodiment, System Server 480 may be suitable for implementing at least some of the Colony Platform features and functionalities described herein.

In according to one embodiment, network device 460 may include a master central processing unit (CPU) 462, interfaces 468, and a bus 467 (e.g., a PCI bus). When acting under the control of appropriate software or firmware, the CPU 462 may be responsible for implementing specific functions associated with the functions of a desired network device. For example, when configured as a server, the CPU 462 may be responsible for analyzing packets; encapsulating packets; forwarding packets to appropriate network devices; instantiating various types of virtual machines, virtual interfaces, virtual storage volumes, virtual appliances; etc. The CPU 462 preferably accomplishes at least a portion of these functions under the control of software including an operating system (e.g. Linux), and any appropriate system software (such as, for example, AppLogic(™) software).

CPU 462 may include one or more processors 463 such as, for example, one or more processors from the AMD, Motorola, Intel and/or MIPS families of microprocessors. In an alternative embodiment, processor 463 may be specially designed hardware for controlling the operations of System Server 480. In a specific embodiment, a memory 461 (such as non-volatile RAM and/or ROM) also forms part of CPU 462. However, there may be many different ways in which memory could be coupled to the system. Memory block 461 may be used for a variety of purposes such as, for example, caching and/or storing data, programming instructions, etc.

The interfaces 468 may be typically provided as interface cards (sometimes referred to as “line cards”). Alternatively, one or more of the interfaces 468 may be provided as on-board interface controllers built into the system motherboard. Generally, they control the sending and receiving of data packets over the network and sometimes support other peripherals used with the System Server 480. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 4G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for communication intensive tasks, these interfaces allow the master microprocessor 462 to efficiently perform routing computations, network diagnostics, security functions, etc.

In at least one embodiment, some interfaces may be configured or designed to allow the System Server 480 to communicate with other network devices associated with various local area network (LANs) and/or wide area networks (WANs). Other interfaces may be configured or designed to allow network device 460 to communicate with one or more direct attached storage device(s) 470.

Although the system shown in FIG. 4 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 465, which, for example, may include random access memory (RAM)) configured to store data, program instructions for the general-purpose network operations and/or other information relating to the functionality of the various Colony Platform features and functionality described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

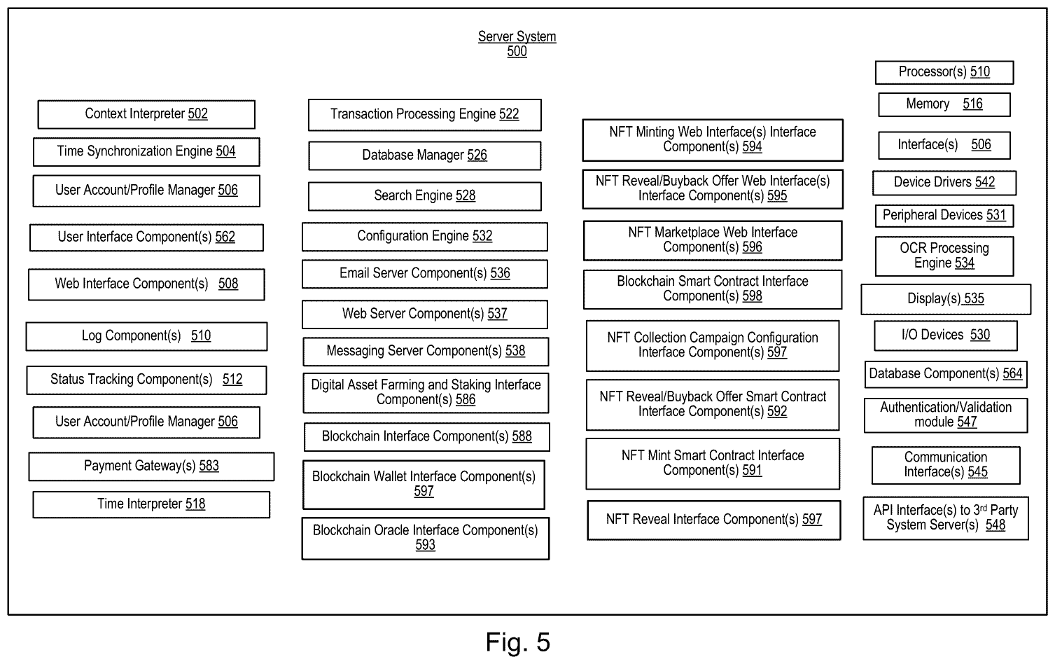

FIG. 5 illustrates an example of a functional block diagram of a Colony Platform Server System 500 in accordance with a specific embodiment. In at least one embodiment, the Server System may be operable to perform and/or implement various types of functions, operations, actions, and/or other features, such as, for example, one or more of those described and/or referenced herein.

In at least one embodiment, the Server System may include a plurality of components operable to perform and/or implement various types of functions, operations, actions, and/or other features such as, for example, one or more of the following (or combinations thereof):
Blockchain Interface Component(s) 588: This component acts as a bridge between the server system and various blockchain networks. It facilitates interactions with different blockchains, enabling the platform to execute transactions, retrieve data, and maintain sync with blockchain states. This component is helpful for ensuring that the platform's activities remain consistent with the decentralized ledger.
Blockchain Wallet Interface Component(s) 597: This interface component manages interactions with user blockchain wallets. It enables users to connect their wallets to the platform, initiate transactions, and check balances. This component plays a helpful role in ensuring secure and efficient wallet operations for transactions on the platform.
Blockchain Oracle Interface Component(s) 593: This component serves as a link between the Colony Platform and external data sources or oracles. It fetches real-time data from these oracles, which may be used to make informed decisions within smart contracts. This interface is helpful for scenarios where off-chain data is needed for on-chain execution.
NFT Minting Web Interface(s) Interface Component(s) 594: This interface helps facilitate the minting of NFTs. It provides users with a user-friendly web interface to create (mint) NFTs on the platform. This component may also be configured or designed to facilitate the configuration of mint smart contracts, and may include features for defining NFT characteristics, uploading digital assets, managing the minting process, etc.
NFT Reveal/Buyback Offer Web Interface(s) Interface Component(s) 595: This web interface manages the reveal and buyback functionalities of NFTs. Users may use this interface to reveal hidden traits of their NFTs and receive and take action on buyback offers from the platform. It provides a helpful role in enhancing user engagement and offering instant liquidity options.
NFT Marketplace Web Interface Component(s) 596: This component provides a marketplace interface where users may engage in the buying, selling, swapping, or exchanging of NFTs. It facilitates listing NFTs for sale, browsing available NFTs, and executing blockchain transactions.
Blockchain Smart Contract Interface Component(s) 598: This interface facilitates interactions with smart contracts deployed on the blockchain. It enables the platform to execute smart contract functions, such as transferring NFTs, updating ownership records, processing transactions, etc.
NFT Collection Campaign Configuration Interface Component(s) 597: This interface assists in setting up and managing NFT collection campaigns. It allows for configuring collection campaign parameters, such as collection size, rarity distribution, NFT traits/attributes, buyback offer criteria, mint window begin/end times, reveal window begin/end times, buyback window begin/and times, and/or other campaign parameters described and/or referenced herein.
NFT Reveal/Buyback Offer Smart Contract Interface Component(s) 592: This interface component interacts with smart contracts that handle the reveal and buyback functionalities of NFTs. It ensures that the reveal process and buyback offers are executed in accordance with the predefined rules and conditions defined in the smart contracts.
NFT Mint Smart Contract Interface Component(s) 591: This component interfaces with smart contracts responsible for the minting of NFTs. It ensures that the minting process adheres to the rules and conditions defined in the smart contract, such as mint limits, pricing, royalty distributions, mint window begin/end times, etc.
NFT Reveal Interface Component(s) 597: This interface is dedicated to the revealing of NFT traits. It provides users with the functionality to initiate revealing of the unrevealed traits and attributes of their NFTs, adding an element of surprise and discovery to the NFT experience.
Digital Asset Farming and Staking Interface Component(s) 586: This component allows users to engage in digital asset farming and staking activities. It provides an interface for users to deposit their digital assets or NFTs, participate in farming activities, and earn rewards. The interface ensures seamless interaction between users and the underlying smart contracts governing the farming and staking processes.
Context Interpreter (e.g., 502) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of user(s)
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
   etc.
Time Synchronization Engine (e.g., 504) which, for example, may be operable to manages universal time synchronization (e.g., via NTP and/or GPS)
Search Engine (e.g., 528) which, for example, may be operable to search for transactions, logs, items, accounts, options in one or more System databases
Configuration Engine (e.g., 532) which, for example, may be operable to determine and handle configuration of various customized configuration parameters for one or more devices, component(s), system(s), process(es), etc.
Time Interpreter (e.g., 518) which, for example, may be operable to automatically and/or dynamically modify or change identifier activation and expiration time(s) based on various criteria such as, for example, time, location, transaction status, etc.
Authentication/Validation Component(s) (e.g., 547) (password, software/hardware info, SSL certificates, cryptographic keys, etc.) which, for example, may be operable to perform various types of authentication/validation tasks such as, for example, one or more of the following (or combinations thereof):
   Verifying/authenticating devices,
   Verifying passwords, passcodes, SSL certificates, biometric identification information, and/or other types of security-related information
   Verify/validate activation and/or expiration times
   Etc.
   In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning the user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 522) which, for example, may be operable to handle various types of transaction processing tasks such as, for example, one or more of the following (or combinations thereof):
   Identifying/determining transaction type
   Determining which payment gateway(s) to use
   Associating databases information to identifiers
   Etc.
Payment Gateway Component(s) 583
Asset Management Component(s) 584
OCR Processing Engine (e.g., 534) which, for example, may be operable to perform image processing and optical character recognition of images such as those captured by a mobile device camera, for example.
Database Manager (e.g., 526) which, for example, may be operable to handle various types of tasks relating to database updating, database management, database access, etc. In at least one embodiment, the Database Manager may be operable to manage TISS databases, Device Application databases, etc.
Log Component(s) (e.g., 510) which, for example, may be operable to generate and manage transactions history logs, system errors, connections from APIs, etc.
Status Tracking Component(s) (e.g., 512) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 514) which, for example, may be operable to facilitate and manage communications and transactions with external Payment Gateways.
Web Interface Component(s) (e.g., 508) which, for example, may be operable to facilitate and manage communications and transactions with computerized data network web portal(s).
API Interface(s) (e.g., 546) which, for example, may be operable to facilitate and manage communications and transactions with API Interface(s) to one or more other components of the computerized data network.
API Interface(s) to 3rd Party System Server(s) (e.g., 548) which, for example, may be operable to facilitate and manage communications and transactions with API Interface(s) to 3rd Party System Server(s)
OCR Processing Engine (e.g., 534) which, for example, may be operable to perform image processing and optical character recognition of images such as those captured by a mobile device camera, for example.
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the Colony Platform techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art.
Device driver(s) 542. In at least one implementation, the device driver(s) 542 may include functionality similar to at least a portion of functionality implemented by one or more computer system driver devices such as those described herein and/or generally known to one having ordinary skill in the art.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable. Additionally, in at least one embodiment the information displayed on display(s) 535 may utilize e-ink technology (such as that available from E Ink Corporation, Cambridge, MA, www.eink.com), or other suitable technology for reducing the power consumption of information displayed on the display(s) 535.
Email Server Component(s) 536, which, for example, may be configured or designed to provide various functions and operations relating to email activities and communications.
Web Server Component(s) 537, which, for example, may be configured or designed to provide various functions and operations relating to web server activities and communications.
Messaging Server Component(s) 538, which, for example, may be configured or designed to provide various functions and operations relating to text messaging and/or other social network messaging activities and/or communications.
Etc.

The Colony Platform is a sophisticated online environment which provides functionality for Colony NFT “Drops.” which, for example, may be implemented as individual ERC721 NFT collections. One or more of these Colony NFT collections feature different types of buyback offer and NFT buyback mechanisms.

In at least one embodiment, the contract schema of the Colony Platform may include a colony factory component and at least one template of a Drop smart contract. In at least one embodiment, the colony factory is responsible for deploying minimal proxies that connect to approved implementation contracts. The colony factory serves as the backbone, facilitating a range of mechanisms desirable for the smooth operation of the platform. In at least one embodiment, the Drop smart contract template may be implemented as an upgradeable ERC721A smart contract. This template forms part of the system for hosting sales of Colony-backed NFT collections. It provides a standardized yet flexible framework for NFT collection creation and minting, ensuring uniformity across various collections.

Various aspects relating to the Colony NFT Collection Drop Flow may include, but are not limited to, one or more of the following (or combinations thereof):
Off-Chain Handling of Images and Metadata: To optimize efficiency and scalability, the Colony Platform includes functionality for enabling the management and storage of images and metadata off-chain. This approach significantly reduces the on-chain load, facilitating smoother and faster transactions while maintaining the integrity and security of the data.
Collection Creation: NFT collections on the platform are created with a base Uniform Resource Identifier (URI) generated off-chain, accompanied by crucial contract metadata. This metadata includes the sale start timestamp, buyback period start and end timestamps, crucial for defining the lifecycle of each NFT collection.
Sales and Buyback Periods: In at least one embodiment, the sales of NFTs are bound by specific timeframes, marked by the sale start timestamp and the buyback period start timestamp. This temporal structuring ensures a controlled environment for NFT transactions, adding an element of exclusivity and urgency to the sale process.
NFT Reveal Process: One unique feature of the Colony Platform is the NFT reveal process. A user may access the Colony Platform to initiate revealing of an NFT which the user has minted or purchased, which in turn causes the NFTs traits and attributes to be publicly revealed. In at least some embodiments, the platform or smart contract may automatically initiate the revealing of all or selected NFTs of a given NFT collection in response to the occurrence of specific events and/or conditions. For example, in one embodiment, once the reveal window is open for a specific NFT collection, owners may be given 24 hours to personally initiate the revealing of their NFTs. After the 24 hours as elapsed, the system may then automatically cause any remaining unrevealed NFT's of the collection to be automatically revealed. In at least one embodiment, this process may be authenticated through EIP712 Signatures.
Automated Buyback Offers: Provides a novel NFT buyback mechanism utilizing a buyback offer smart contract which is configured or designed to provide functionality for automatically generating buyback offers to Drop NFT owners after the reveal of NFT traits. In at least one embodiment, the buyback smart contract is configured or designed to include functionality for automatically and dynamically calculating or determining a customized buyback offer amount for each Drop NFT.
NFT Buyback Mechanism—When an owner of a Drop NFT is presented with a buyback offer, the owner may elect to accept the buyback offer to execute a Drop NFT buyback procedure. In at least one embodiment, the Drop NFT buyback procedure represents a contractual NFT sale-purchase agreement, where the seller is the Drop NFT owner, and the buyer is the buyback smart contract. Execution of the Drop NFT buyback procedure involves: (i) the Drop NFT being automatically transferred out of the user's wallet and either burned or sent to a different wallet address controlled by the smart contract; and (ii) transfering the Buyback Offer payment amount into the user's wallet. This process is only permissible within a designated buyback period (or buyback window), ensuring a regulated and fair environment for all platform users. In at least one embodiment, the Buyback Offer payment amount may be funded using a portion of the proceeds or revenue generated from the Drop mint.
Admin Withdrawal: Colony Platform administrators have the authority to manually withdraw remaining proceeds from the Drop mint. In one embodiment, this action is only permissible after the buyback period has concluded, adding another layer of control and oversight to the platform's financial transactions.

Various aspects relating to the Colony NFT Collection Drop utility may include, but are not limited to, one or more of the following (or combinations thereof):
Whitelisting and Proxy Deployment: The Colony Platform includes functionality for providing the ability to whitelist implementation addresses. In some embodiments, this feature may be restricted for use by system admins. In some embodiments, this feature may be made available to vetted platform users, for example, through EIP712 signatures.
Admin Control: The platform allows for robust admin control, including the ability to add or remove administrators. This feature ensures that the platform may adapt and respond to its evolving needs while maintaining a high level of oversight and governance.
Clone Deployment: The use of clones to deploy minimal proxies is another advantageous feature of the platform, allowing for more efficient and flexible contract management.
Unique Collection Addition: The Colony Platform provides the functionality to add unique NFT collections (non-templates) to the protocol, and to be indexed. This feature enables the platform to host a diverse range of NFT collections, catering to a wide array of tastes and preferences.
Batch Configuration: For ease of indexing and management, the platform supports batch configuration of sub-collections. This feature simplifies the administrative process, particularly in scenarios where extensive collections are involved.

Various aspects relating to the Drop Template utility may include, but are not limited to, one or more of the following (or combinations thereof):
Hosting Primary Sales: The Drop template is designed to facilitate the hosting of primary sales, providing creators and sellers with a streamlined, user-friendly interface for launching their NFT collections.
Buyback Mechanism: A novel aspect of the Drop template is the inclusion of a buyback mechanism, which may be funded based on a relative percentage of the total mint funds generated. In one embodiment, the Colony Platform supports adoption of EIP712 signatures for this functionality, which may be particularly useful in scenarios requiring recalibration of rarity values (e.g., composite trait scores) for unsold collections.
Metadata Inclusions: The Drop template encompasses a range of various types of metadata to support comprehensive management of NFT sales. Such metadata may include, for example, one or more of the following (or combinations thereof):
   Sale Start Time
   Buyback Start Time
   Buyback End Time
   Mint price
   Max Mints per wallet
   Max supply of NFTs that may be minted
   Etc.

### Colony Platform Process Flows and Graphical User Interfaces

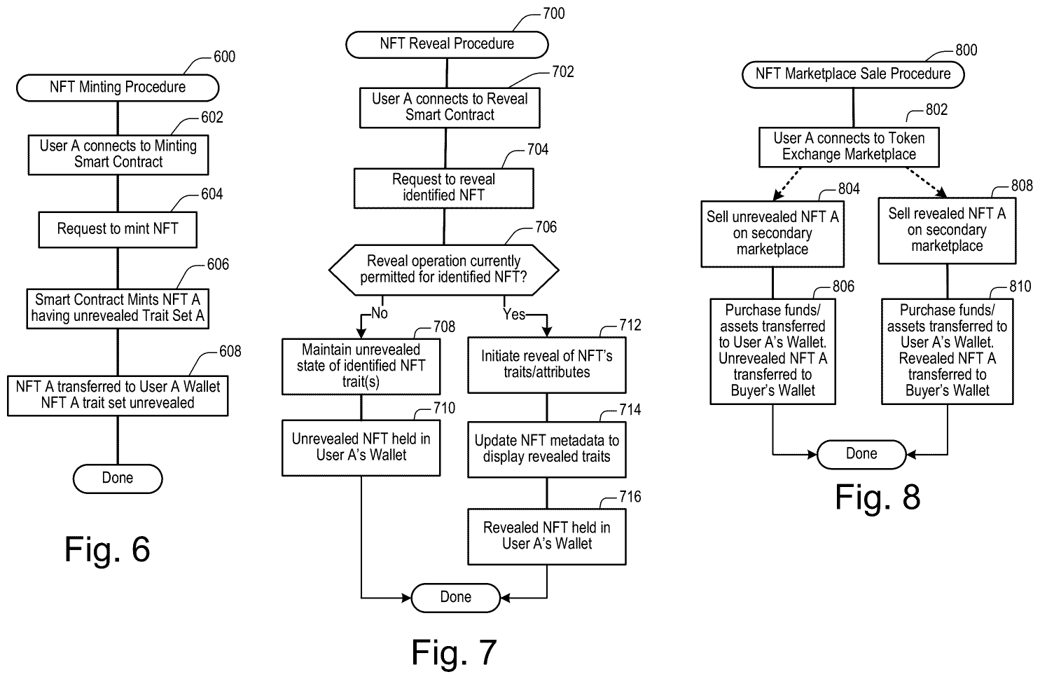

FIGS. 6-12 and 20-30 illustrate various example embodiments of different Colony Platform procedures and/or procedural flows which may be used for facilitating activities relating to one or more of the Colony Platform aspects disclosed herein.

According to different embodiments, at least a portion of the various types of functions, operations, actions, and/or other features provided by the Procedures of FIGS. 6-12 and 20-30 may be implemented at one or more client systems(s), at one or more System Servers (s), at one or more blockchain component(s), and/or combinations thereof.

In at least one embodiment, one or more of the procedures disclosed herein may be operable to utilize and/or generate various different types of data and/or other types of information when performing specific tasks and/or operations. This may include, for example, input data/information and/or output data/information. For example, in at least one embodiment, the Colony Platform procedures may be operable to access, process, and/or otherwise utilize information from one or more different types of sources, such as, for example, one or more local and/or remote memories, devices and/or systems. Additionally, in at least one embodiment, at least some procedures may be operable to generate one or more different types of output data/information, which, for example, may be stored in memory of one or more local and/or remote devices and/or systems. Examples of different types of input data/information and/or output data/information which may be accessed and/or utilized may include, but are not limited to, one or more of those described and/or referenced herein.

In at least one embodiment, a given instance of at least one of the procedures may access and/or utilize information from one or more associated databases. In at least one embodiment, at least a portion of the database information may be accessed via communication with one or more local and/or remote memory devices. Examples of different types of data which may be accessed by at least one of the procedures may include, but are not limited to, one or more of those described and/or referenced herein.

According to specific embodiments, multiple instances or threads of at least one of the procedures may be concurrently implemented and/or initiated via the use of one or more processors and/or other combinations of hardware and/or hardware and software. For example, in at least some embodiments, various aspects, features, and/or functionalities of at least one of the procedures may be performed, implemented and/or initiated by one or more of the various systems, components, systems, devices, procedures, processes, etc., described and/or referenced herein.

According to different embodiments, one or more different threads or instances of at least one of the procedures may be initiated in response to detection of one or more conditions or events satisfying one or more different types of minimum threshold criteria for triggering initiation of at least one instance of at least one of the procedures. Various examples of conditions or events which may trigger initiation and/or implementation of one or more different threads or instances of at least one of the procedures may include, but are not limited to, one or more of those described and/or referenced herein.

According to different embodiments, one or more different threads or instances of at least one of the procedures may be initiated and/or implemented manually, automatically, statically, dynamically, concurrently, and/or combinations thereof. Additionally, different instances and/or embodiments of at least one of the procedures may be initiated at one or more different time intervals (e.g., during a specific time interval, at regular periodic intervals, at irregular periodic intervals, upon demand, etc.).

In at least one embodiment, initial configuration of a given instance of at least one of the procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of at least one of the procedures may correspond to and/or may be derived from the input data/information.

It will be appreciated that the procedural diagrams of FIGS. 6-12 and 20-30 are merely specific examples of procedural flows and/or other activities which may be implemented to provide one or more features, functions and/or other aspects of the Colony Platform techniques described herein. Other embodiments of procedural flows (not shown) may include additional, fewer and/or different steps, actions, and/or operations than those illustrated in the example procedural diagrams of FIGS. 6-12 and 20-30.

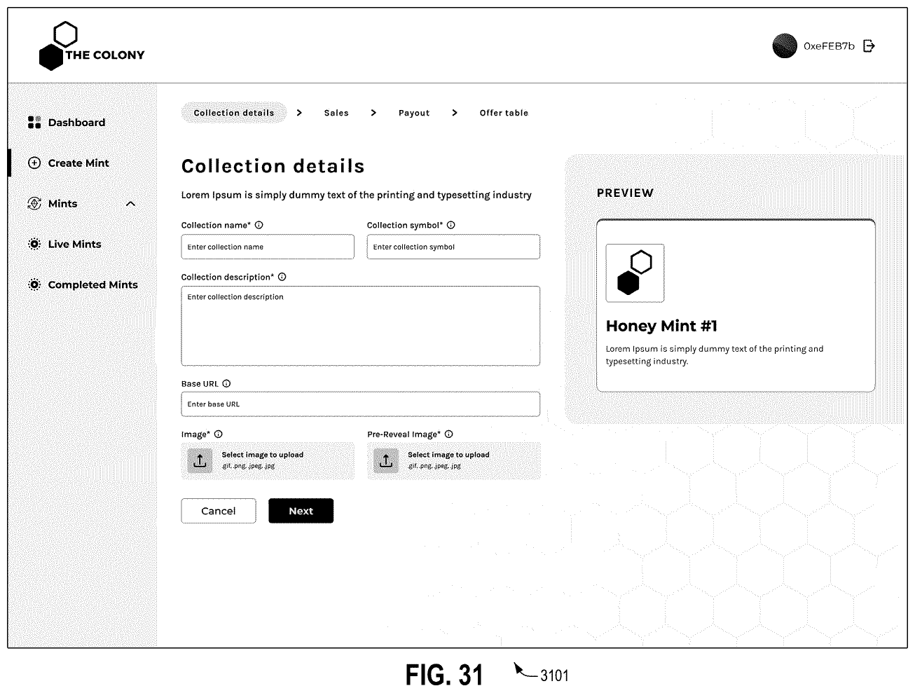

FIGS. 31-65 illustrate example screenshots of various graphical user interfaces (GUIs) which are configured or designed to facilitate activities relating to one or more of the Colony Platform's features. procedures and/or process flows disclosed herein. In at least one embodiment, at least a portion of the GUIs may be configured or designed for use at one or more mobile devices.

For purposes of illustration, the process flows of FIGS. 6-12 and 20-30 will now be described with reference to the GUIs illustrated in FIGS. 31-65.

FIG. 6 shows an example flow diagram of an NFT Minting Procedure 600 in accordance with one embodiment. At least a portion of the operations of the NFT Minting Procedure may be initiated and/or executed at one or more components of the Colony Platform to facilitate the minting of NFTs for a given NFT collection or NFT Drop.

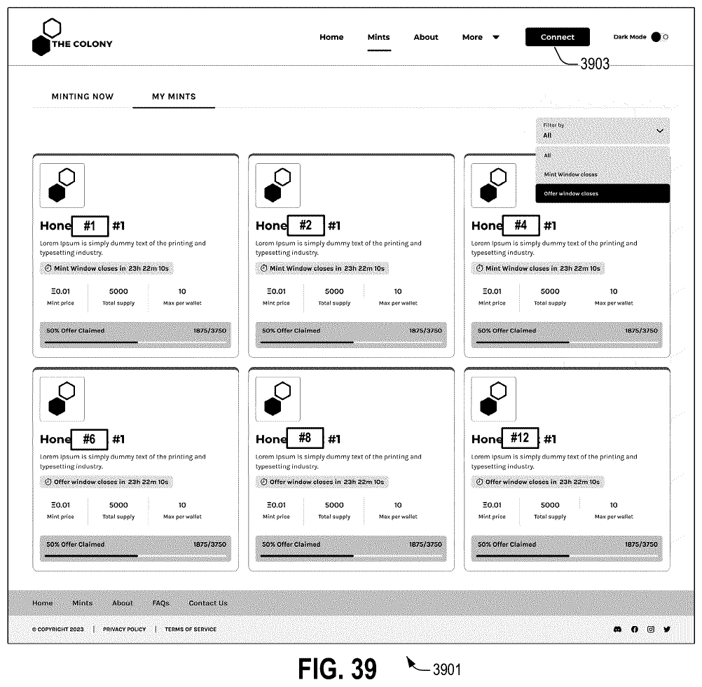

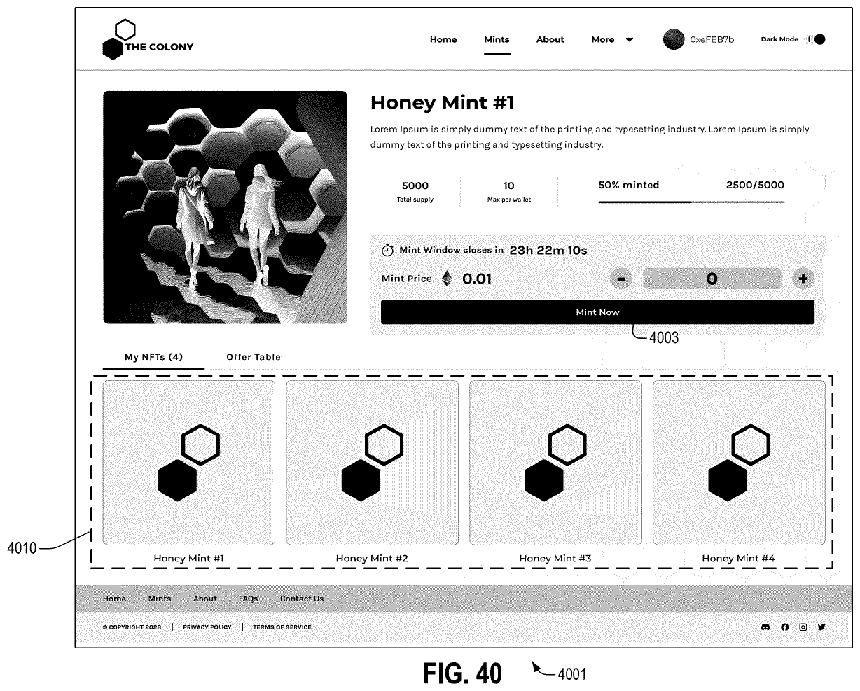

User A connects to Minting Smart Contract (602). User A establishes a connection with the Minting Smart Contract. This connection process may involve several sub-steps such as, for example:
Wallet Connection: The user's digital wallet is linked or connected with the Colony Platform to initiate and authorize blockchain transactions. In one embodiment, user may initiate this by clicking on the Connect button 3903 of FIG. 39.
Resource Check: In some embodiments, the system may verify that User A has sufficient resources (e.g., cryptocurrency) to cover any transaction fees associated with minting the NFT.
Smart Contract Interaction: The user interacts with the smart contract, through a user interface (e.g., Live Mint Details GUI 4001, FIG. 40).

Request to mint NFT (604). In this step, it is assumed that User A initiates a request to mint a new NFT associated with a specific NFT collection. For example, in one embodiment, User A may access the Colony Platform and navigate to a Live Mint Details GUI (e.g., 4001, FIG. 40) to view details relating to a live NFT Drop (e.g., Honey Mint Drop). The user may specify the quantity of NFTs she wishes to mint from the collection, and may initiate the minting process by clicking on the Mint Now button 4003. Before executing on the mint request, the mint smart contract may validate the mint request to confirm that the parameters of the mint request are in compliance with the minting rules and minting eligibility criteria specified in the smart contract.

Smart Contract Mints NFT A having unrevealed Trait Set A (606). The smart contract processes and executes User A's mint request and mints new NFT (NFT A) having randomly selected Trait Set A. In one embodiment. sub-steps of this sub-steps may include:
NFT Creation: The smart contract generates a new NFT with a unique identifier (e.g., NFT A).
Randomized Attribute/Trait selection: In conformance with rules defined in the smart contract, the smart contract randomly selects a set of attributes/traits (e.g., Trait Set A) from a domain of available attributes/traits for that NFT collection, and assigns the selected trait set to the new NFT. In at least one embodiment, the traits/attributes of the newly minted NFT are hidden or prevented from being publicly revealed for an initial time interval.
NFT minting fees collected from User/User's wallet. According to different embodiments, the Colony Platform may provide users with several options for funding the NFT mint transactions, such as, for example, via cryptocurrency, bank transfer, credit card, debit card, 3rd party payment providers such as PayPal, etc.
Blockchain Record: The creation of the NFT is recorded on the blockchain, ensuring transparency and immutability.

NFT A transferred to User A Wallet, NFT A trait set unrevealed (608). This step involves transferring the newly minted NFT to User A's wallet. However, the traits of NFT A remain unrevealed at this stage. The sub-steps of this step may include:
Transfer Execution: The smart contract executes a transfer of NFT A to User A's wallet address.
Unrevealed Status Maintenance: The traits of NFT A are kept hidden/unrevealed. This helps to maintain intrigue or for a later reveal event, and also allows NFT owners to take advantage of market speculation.

In at least one embodiment, the process of initially minting an NFT with unrevealed traits and then subsequently updating it to reveal its traits involves a combination of smart contract programming and a strategic approach to NFT metadata management. This process adds an element of surprise and excitement for NFT collectors, making the reveal and buyback offer events a significant part of the NFT project's lifecycle. By way of illustration, one example embodiment for implementing such a reveal process will now be described.
Initial Minting with Hidden Traits:
   Smart Contract Deployment: A first step is to deploy a smart contract on a blockchain platform (e.g., Ethereum) that supports NFTs. This contract governs the minting process.
   Placeholder Metadata: When a new NFT is minted, it is linked to a placeholder metadata file. This file doesn't contain the actual traits or attributes of the NFT but to a generic image or information indicating that the traits are hidden. This metadata is typically stored off-chain (e.g., on IPFS—InterPlanetary File System).
   Minting Process: Users interact with the smart contract to mint NFTs. Each NFT is unique but looks identical initially due to the placeholder metadata. (e.g., as shown at 4010, FIG. 40)
Updating the Metadata to Reveal Traits:
   Preparation of Actual Metadata: While the NFTs are minted with placeholder metadata, the actual metadata with the true traits and attributes of each NFT is prepared separately. This also includes unique images or descriptions that correspond to the NFT's individual characteristics. In conformance with rules defined in the smart contract, for each newly minted NFT, the smart contract may randomly select a set of attributes/traits from a domain of available attributes/traits for that NFT collection, and assign the selected trait set to the new NFT. In at least some embodiments, the attributes/traits of each NFT are randomized. The actual assignment of traits to each token ID may occur (based on geographical and sector regulations) at the reveal to ensure fairness and unpredictability. In some embodiments, the rarity table will be pre-determined based on the NFT collection size and dynamics.
   Triggering the Reveal: The reveal of traits is typically an event-controlled process. The trigger may be a specific time and date, reaching a certain number of sales, or a manual trigger by the contract owner. For example, in one embodiment, once the reveal window is open for a specific NFT collection, owners may be given 24 hours to manually trigger the revealing of their NFTs. After the 24 hours as elapsed, the system may automatically cause any remaining unrevealed NFT's of the collection to be automatically revealed.
   Updating Metadata Links: Once the reveal is triggered, the smart contract updates the links of each NFT's metadata to point to the actual metadata with revealed traits. This may be done by updating the URI (Uniform Resource Identifier) in the smart contract to point to the new metadata file.
   Visibility on Marketplaces: Once the metadata is updated, the changes reflect on various NFT marketplaces and wallets where these NFTs are held. Users may then see the revealed traits and attributes of their NFTs.
Other Aspects of the Reveal Process:
   Gas Fees: The process of updating metadata may incur transaction (gas) fees on the blockchain. In at least one embodiment, the Colony Platform may cover the cost of such gas fees, for example, by using revenue generated from the mint.
   The smart contract may be configured to include a function to update the base URI of the metadata. When this function is called, it switches the base URI from the placeholder to the actual metadata.
   The actual metadata (with revealed traits) should preferably be pre-uploaded to a decentralized storage like IPFS before the reveal, and the URI should point to this location.

FIG. 7 shows an example flow diagram of an NFT Reveal Procedure 700 in accordance with one embodiment. At least a portion of the operations of the NFT Reveal Procedure may be initiated and/or executed at one or more components of the Colony Platform to cause the revealing of the traits/attributes of an NFT after its initial minting and transfer.

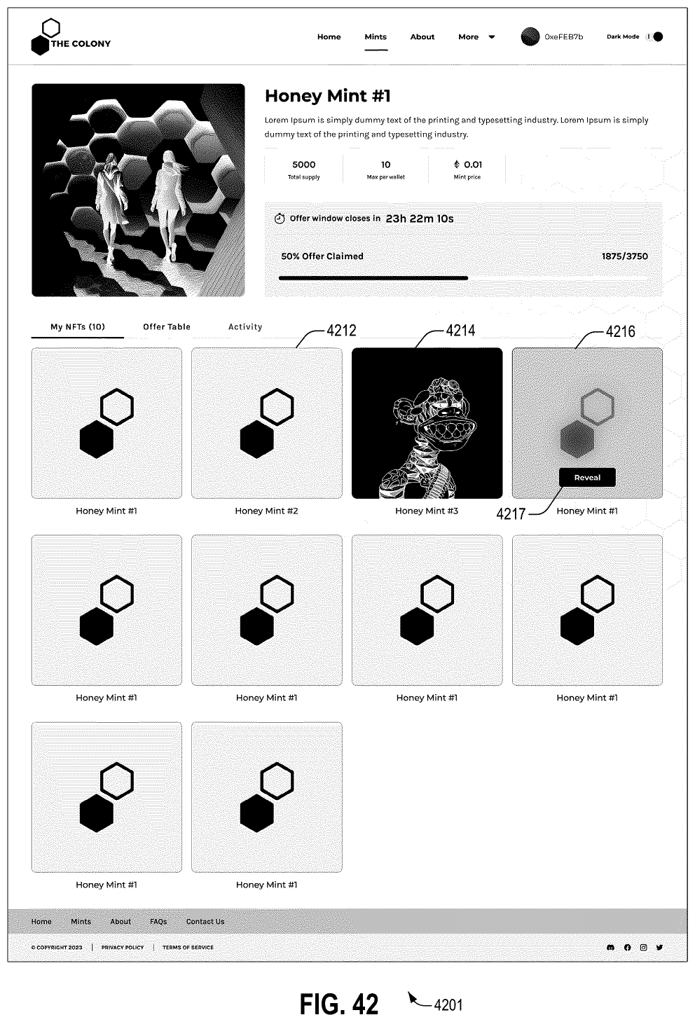

User A connects to Reveal Smart Contract (702). This step involves User A establishing a connection with the Colony Platform and/or Reveal Smart Contract. This connection is facilitated through a Colony Platform user interface (e.g., My NFTs GUI 4201, FIG. 42) that interacts with the blockchain. In some embodiments, this step may include ensuring that User A's wallet, which contains the NFT, is connected to the Colony Platform.

Request to reveal identified NFT (704). In this step, User A selects a specific NFT in their wallet for which is available to be revealed, and initiates a reveal request for the selected NFT. In one embodiment, the reveal request may be initiated by the user via interaction with a Colony Platform GUI (e.g., My NFTs GUI 4201, FIG. 42). For example, FIG. 42 shows an example Colony Platform GUI (e.g., My NFTs GUI 4201) which displays NFTs of a recent Colony NFT Drop which are owned by the user. For purposes of illustration, it is assumed in this example that a first portion of these NFTs (e.g., NFT 4212) are unrevealed and are not yet available to be revealed, e.g., as indicated by the absence of Reveal buttons for this first portion of NFTs. A second portion of these NFTs (e.g., NFT 4214) have already been revealed. A third portion of these NFTs (e.g., NFT 4216) are currently unrevealed and are available to be revealed by the user, e.g., as indicated by the presence of a Reveal button 4217. The user may initiate a request to reveal the selected NFT 4216 by clicking on the Reveal button 4217, which causes the Colony Platform to submit a transaction to the reveal/buyback smart contract to request the reveal of the selected NFT's traits/attributes.

Decision: Reveal operation currently permitted for identified NFT? (706, 708, 712). A decision-making process within the smart contract determines if the reveal operation is permitted. In at least one embodiment, the smart contract may be configured to store or access specific reveal-related rules and/or criteria which are required to be satisfied in order to permit the reveal operation to be performed for a specified NFT. Examples of such reveal-related rules and/or criteria may include, but are not limited to:

### Ownership Verification:

The smart contract checks if the user requesting the reveal is the legitimate owner of the NFT.
It ensures that the wallet address from which the request is made matches the NFT's registered owner on the blockchain.

### Reveal Timing Constraints:

The smart contract may be programmed to allow reveals only during a specified time window.
This may be aligned with a broader marketing strategy, such as synchronized reveals across all owners.
   Compliance with Platform Rules:
The smart contract ensures the request complies with any specific platform rules or standards set by the Colony Platform.
This may include checks against fraudulent or malicious activities and KYC checks where applicable.

### NFT Status Check:

The contract verifies that the NFT is indeed in an ‘unrevealed’ state and hasn't already been revealed.
It may also check for any locks or holds placed on the NFT that may prevent its reveal.

### Resource Availability:

Ensuring that the necessary computational resources (like gas for transaction fees) are available for executing the reveal.

### Smart Contract-Specific Logic:

Some smart contracts may include unique logic or conditions, such as requiring the completion of certain tasks or achievements by the user before revealing the NFT.
The contract may also interact with other contracts or external data sources to make this decision.
   Randomization Factors (if applicable):
For NFTs where the reveal includes some element of randomization (e.g., revealing random traits), the contract may perform checks to ensure fair and unbiased randomization processes.

### Security Checks:

The smart contract may perform security checks to prevent unauthorized access or manipulation during the reveal process.

Returning to the reveal operation decision step 706, if the Colony Platform and/or smart contract determines that the requested reveal operation is not currently permitted for identified NFT (708, 710), the system denies the NFT reveal request, and the NFT remains in its unrevealed state in User A's wallet. Alternatively, if the Colony Platform and/or smart contract determines that the requested reveal operation is currently permitted for identified NFT (712, 714, 716), the system initiates procedures for causing the reveal of the NFT's traits/attributes, which. for example. may include:
Automatically and/or dynamically determining the traits/attributes for the identified NFT, e.g., in embodiments where the actual assignment of traits to each token ID occurs at the reveal.
Updating Metadata Links: Once the reveal is triggered, the smart contract updates the links of the NFT's metadata to point to the actual metadata with revealed traits. This may be done by updating the URI (Uniform Resource Identifier) in the smart contract to point to the new metadata file.
Visibility on Marketplaces: Once the metadata is updated, the changes reflect on various NFT marketplaces and wallets where these NFTs are held. Users may then see the revealed traits and attributes of their NFTs.
Blockchain Record Update: In some embodiments, the blockchain record for the NFT may be updated to reflect the newly revealed traits/attributes.

After the reveal process has been completed the revealed NFT is held in User A's Wallet (716). In some embodiments, the reveal process involves the system automatically removing the unrevealed NFT from the user's wallet and burning it (e.g., sending it to a burn address), and transferring a revealed NFT (e.g., having a token ID which is different than the unrevealed NFT token ID) into the user's wallet. In other embodiments, the unrevealed NFT that was held in the user's wallet before execution of the reveal operation is the same NFT (e.g., has the same token ID) as the revealed NFT that is held in the user's wallet after execution of the reveal operation.

FIG. 8 shows an example flow diagram of an NFT Marketplace Sell Procedure 800 in accordance with one embodiment. At least a portion of the operations of the NFT Marketplace Sell Procedure may be initiated and/or executed at one or more components of the Colony Platform to facilitate a user selling an NFT via the Colony Platform marketplace or other secondary marketplace.

User A connects to Token Exchange Marketplace (802). The step involves User A connecting to the Token Exchange Marketplace, a platform component that facilitates NFT transactions. This step includes:
Authentication: Ensuring that User A is verified and authorized to access the marketplace.
Wallet Integration: Linking User A's wallet, which contains the NFTs, to the marketplace for transactions.
Marketplace Interface: User A accesses the marketplace's interface to list an NFT for sale.

Sell unrevealed NFT A on secondary marketplace (804). This step may be applicable to scenarios where the user holds an unrevealed NFT and wishes to sell the unrevealed NFT via a secondary marketplace. The Colony Platform is configured or designed to enable User A to list the unrevealed NFT (e.g., NFT A) for sale on the secondary marketplace. This process may involve:
Listing Creation: User A creates a listing for the unrevealed NFT, including setting a price and terms of sale.
Unrevealed NFT Appeal: The intrigue of an unrevealed NFT may be a selling point, as buyers speculate on its hidden traits.

Alternatively, in a different example scenario where the user holds a revealed NFT and wishes to sell the revealed NFT via a secondary marketplace, the Colony Platform is configured or designed to enable User A to list and sell (808) the revealed NFT (e.g., NFT A) for sale on the secondary marketplace This process may involve:
Revealed Traits Display: The listing includes detailed information about the NFT's revealed traits.
Pricing Strategy: User A may price the NFT based on its traits, rarity, or market demand.

NFT A sold to buyer (806, 810). In this example it is assumed that a buyer purchases NFT A from the seller. Once this sale is made, whether the NFT is revealed or unrevealed, the sale transaction is finalized through these steps:
Fund Transfer: The buyer's payment (funds/assets) is transferred to User A's wallet.
NFT Transfer: NFT A is transferred from User A's wallet to the buyer's wallet.
Transaction Record: The transaction details are recorded on the blockchain, ensuring security and transparency.

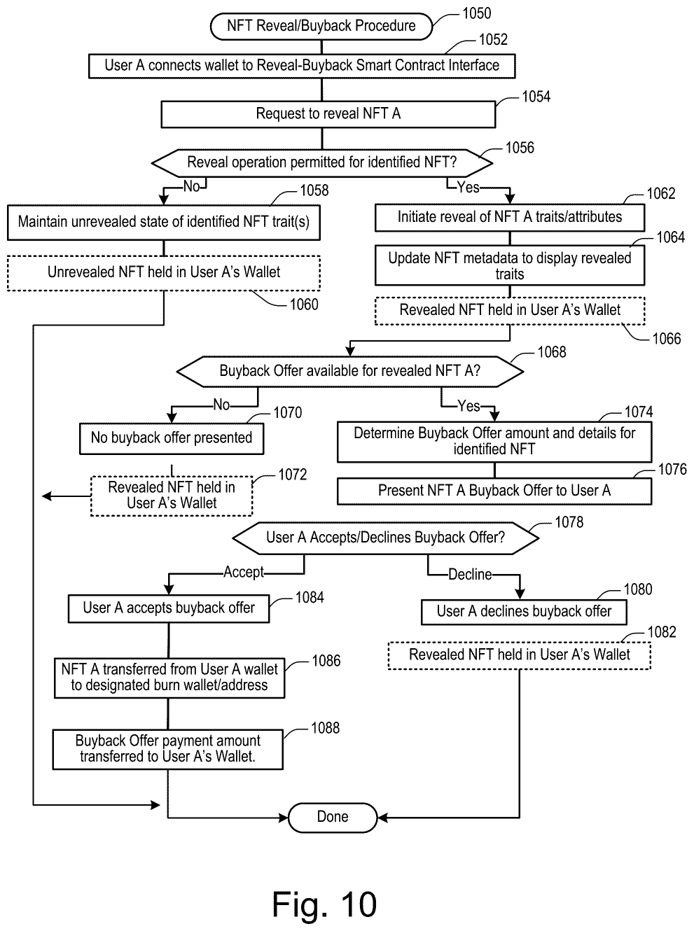

FIG. 10 shows an example flow diagram of an NFT Reveal/Buyback Procedure 1000 in accordance with one embodiment. At least a portion of the operations of the NFT Reveal/Buyback Procedure may be initiated and/or executed at one or more components of the Colony Platform to facilitate NFT reveal operations, NFT buyback offer operations, and NFT buyback transactions.

User A connects wallet to Reveal-Buyback Smart Contract Interface (1052): This step involves User A establishing a connection between their digital wallet and the Reveal-Buyback Smart Contract Interface.

NFT Reveal Procedure (1054-1066). The procedural steps 1054-1066 in FIG. 10 primarily encompass a sequence of actions for causing the revealing of the traits and attributes of an NFT following its initial minting and transfer. These steps are substantially similar to those of the NFT Reveal Procedure previous described with respect to FIG. 7. Given their similarity, a detailed repetition of these steps is not necessary.

As shown at 1068, after the traits/attributes of NFT A have been revealed, the system determines (1068) if conditions allow for a Buyback Offer to be presented to the owner (User A) for purchasing revealed NFT A. In one embodiment, a decision-making process within the smart contract determines if conditions currently allow for a Buyback Offer to be presented.

In at least one embodiment, the smart contract may be configured to store or access specific buyback-related rules and/or criteria which may be required to be satisfied in order to allow a Buyback Offer to be presented to the NFT A owner for purchasing the revealed NFT. Examples of such buyback-related rules and/or criteria may include, but are not limited to:
Eligibility and Offer Check: System (e.g., Colony Platform and/or smart contract) assesses if NFT A is eligible for a buyback offer and whether current conditions allow for a Buyback Offer to be presented.
Buyback Timing Constraints: The smart contract may be programmed to allow buyback offers to be presented and/or to allow buyback transactions to be conducted only during a specified time window (e.g., buyback window).
Buyback Offer value determination: In order for a buyback offer to be presented, the system may first check to verify that a buyback offer amount or value (representing the offer price) is able to be determined or calculated. If the system is currently unable to determine or calculate the buyback offer amount for the NFT A, it may determine that a buyback offer is not currently available.
Compliance with Platform Rules: The smart contract ensures the request complies with any specific platform rules or standards set by the Colony Platform. This may include checks against fraudulent or malicious activities.
NFT Status Check: The system checks for any locks or holds placed on the NFT that may prevent its buyback.
Resource Availability: Ensuring that sufficient funds are available to complete the buyback transaction if the offer is accepted.
Smart Contract-Specific Logic: Some smart contracts may include unique logic or conditions, such as requiring the completion of certain tasks or achievements by the user before a buyback offer for the NFT can be presented. The contract may also interact with other contracts or external data sources to make this decision.
Randomization Factors (if applicable): For NFTs where the buyback includes some element of randomization (e.g., buyback offer is randomly selected from a pool of available buyback offers), the contract may perform checks to ensure fair and unbiased randomization processes.
Security Checks: The smart contract may perform security checks to prevent unauthorized access or manipulation during the buyback process.

Returning to the Buyback Offer decision step 1068, if the system (e.g., Colony Platform and/or smart contract) determines that a Buyback Offer is not currently available for the identified NFT (1070), no buyback offer is presented, and the process concludes with the NFT remaining in User A's wallet. Alternatively, if the system determines that a Buyback Offer is currently permitted for the identified NFT, the procedure advances to generate and present a buyback offer to the owner.

Determine Buyback Offer amount and Buyback Offer details for identified NFT (1074): The system initiates procedures to calculate or determine the Buyback Offer amount and other Buyback Offer details for the identified NFT. This may involve, for example:
This step involves formulating the terms of the buyback offer for the NFT, which is central to the transaction process.
Computing a Rarity Score or Composite Trait Score for the identified NFT.
Using the Composite Trait Score to lookup or determine (e.g., from a table of predetermined buyback values) the Buyback Offer value.
Determining other Buyback Offer details such as, for example, Buyback Offer Expiration, type of payment to be offered (e.g., USDC, ETH, BTC, etc.)

Present NFT A Buyback Offer to User A (1076): The system generates and presents a Buyback Offer to User A to purchase NFT A for the Buyback Offer amount, and in accordance with the terms of the buyback offer.

Decision: User A Accepts/Declines Buyback Offer? (1078): User A may elect to accept or decline the Buyback Offer.
Buyback Offer Accepted: If User A accepts the Buyback Offer (1084), the system causes the NFT to be transferred from of User A's wallet to a designated blockchain address (such as a burn address). Additionally. the system causes funds relating to the Buyback Offer payment amount to be transferred to User A's Wallet.
Buyback Offer Declined: If User A declines (1080) or does not accept with Buyback Offer before its expiration, and the process concludes with the NFT remaining in User A's wallet.

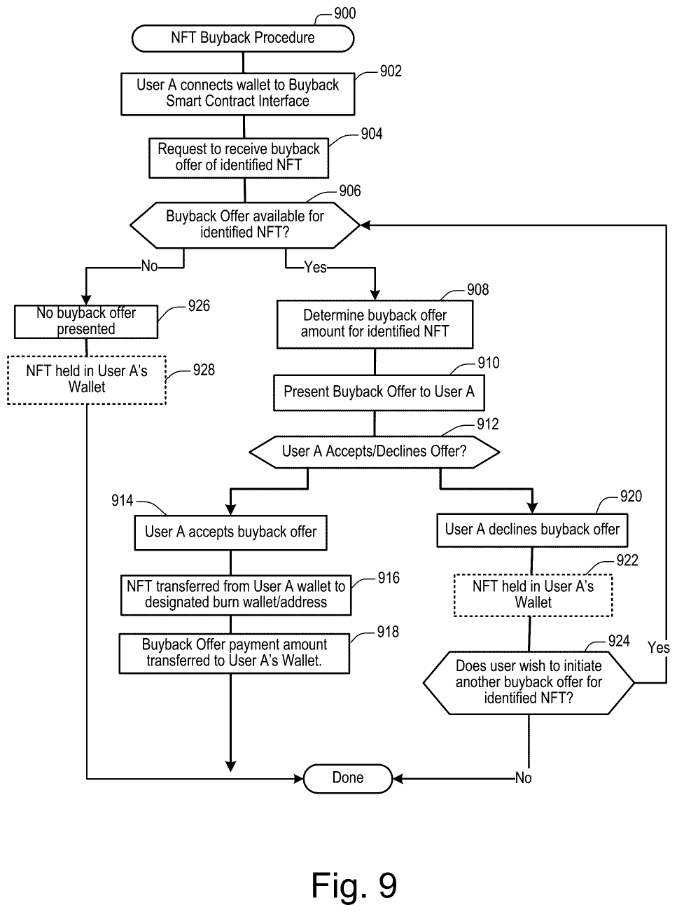

FIG. 9 shows an alternate embodiment of an NFT Buyback Procedure 900. In this alternate embodiment, the Colony Platform (and associated smart contracts) are configured or designed to enable an NFT owner of a Colony NFT collection to initiate one or more buyback offer requests for a given NFT in order to receive multiple different buyback offers for that NFT. This embodiment may be particularly desirable and advantageous for lottery type gaming use cases and marketing/promotional campaign use cases.

By way of illustration, in one example scenario, users may mint or purchase one or more NFTs from a new NFT drop. Initially, the minted NFTs are unrevealed. The rules of the NFT collection state that each NFT of the collection comes with the ability for the NFT owner to submit up to two different buyback offer requests for that NFT. The rules further stipulate that only one buyback offer request is allowed to be submitted while the NFT is unrevealed, and that only one buyback offer request is allowed to be submitted after the NFT has been revealed. A user owning one of the unrevealed NFTs may access the Colony Platform to initiate a first request to receive a buyback offer from the system to purchase the unrevealed NFT for a randomly determined buyback amount. The system processes the first buyback offer request, and randomly selects a first buyback offer amount from a pool or domain of predetermined buyback offer amounts. The system then presents a first buyback offer to the NFT owner to purchase the unrevealed NFT for the first buyback offer amount. The user may elect to accept or decline the first buyback offer.

If the user accepts the first buyback offer, the system completes the purchase transaction of the unrevealed NFT. The system causes the unrevealed NFT to be transferred from the user's wallet to a designated wallet address controlled by one of the Colony Platform's smart contracts, and also causes funds relating to the first buyback offer amount to be transferred into the user's wallet. Alternatively, if the user declines the first buyback offer, no NFT buyback transaction takes place, and the unrevealed NFT remains in the user's wallet. Regardless of whether or not the user elects to accept the first buyback offer, the smart contract is updated to reflect that one of Unrevealed NFT buyback offer request opportunities associated with the identified NFT has been consumed.

For purposes of illustration, it is assumed in this example that the user has elected to decline the first buyback offer. Subsequently, after the attributes/traits of the NFT have been revealed, the user may access the Colony Platform to initiate a second request to receive a buyback offer from the system to purchase the revealed NFT. The system processes the second buyback offer request, and determines a second buyback offer amount. According to different embodiments, the second buyback offer amount may be determined based on a rarity score or composite trade score which has been calculated for that NFT. Alternatively, the second buyback offer amount may be randomly selected from a pool or domain of predetermined buyback offer amounts. The system then presents a second buyback offer to the NFT owner to purchase the revealed NFT for the second buyback offer amount. The user may elect to accept or decline the second buyback offer.

If the user accepts the second buyback offer, the system completes the purchase transaction of the revealed NFT. The system causes the revealed NFT to be transferred from the user's wallet to a designated wallet address controlled by one of the Colony Platform's smart contracts, and also causes funds relating to the second buyback offer amount to be transferred into the user's wallet. Alternatively, if the user declines the second buyback offer, no NFT buyback transaction takes place, and the revealed NFT remains in the user's wallet. Regardless of whether or not the user elects to accept the second buyback offer, the smart contract is updated to reflect that one of Revealed NFT buyback offer request opportunities associated with the identified NFT has been consumed.

In at least one embodiment, the smart contract which manages the NFT collection continuously tracks buyback related activity associated with each NFT of the collection such as, for example, for an each NFT:
the initial total number of buyback offer request opportunities available to be consumed;
the number of buyback offer request opportunities available to be consumed while the NFT is unrevealed;
the number of buyback offer request opportunities available to be consumed after the NFT has been revealed;
the number of buyback offer request opportunities consumed while the NFT was unrevealed;
the number of buyback offer request opportunities consumed after the NFT was revealed;
details of any buyback offers presented to the user, including, for example, buyback offer amounts, timestamps relating to when the buyback offers were presented to the NFT owner, the user's responses to each of the buyback offers;
details relating to NFT buyback transactions which were processed in response to the user accepting buyback offer(s);
etc.

In at least some embodiments, the smart contract may also be configured are designed to access and manage one or more pools of predetermined buyback offer amounts, keeping track of which buyback offer amounts from the pool have been consumed and which buyback offer amounts are still available to be selected. In one embodiment, the smart contract may determine the buyback offer amount of a buyback offer by randomly selecting one of the available buyback offer amounts from pool, similar to the way individual lotto balls are selected from a hopper of lotto balls. In one embodiment, when a buyback offer amount is selected from the pool, the smart contract updates its records to indicate that that particular buyback offer amount has been consumed from the pool. In some embodiments, when a buyback offer amount is selected from the pool, the smart contract updates its records to indicate that that particular buyback offer amount has been consumed from the pool, regardless of whether or not the user accepts the buyback offer which includes the selected buyback offer amount.

Referring now to the example NFT Buyback Procedure of FIG. 9:
902: User A connects wallet to Buyback Smart Contract Interface
904: Request to receive buyback offer of identified NFT
   Initiating Request: User A submits a buyback offer request for their NFT, which can be in an unrevealed or revealed state.
   Request Processing: The smart contract processes the request, logging it with a timestamp for record-keeping.
906: Decision: Buyback Offer available for identified NFT?
   Eligibility Verification: The system checks if the NFT qualifies for a buyback offer based on predefined criteria, including its status within the collection (unrevealed/revealed).
   Availability Confirmation: The smart contract confirms whether a buyback offer is currently available for the specific NFT.
926, 928: No Buyback Offer Available
   No buyback offer presented
   Process concludes with the NFT remaining (928) in User A's wallet.
908: (Buyback Offer Available) Determine Buyback Offer Amount for Identified NFT
   Offer Calculation: For an unrevealed NFT, the system may randomly select a buyback offer amount from a pool of predetermined amounts. For a revealed NFT, the Buyback Offer amount may be based on a calculated rarity score or composite trait score, or may be randomly selected from a pool of predetermined buyback offer amounts.
Dynamic Offer Generation: The system dynamically generates a buyback offer amount tailored to the specific NFT.
910: Present Buyback Offer to User A
   Offer Presentation: The buyback offer, including the Buyback Offer amount and terms, is presented to User A via the platform.
   Decision Opportunity: User A reviews the offer and decides whether to accept or decline it.
912: Decision: User A Accepts/Declines Buyback Offer?
   User A may elect to accept or decline the Buyback Offer.
914, 916, 918: User A accepts buyback offer
   If User A accepts the Buyback Offer, the system causes the NFT to be transferred (916) from of User A's wallet to a designated blockchain address (such as a burn address).
   System causes funds relating to the Buyback Offer payment amount to be transferred (918) to User A's Wallet.
   Record Keeping: The smart contract logs the completion of the transaction, updating the NFT's status.
920, 922: User A declines buyback offer
   If User A declines or does not accept with Buyback Offer before its expiration, the NFT remains (922) in User A's wallet.
924: Decision: Does user wish to initiate another buyback offer for identified NFT? (Optional)
   Second Offer Request: Following a declined offer, User A may choose to initiate another buyback offer request.
   Processing of Additional Buyback Offer Request(s): The system processes this additional Buyback Offer request, for example, commencing from step 906.
924: NFT Held in User A's Wallet
   Retention of NFT: Post-decline, the NFT remains in User A's wallet.
   Preservation of Status: The NFT retains its status and eligibility for future buyback opportunities.
926: No Buyback Offer Presented
   Absence of Offer: In scenarios where no buyback offer is available or presented, the NFT remains with the user.
   Status Quo Maintained: The NFT's status on the platform remains unchanged.
928: Determination of Future Actions
   User Decision: User A decides whether to hold onto the NFT or initiate further buyback offers.
   Platform Interaction: The user may interact with the platform for future buyback opportunities or other actions regarding the NFT.

NFT Buyback Procedure of FIG. 9 ensures that NFT owners on the Colony Platform can engage in an interactive and dynamic process, receiving multiple buyback offers for their NFTs. The system is designed to provide flexibility and enhance user engagement, making it an attractive feature for both gaming and promotional activities. The integration of smart contracts ensures transparency and efficiency in managing these transactions, adhering to the platform's standards and user expectations.

Alternate embodiments of the NFT Buyback Procedure may be configured or designed to provide additional features/functionality such as, for example:
Second Buyback Offer Request (Post-NFT Reveal):
   After the NFT is revealed, User A may be permitted to initiate a second buyback offer request.
   According to different embodiments, the Buyback Offer amount offer may be based on a calculated rarity score or composite trait score, or may be randomly selected from a pool of predetermined buyback offer amounts.
Smart Contract Management of Buyback Activity:
   The smart contract continuously tracks the buyback-related activity for each NFT in the collection.
   This includes tracking the total number of buyback requests available, the number consumed in both unrevealed and revealed states, and the details of any buyback offers presented, including responses and transaction details.
Managing Pools of Predetermined Buyback Offer Amounts:
   The smart contract manages pools of predetermined buyback offer amounts.
   It keeps track of consumed Buyback Offer amounts and available (non-consumed) Buyback Offer amounts, updating records as different Buyback Offer amounts are selected from the Buyback Offer pool and whether they are accepted or declined.

The smart contract managing the NFT collection tracks buyback activity, including available and consumed buyback opportunities, and multitudes of buyback offers presented and accepted. The contract also manages pools of predetermined buyback offer amounts, updating records based on selection and consumption. This procedure demonstrates the platform's ability to facilitate interactive and dynamic NFT transactions, blending elements of gaming and investment in a legally compliant framework.

This procedure showcases the Colony Platform's capability to offer dynamic and flexible buyback options for NFT owners, enhancing engagement and interaction, especially in gaming and promotional contexts. The use of smart contracts to manage and track these processes ensures transparency, fairness, and efficiency in the buyback transactions.

One significant advantage of operating an NFT collection buyback campaign as described in various embodiments herein is that it enables lottery type NFT collection buyback campaigns to be deployed in a manner which is fully compliant with jurisdictional laws and regulations, and in a manner which does not require the operator to hold a gaming license in order to allow consumers to participate in the NFT collection buyback campaign. For example, in the Colony NFT collection buyback campaign embodiments described herein, users are legally purchasing digital assets in accordance with standard contract law.

The operation of a lottery-type NFT collection buyback campaign, as described for the Colony Platform, is structured in a way that is compliant with jurisdictional laws and regulations and which does not necessitate a gaming license. This is achieved by aligning the campaign's structure with the principles of contract law, rather than those governing traditional gambling activities. Below is a discussion explaining some of these principles:
Compliance with Jurisdictional Laws and Regulations: In at least some of the NFT collection buyback campaign examples described herein, the lottery-type element is integrated into a system where users are essentially engaging in buying and selling digital assets (NFTs). This activity differs from traditional gambling because it lacks required gambling elements. Instead of wagering money with uncertain outcomes based purely on chance, users purchase NFTs as digital assets. The element of chance is introduced not in the purchase, but in the potential future value of these assets, which is a common characteristic in many legitimate investment activities and the may or not be pre-determined—dependent on regulatory constraints.
Legal Purchase and Sale in Accordance with Contract Law: When users purchase NFTs, they enter into a contract where they offer a certain amount of money in exchange for the digital asset. Once the NFT issuer accepts this offer, a contract is formed with mutual consent and consideration (money for NFT). Similarly, when a user accepts a buyback offer, they agree to sell the NFT back at a determined price. This again constitutes a contractual agreement with clear offer, acceptance, and consideration.
Meeting Contractual Agreement Criteria:
   Offer and Acceptance: The buyback offer made by the platform for an NFT and its acceptance by the user meet the criteria of offer and acceptance in contract law.
   Mutual Consent: Both parties willingly enter into the agreement, with the user having the option to accept or decline the buyback offer.
   Consideration: The consideration here is the value exchanged—the NFT for its buyback price.
Purchasing or Minting NFTs Not Considered Gambling: When users purchase or mint Colony NFTs, they receive a tangible digital asset in return. This transaction is more akin to a purchase of goods rather than a gamble, as the primary intent is to acquire an asset, not to win a prize by chance. The value of NFTs may fluctuate, and while this may introduce elements of risk and uncertainty, these characteristics are common in various forms of investments and asset acquisitions.
Accepting a Buyback Offer Not Considered Gambling: Accepting a buyback offer involves selling a digital asset (the NFT) back to the platform for a predetermined price. This is a standard sale transaction, not a wager or bet. Additionally, the user exercises control over whether to accept the offer, making it a decision based on their assessment of the NFT's value, rather than a gamble on an uncertain outcome.

The NFT collection buyback campaign on the Colony Platform is aligned with standard contract law principles rather than gambling regulations. This alignment helps to ensure the legality and regulatory compliance of the campaign, distinguishing it from traditional gambling activities. By structuring transactions as purchases and sales of digital assets with clear contractual elements of offer, acceptance, and consideration, the platform operates within the realm of legitimate commercial activity.

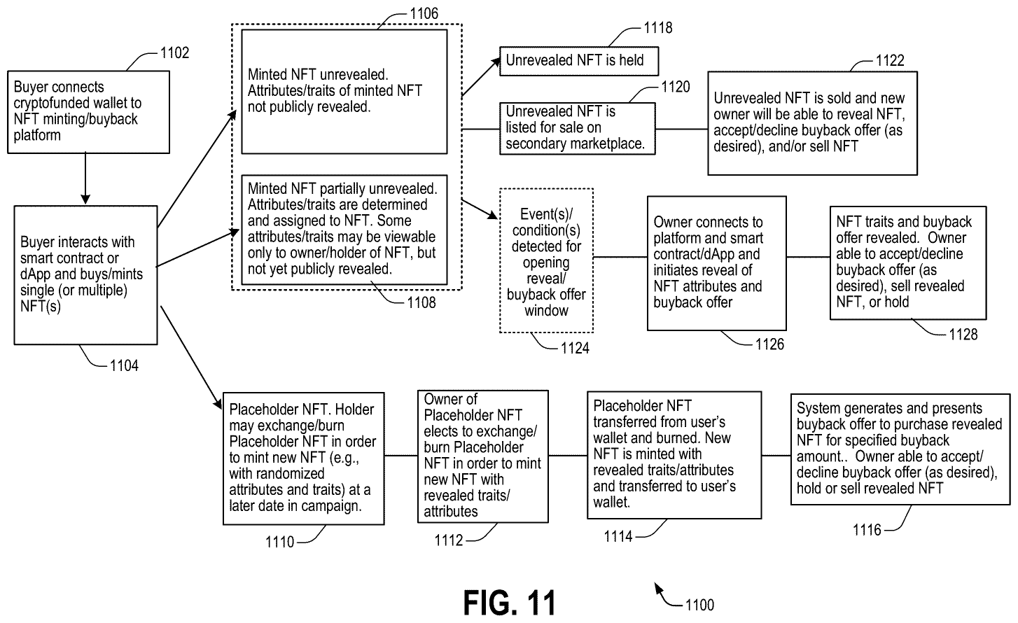

FIG. 11 shows a flow diagram of an NFT Collection Mint-Reveal-Buyback procedure illustrating one example embodiment of an NFT Collection Mint-Reveal-Buyback procedural flow which is executed by one or more components of the Colony Platform. This procedure is designed to integrate various functionalities of the platform, including NFT minting, revealing traits, and offering buyback options. Below is a description of the various steps or processes illustrated in the figure:
1102: Buyer connects crypto-funded wallet to NFT minting/buyback platform
   Prospective buyers connect their cryptocurrency wallets, funded with digital currency, to the platform.
   Wallet connection enables buyers to participate in NFT minting and buyback processes.
1104: Buyer interacts with smart contract or dApp and buys/mints single (or multiple) NFT(s)
   Buyers interact with the platform's smart contract or dApp to mint one or more NFTs.
   This step involves selecting NFTs, executing transactions, and confirming the minting process.
1106: Minted NFT unrevealed.
   In some embodiments, attributes/traits of the minted NFT are determined at time of minting and assigned to NFT but not yet publicly revealed. In other embodiments, attributes/traits of the minted NFT are dynamically determined at time of reveal.
   In at least one embodiment, the minted NFT may remain unrevealed for a predetermined time interval, according to the parameters defined in the controlling smart contract.
1108: Minted NFT partially unrevealed. In some embodiments, attributes/traits for the minted NFT are determined and assigned at time of minting. Some attributes/traits may be viewable only to owner/holder of NFT but not yet publicly revealed.
1118: Owner of unrevealed NFT elects to hold or keep it. Unrevealed NFT is held in owner's wallet.
1120: Owner of unrevealed NFT elects to listed unrevealed NFT for sale on secondary marketplace;
1122: Unrevealed NFT is sold and new owner will be able to reveal NFT accept/decline buyback offer (as desired) and/or sell NFT. Upon purchase, the new owner gains the right to reveal the NFT and may choose to accept or decline any buyback offer or resell the NFT.
1124: Event(s)/condition(s) detected for opening reveal/buyback offer window. In some embodiments, the smart contract(s) may be configured to include specific time/date parameters defining the opening/closing of the live mint window(s), the opening/closing of the reveal window(s), and the opening/closing of the buyback window(s). 1126: Owner connects to platform and smart contract/dApp and initiates reveal of NFT attributes and buyback offer.
1128: NFT traits and buyback offer revealed. Owner able to accept/decline buyback offer (as desired), and either keep or sell revealed NFT. The system reveals the NFT traits along with any buyback offer, allowing the owner to make informed decisions regarding selling, holding, or accepting the buyback.
1110: Placeholder NFT. In some embodiments, the minted NFT serves as a placeholder NFT, which the owner may exchange/surrender/burn at a future date/time in order to mint or receive a new NFT with revealed attributes and traits.
1112: Owner of Placeholder NFT elects to exchange/burn/surrender Placeholder NFT for new NFT with revealed traits/attributes. In at least one embodiment, the owner of the Placeholder NFT may access the Colony Platform to and initiate a request to exchange/burn/surrender Placeholder NFT in order to mint/receive a new NFT with revealed traits/attributes.
1114: Placeholder NFT transferred from user's wallet and burned. New NFT is minted with revealed traits/attributes and transferred to user's wallet. In some embodiments, the user may manually initiate the minting of the new NFT. In other embodiments, the system may automatically mint the new NFT and transfer it or airdrop it into the user's wallet.
1116: System generates and presents buyback offer to purchase revealed NFT for specified buyback amount. Owner able to accept/decline buyback offer (as desired), or hold or sell revealed NFT.

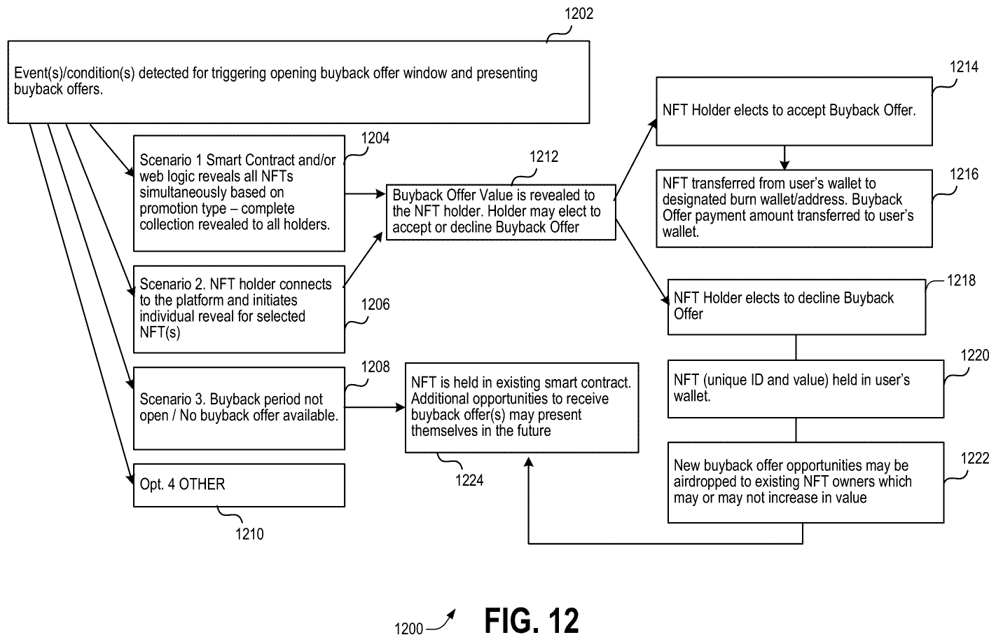

FIG. 12 shows a flow diagram of an NFT Buyback procedure illustrating one example embodiment of a flow which is executed by one or more components of the Colony Platform. This procedure is designed to illustrate various functionalities of the platform, and shows different scenarios relating to NFT reveal processes, buyback offer processes, and buyback transaction processes. Below is a description of the various steps or processes illustrated in the figure:
1202: Event(s)/condition(s) detected for triggering opening buyback offer window and presenting buyback offers
   According to different embodiments, the buyback process may be initiated or triggered by specific events or rules set, which may be defined within the platform's promotional campaigns, promotion rules, smart contract(s) and/or dApps (web server and logic).
   This step involves the activation of the smart contract or dApp, which governs the buyback process based on predetermined conditions or events. These conditions are predefined and may be time-based, event-based, or dependent on certain achievements within the platform.
1204: Scenario 1. Smart Contract and/or Web Logic Reveals All NFTs Simultaneously Based on Promotion Type—Complete Collection Revealed to All Holders
   In this scenario, the smart contract or web logic reveals all NFTs in a collection simultaneously, based on the type of promotion.
   This mass reveal to all holders enhances the collective experience and may significantly impact the market and community engagement.
   In one scenario, the Colony Platform initiates procedures to affect precise coordination and timing to ensure a simultaneous reveal across all holders.
1206: Scenario 2. NFT Holder Connects to the Platform and Initiates Individual Reveal for Selected NFT(s)
   In this scenario, a user may connect to the platform and initiate individual reveal requests for selected unrevealed NFTs owned by the user.
   This process involves the holder actively engaging with the platform to uncover the traits or attributes of their NFT.
1208: Scenario 3. Buyback period not open/No buyback offer available. In this scenario, the buyback period not open, has closed, or no buyback offer is available.
1210: Opt. 4 Other. This option covers other potential scenarios or actions that may arise in the buyback process not explicitly covered in the previous steps. It allows for flexibility in the procedure, accommodating unique or unforeseen circumstances in the NFT buyback process.
1212: Buyback Offer Value is revealed to the NFT holder. Holder may elect to accept or decline Buyback Offer
   While the buyback/buyback offer window is open, buyback offers may be generated by the system and presented to various NFT owners. In at least one embodiment, a buyback offer for a given NFT represents an offer by the platform or smart contract to purchase the identified NFT for a buyback offer amount which has been dynamically calculated for the identified NFT.
   The holder is then provided with options to accept or decline the Buyback Offer.
   The buyback offer amounts (or Buyback Offer value) may vary based on several variables, such as randomly predetermined characteristics, artistic rank, attributes, or other traits of the NFTs.
1214: NFT Holder Elects to Accept Buyback Offer
   When an NFT holder decides to accept the buyback offer, this decision is processed by the platform and by the smart contract which initiated the Buyback Offer.
   Acceptance involves the NFT holder agreeing to the terms of the buyback offer, including the Buyback Offer amount and other conditions.
   This step may involve digital signatures or other forms of confirmation to validate the holder's acceptance.
1216: NFT Transferred from User's Wallet to Designated Burn Wallet/Address. Buyback Offer Payment Amount Transferred to User's Wallet: Upon acceptance of the buyback offer, the system causes the identified NFT to be transferred from the NFT owner's wallet to a designated blockchain address (such as a burn address). Additionally, the system causes funds relating to the Buyback Offer payment amount to be transferred to the wallet which held the purchased NFT.
1218: NFT Holder Elects to Decline Buyback Offer
   If the NFT holder declines the buyback offer, this decision is recorded by the platform.
   The holder retains ownership of the NFT without engaging in the buyback transaction.
1220: NFT (Unique ID and Value) Remains in Initial Smart Contract: If no action is taken regarding the buyback offer, the NFT, with its unique ID and value, remains in the user's wallet.
1222: New Buyback Offer Opportunities May Be Airdropped to Existing NFT Owners Which May or May Not Increase in Value: For users who elect to keep or hold onto their NFTs in their wallets, the system may automatically airdrop new digital assets (e.g., NFTs) to the wallets holding the NFTs. This feature may be promoted as part of the utility which users may benefit from retaining ownership of the NFTs.
1224: NFT Is Held in Existing Smart Contract. Additional Opportunities to Receive Buyback Offer(s) May Present Themselves in the Future
   If the NFT holder does not engage with the buyback offer, the NFT remains within the existing smart contract.
   This allows the possibility of future buyback offers, keeping the NFT active within the platform's ecosystem.

The system may be configured or designed to present additional buyback offers to NFT holders at a later time during the campaign. These additional Buyback Offer may vary in value and may offer additional engagement and incentives for NFT holders.

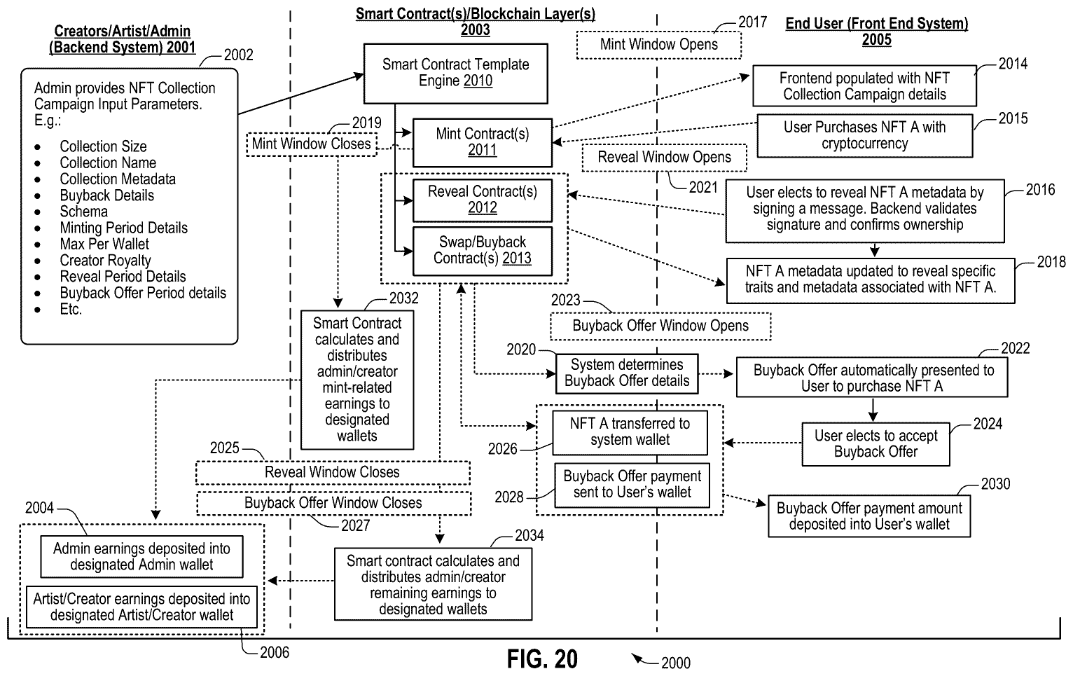

FIG. 20 shows an example embodiment of a system interaction and flow diagram demonstrating various interactions between the Colony Platform's Backend components (2001) & Front End components (2005) components and Smart Contract components (2003, 2010, 2011, 2012, 2013) of the blockchain layer. Below is a description of the various system components, process operations, and events illustrated in the figure:

2001: Backend System (Creators/Artist/Admin Activity): The Creators/Artist/Admin (Backend System) (2001) serves as an administrative and operational system of the Colony Platform. This system encompasses a range of functionalities tailored to the needs of creators, artists, and administrators who manage and oversee the NFT collection campaigns. The backend system 2001 is configured or designed to provide functionality for enabling creators, artists, and administrators to perform a variety of administrative tasks including, for example user management, campaign configuration, digital asset management, data analytics, integration with blockchain technologies, and/or other administrative tasks. Example administrative tasks may include:
Setting up and configuring new NFT collection campaigns.
Managing user roles and permissions within the platform.
Analyzing data from ongoing and past campaigns.
Integrating with smart contracts for seamless NFT transactions.

This backend system is helpful for maintaining the smooth operation of the platform, ensuring that creators and artists have the necessary tools to manage their NFT campaigns effectively.

2003: Smart Contract(s)/Blockchain Layer(s): The Smart Contract(s)/Blockchain Layer(s) (2003) handle the Colony Platform's blockchain functionality. These smart contracts automate and enforce the rules set for each NFT campaign, handling aspects like minting, reveals, and buyback processes. The layer ensures that all transactions are secure, transparent, and in compliance with the configured parameters. Example functions may include:
Executing minting processes based on defined NFT Collection Campaign configuration parameters.
Managing the reveal of NFT traits and metadata.
Handling buyback offers and NFT buyback transactions via the blockchain.
Handling distribution and transfer of digital currency and digital assets.
Etc.

2005: Front End System (End User Activity): The Front End System (2005) comprises Colony Platform components and user interfaces through which end users may interact and carry out activities via the Colony Platform. This system is designed to be user-friendly, allowing end users to engage in a variety of activities supported by the Colony Platform such as, for example, one or more of the following (or combinations thereof):
explore and participate in live NFT drops;
explore and participate in tokenize collectible drops;
browse, purchase, sell and interact with NFTs
view details of NFTs and NFT collections
mint NFTs.
initiate revealing of NFTs
request, view, accept, and decline swap/buyback offers
manage their digital assets;
engage in communications with other platform users and/or NFT holders
and/or other types of end user activities.

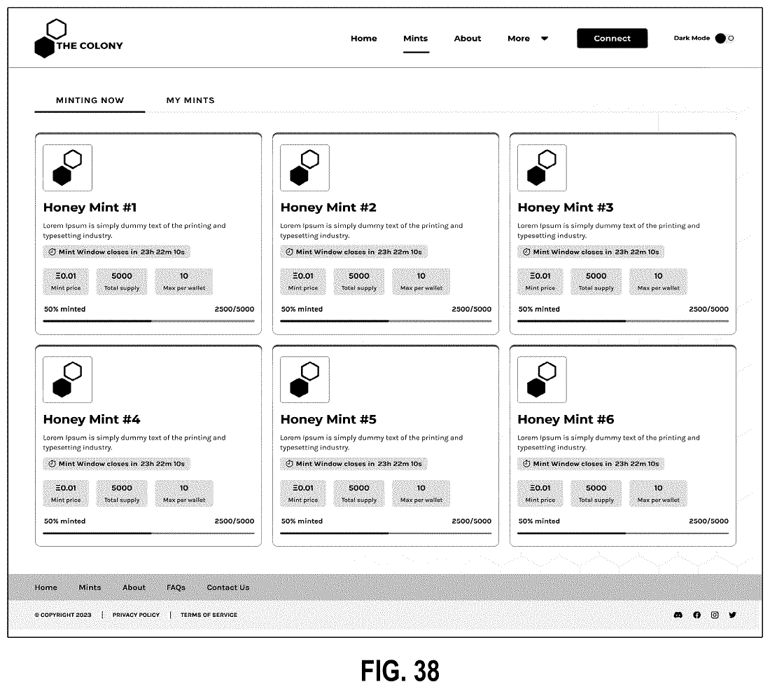

In at least one embodiment, the Colony Platform is configured or designed to provide end users with access to a variety of different Front End graphical user interfaces (“Front End GUIs”) which are specifically configured or designed to facilitate the carrying out of front end related tasks. Examples of such Front End GUIs are illustrated and described respect to FIGS. 38-45 and 56-65 of the drawings.

2010: Smart Contract Template Engine: The Smart Contract Template Engine (2010) is configured or designed to facilitate the generation and configuration of customized smart contracts based on configuration parameters provided by creators and admins. This engine automates the process of smart contract creation, ensuring that each contract is tailored to the specific requirements of each NFT campaign, allowing creators and collectors to create their own mints and integrated smart contracts.

In at least one embodiment, the Smart Contract Template Engine may be configured or designed to include a plurality of smart contract templates can be used for rapid deployment of customized smart contracts. Examples of such smart contract templates may include, but are not limited to, one or more of the following (or combinations thereof):
mint smart contract template(s)
reveal smart contract template(s)
buyback offer smart contract template(s)
buyback smart contract template(s)
reveal/buyback smart contract template(s)
and/or other types of smart contract templates.

Example functions which may be performed by the Smart Contract Template Engine may include:
Generating customized mint, reveal, and buyback contracts based on provided configuration parameters.
Ensuring that the contracts are compliant with blockchain standards.
Integrating these contracts seamlessly with the platform's backend and blockchain layers.

The Smart Contract Template Engine simplifies the complex process of configuring and deploying smart contracts, making it accessible and efficient for creators and admins.

2011: Mint Contract(s) : Mint Contract(s) (2011) are specialized smart contracts that handle the minting process of NFTs. These contracts are configured to execute the minting based on the configuration parameters set by the creators, including, for example, collection size, minting period, collection metadata, collection traits and attributes, mint fee, etc.

2012: Reveal Contract(s): Reveal Contract(s) (2012) manage the process of revealing hidden aspects of NFTs. such as specific traits, attributes, and metadata. These contracts are activated post-purchase, allowing users to discover unique attributes of their NFTs. This process adds an element of surprise and engagement for the users.

Example functions of reveal contracts may include:
Triggering the reveal of NFT traits at a predetermined time.
Ensuring the security and integrity of the reveal process.
Updating the NFT metadata on the blockchain post-reveal.

2013: Swap/Buyback Contract(s): Swap/Buyback Contract(s) (2013) are configured to enable and manage processes relating to buyback offers and buyback transactions within the platform. In some embodiments, Swap/Buyback Contract(s) may be configured to enable and manage processes relating to buyback offers and buyback transactions for NFT collections which are external to the Colony Platform.

According to different embodiments, the Swap/Buyback Contract(s) provide functionality for enabling users to engage in a variety of swap/buyback related activities under specific conditions, such as, for example:
Initiate requests for buyback offers
View buyback offer details
Accept/Decline buyback offers
and/or other swap/buyback related activities disclosed herein.

Example functions of Swap/Buyback contracts may include:
Calculating rarity or trait scores for selected NFTs in a collection
Determining buyback offer prices/amounts for selected NFTs
Automatically presenting buyback offers to users.
Executing NFT buyback transactions securely on the blockchain.
Calculating and transferring the buyback amount payment to users' wallets.
And/or swap/buyback related functions disclosed herein.

2002: Creator/Admin Accesses Colony Platform: In this process (2002), a creator or admin accesses the Colony Platform to provide various NFT Collection Campaign configuration parameters. These parameters are used for configuring and defining the specifics of each NFT campaign, such as collection size, name, metadata, live mint rules and parameters, reveal rules and parameters, buyback rules and parameters, buyback offer values, etc. These configuration parameters are fed to the smart contract template engine 2010 and used to deploy customized smart contracts (e.g., mint contract(s), reveal contract(s), swap/buyback contract(s)) relating to a specific NFT collection campaign. Examples of various NFT Collection campaign configuration parameters may include, but are not limited to, one or more of the following (or combinations thereof):
Collection Size
Collection Name
Collection Metadata
Buyback Details
Schema
Minting Period Details
Max Per Wallet
Creator Royalty
Reveal Period Details
Buyback Offer Period details
Any Buyback promotion details
Predetermined Buyback Offer Values
Etc.

In at least one embodiment, the Colony Platform is configured or designed to provide creators, artists, and administrators with access to a variety of different Backend graphical user interfaces (“Backend GUIs”) which are specifically configured or designed to facilitate the carrying out of backend system related tasks. Examples of such Backend GUIs are illustrated and described respect to FIGS. 31-37 and 46-55 of the drawings.

2017: Mint Window Opens: The Mint Window Opens (2017) marks the beginning of the minting period for the NFT collection. During this window, users have the opportunity to mint new NFTs based on the available collection.

2014: Frontend Populated with NFT Collection Campaign Details: In this step (2014), the front end of the platform is populated with details of the NFT collection campaigns. This process involves displaying information such as collection size, name, metadata, and other relevant details to the end users.

2015: User Purchases NFT A with Cryptocurrency: Here, the user purchases an NFT (referred to as NFT A) using cryptocurrency (2015). This process involves selecting the desired NFT from the collection, completing the transaction using a supported cryptocurrency, and transferring the NFT to the user's digital wallet.

2019: Mint Window Closes: The Mint Window Closes (2019) signifies the end of the minting period for the NFT collection. After this point, no further NFTs may be minted from this collection, marking the completion of the initial distribution phase.

2021: Reveal Window Opens: The Reveal Window Opens (2021) marks the start of the period during which NFT owners may access the Colony Platform to initiate requests to reveal the hidden traits of their NFTs. This window provides users with a timeframe to engage with their NFTs and discover their unique characteristics. In at least one embodiment, the system may be configured to automatically initiate the revealing of any remaining unrevealed NFTs of the collection at the end of the reveal period.

2016: User Elects to Reveal NFT A Metadata: In this operation (2016), the user elects to initiate a request to reveal the metadata of NFT A. This involves the user signing a message, which the backend system then validates to confirm ownership and to confirm if the reveal operation is permitted. In at least one embodiment, the smart contract may be configured to store or access specific reveal-related rules and/or criteria which may be required to be satisfied in order to permit the reveal operation to be performed for a specified NFT. Upon successful validation/confirmation, the process initiates processes to cause the revealing of the NFT's specific traits and attributes.

2018: NFT A Metadata Updated to Reveal Specific Traits: After initiation of the reveal process for revealing of the NFT's specific traits and attributes, the metadata of the NFT is updated (2018) to display its specific traits and attributes. This update process may be executed by the reveal smart contract, ensuring that the new information is accurately reflected on the blockchain and visible to the NFT owner.

2023: Buyback Offer Window Opens: The Buyback Offer Window Opens (2023) marks the commencement of a designated time frame within which users of the platform can receive buyback offers to sell back their NFTs back to the system, and initiate NFT buyback transactions (e.g., by accepting a buyback offer). During this period, the owner of NFT A may be presented with a buyback offer from the system to purchase NFT A for a specified buyback offer price (also referred to herein as “buyback offer amount” or “buyback offer value”). The user may elect to accept or decline/reject the buyback offer.

2020: System Determines Buyback Offer Details: In this step (2020), the system determines the details of the buyback offers for the NFTs. This involves calculating the buyback offer price and conditions based on predefined criteria defined in the smart contract, and making the offer available to NFT owners.

2022: Buyback Offer Automatically Presented to User: In at least one embodiment, the system may automatically and dynamically generate and present a buyback offer to the owner of NFT A to purchase the NFT for a specified buyback offer price. In one embodiment, the system may automatically and dynamically generate and present a buyback offer upon the opening of the buyback offer window. In some embodiments, the system may configure the timing of the opening of the buyback offer window to coincide with the timing of the opening of the reveal window, so that users may be immediately presented with a buyback offer upon the revealing of their NFTs.

2024: User Elects to Accept Buyback Offer: In this operation (2024), the user elects to accept the buyback offer for their NFT. This decision triggers a series of transactions, including the transfer of the NFT to a system controlled wallet (or to a designated burn address), and the transfer of the buyback offer price payment to the user's wallet.

2025: Reveal Window Closes: The Reveal Window Closes (2025) marks the end of the period during which users may reveal their NFTs. In one embodiment, after this window closes, the NFTs' traits and metadata remain fixed, and no further reveals are possible until a next opening of the reveal window (if scheduled).

2026: NFT A Transferred to System Burn Wallet: In one embodiment, once the user accepts the buyback offer, NFT A is transferred (2026) to the system's burn wallet. This process effectively removes the NFT from circulation. playing a role in managing the supply of NFTs within the platform.

2028: Buyback Offer Payment Sent to User's Wallet: Following the acceptance of a buyback offer, and the transfer of NFT A to a system controlled wallet, the system automatically initiates the process of transferring the buyback offer price payment to the user's wallet.

2030: Buyback Offer Payment Amount Deposited into User's Wallet: In this step (2030), the buyback offer payment amount is deposited into the user's wallet. This marks the completion of the NFT buyback transaction. compensating the user for the sale of their NFT to the system.

2027: Buyback Offer Window Closes: The Buyback Offer Window Closes (2027) signifies the end of the period during which buyback offers are available to users. After this point, no further buyback offers are presented, and no further buyback transactions are initiated, concluding this phase of the NFT lifecycle.

2032: Smart Contract Calculates and Distributes Admin/Creator Mint-Related Earnings: This process (2032) involves a smart contract calculating and distributing the earnings related to the minting of NFTs to the admin and creator's designated wallets. This automated distribution ensures that the revenues generated from the minting process are fairly allocated according to the predefined sharing percentages. In at least one embodiment, in accordance with predefined rules configured into the smart contract, the system may be configured to allow only a predetermined percentage (e.g., 25%) of the NFT mint revenue to be distributed to the admin/creators before the closing of the buyback window. The system holds the remaining percentage (e.g., 75%) of the NFT mint revenue in reserve to be used for funding payment of accepted buyback offer transactions and other related expenses, in accordance with predefined rules configured into the smart contract.

2034: Smart Contract Calculates and Distributes Remaining Earnings: In at least one embodiment, in response to detecting the close of the buyback offer window, the system calculates and distributes (2034) any remaining earnings from the NFT campaign to the admin and creator's designated wallets, in accordance with predefined rules configured into the smart contract. This step may also include the distribution of earnings from transactions other than minting, such as royalties from secondary sales.

2004: Admin Earnings Deposited: In this process (2004), earnings accrued to the admin from the NFT campaigns are automatically deposited into the designated admin wallet. This process involves calculating the due earnings based on the campaign's success and transferring the amount to the admin's wallet.

2006: Artist/Creator Earnings Deposited: In this operation (2006), earnings generated for artists and creators from the sale of NFTs are deposited into their designated wallets. This automatic process ensures that artists and creators are promptly compensated for their contributions to the platform, reflecting the sales and popularity of their NFT collections.

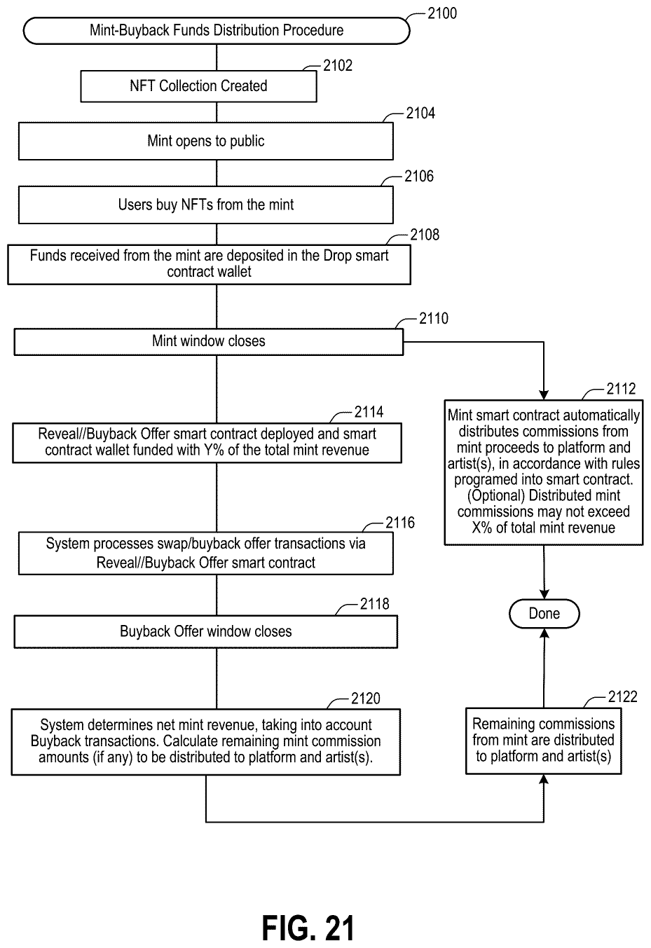

FIG. 21 shows an example embodiment of a Mint-Buyback Funds Distribution Procedure, illustrating various functionalities and procedural flows of the Colony Platform relating to the distribution of revenue generated from an NFT mint, in accordance with predefined rules. Below is a description of the processes and procedural flows illustrated in the figure.

2102: NFT Collection Created. At this initial stage, an NFT collection is created within the Colony Platform. This process involves configuring the parameters of the NFT collection, including configuring rules relating to the distributions of revenue generated from the NFT collection mint to various entities such as artists, creators, and administrators.

2104: Mint Opens to Public. In this phase, the minting process for the NFT collection is opened to the public. This is when potential buyers can participate in the minting process, purchasing NFTs from the collection.

2106: Users Buy NFTs from the Mint. This step involves the actual transaction where users buy NFTs from the mint. Interested buyers interact with the smart contract associated with the NFT collection to mint or purchase the NFTs. This process usually requires buyers to connect their digital wallets and pay the minting price, typically in cryptocurrency

2108: Funds Received from the Mint are Deposited in the Drop Smart Contract Wallet. Once users purchase the NFTs, the funds received from these transactions are deposited into a dedicated smart contract wallet, known as the Drop smart contract wallet. This wallet is designed to hold the funds securely and manage them according to the predefined rules set within the smart contract. The funds in this wallet are used for various purposes, including funding the buyback offers and distributing commissions.

2110: Mint Window Closes. After a specific period or once the NFT collection is fully minted, the mint window closes. This marks the end of the public minting phase and transitions the process to the next stages involving the distribution of funds and buyback offers.

2112: Mint Smart Contract Automatically Distributes Commissions. This process involves the smart contract calculating and distributing a portion of the earnings related to the minting of NFTs to the admin and creator's designated wallets in accordance with predefined rules configured into the smart contract. In at least one embodiment, the predefined rules configured into the smart contract may specify that only a predetermined percentage (e.g., 25%) of the NFT mint revenue is allowed to be distributed to the admin/creators before the closing of the buyback window. The system holds the remaining percentage (e.g., 75%) of the NFT mint revenue in reserve to be used for funding payment of accepted buyback offer transactions and other related expenses, in accordance with predefined rules configured into the smart contract.

2114: Reveal/Buyback Offer Smart Contract Deployed and Smart Contract Wallet Funded with Y % of Total Mint Revenue. In this step, a separate smart contract, specifically for the reveal and buyback offer, is deployed. This smart contract is funded with a certain percentage (denoted as Y %) of the total mint revenue (e.g., 75%). The percentage allocated is used to manage the buyback offers and other related transactions.

2116: System Processes Swap/Buyback Offer Transactions via Reveal/Buyback Offer Smart Contract. This process involves the Colony Platform's system processing swap and NFT buyback transactions, which are funded using the portion of the NFT mint revenue that was deposited into the Reveal/Buyback Offer Smart Contract Wallet.

2118: Buyback Offer Window Closes. Following the processing of swap/buyback offers, the window for these offers closes. This marks the end of the period during which NFT holders can opt to sell their NFTs back to the platform under the buyback scheme.

2120: System Determines Net Mint Revenue Taking into Account Buyback Transactions. After the closure of the buyback offer window, the system calculates the net mint revenue, taking into account all transactions, including all NFT buyback transactions.

2122: Remaining Commissions from Mint are Distributed to Platform and Artists. In response to detecting the close of the buyback offer window, the smart contract automatically calculates the net mint revenue and distributes any remaining commissions from the net mint revenue to the appropriate wallet addresses, in accordance with predefined rules configured into the smart contract. This step may also include the distribution of earnings from transactions other than minting, such as royalties from secondary sales.

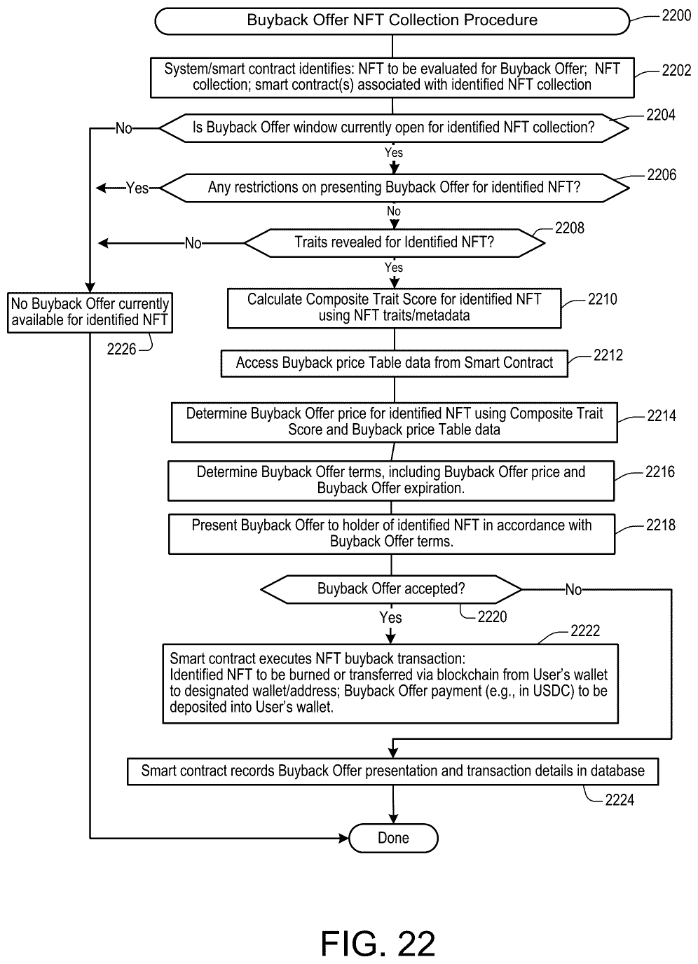

FIG. 22 shows an example of a Buyback Offer NFT Collection Procedure 2200, demonstrating a specific embodiment executed by one or more components of the Colony Platform. This procedure showcases various functionalities and procedural flows relating to NFT Collection Mints and associated automated buyback offer functionality and NFT buyback functionality. Below is a description of the processes and procedural flows illustrated in the figure.

2202: System/smart contract identifies: NFT to be evaluated for Buyback Offer; NFT collection; smart contract(s) associated with identified NFT collection

This step involves the system or smart contract identifying the specific NFT that is to be evaluated for a Buyback Offer. It includes identifying the NFT collection to which the NFT belongs and the associated smart contract(s) that govern the NFT collection.

Sub-steps/Subsidiary Processes of this step may include:
Retrieving NFT data from the blockchain.
Identifying and associating the NFT with its collection.
Fetching and linking the smart contract details relevant to the NFT.
   2204: Is Buyback Offer window currently open for identified NFT collection?

This step involves determining if the current time falls within the predefined period when Buyback Offers are allowed for the identified NFT collection. This is a gating step, ensuring that buyback activities are conducted within the appropriate timeframe set for the collection.

### Criteria Analyzed

The current date and time.
The predefined Buyback Offer window period set in the NFT collection's smart contract.

### Possible Outcomes and Next Steps

Yes (Proceed to Step 2206): If the Buyback Offer window is open, the process moves to the next step to check for any restrictions on the NFT.
No (End of Process): If the window is not open, the process ends, and no buyback offer is made.
   2206: Any restrictions on presenting Buyback Offer for identified NFT?

This step assesses if there are any specific restrictions or conditions in the smart contract or the collection's rules that would prevent a Buyback Offer from being presented for the identified NFT.

### Decision Evaluation

Determine if any restrictions apply to the identified NFT for a Buyback Offer.

### Criteria Analyzed

The terms and conditions outlined in the smart contract.
Any collection-specific rules or restrictions.

### Possible Outcomes and Next Steps

Yes (End of Process): If restrictions exist, the system informs the user that no Buyback Offer is currently available for identified NFT (2226).
No (Proceed to Step 2208): If no restrictions apply, the process moves to the next step to check if the traits of the NFT have been revealed.
   2208: Traits revealed for Identified NFT?

This step determines whether the traits or characteristics of the identified NFT have been revealed. The system may view the NFT's metadata on the blockchain to ascertain whether its traits are visible or hidden.

### Possible Outcomes and Next Steps

Yes (Proceed to Step 2210): If traits are revealed, the process moves to calculate the Composite Trait Score.
No (Proceed to Step 2226): If traits are not revealed, the system informs the user that no Buyback Offer is currently available for identified NFT (2226).

As noted previously, in at least some alternate embodiments, the system may be configured or designed to permit buyback offers to be generated and presented for NFTs whose traits are unrevealed.

2210: Calculate Composite Trait Score for identified NFT using NFT traits/metadata

This step involves calculating the Composite Trait Score (also referred to herein as “Trait Score”) for the identified NFT. This score is derived from the NFT's traits and metadata, forming a basis for determining the Buyback Offer's value.

### Input Information/Data

The NFT's traits and metadata.

### Output Information/Data

The Composite Trait Score of the NFT.

### Sub-steps/Subsidiary Processes

Analyzing the NFT's traits and metadata.
Applying a scoring algorithm to quantify the traits.
Generating a numerical score representing the NFT's value and rarity.

Examples of various scoring algorithms and methodologies which may be used for calculating the composites trait scores are described below.

2212: Access Buyback Value Table data from Smart Contract

In this step, the system accesses Buyback Value Table data from the associated smart contract. This table contains predetermined values or offer prices which are indexed based on composite trait score values. Using a composite trait score, the smart contract is able to use the Buyback Value Table data to determine a corresponding buyback offer value or offer price associated with that composite trait score, as described in step 2214.

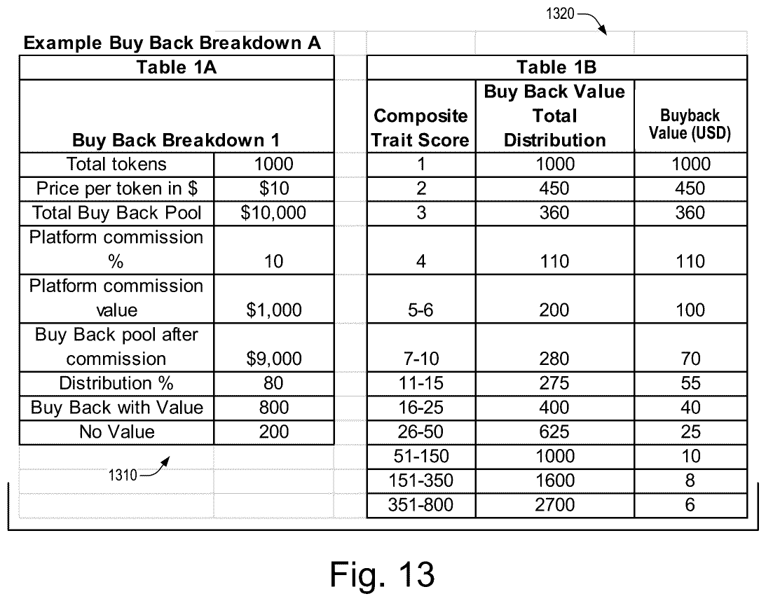

Illustrative examples of various Buyback Value Tables are described herein with respect to FIGS. 13-19 of the drawings.

2214: Determine Buyback Offer price for identified NFT using Composite Trait Score and Buyback Value

### Table Data

This step involves using the Composite Trait Score and the data from the Buyback Value Table to determine the value (or amount or price) of the Buyback Offer for the identified NFT.

### Input Information/Data

The Composite Trait Score of the NFT.
Data from the Buyback Value Table.

### Output Information/Data

The determined Buyback Offer amount/price for the NFT.

### Sub-steps/Subsidiary Processes

Calculating the Buyback Offer amount based on the Composite Trait Score and Buyback Value Table data.

In at least one embodiment, the Buyback Offer Value is determined using the Composite Trait Score of the NFT, derived from steps 2210 and 2212. The score reflects the rarity and uniqueness of the NFT's traits. For example, an NFT with a higher rarity (lower numerical score) may be valued more in the buyback offer.

A Buyback Value Table, such as, for example, Table 1B 1320 of FIG. 13, is used to assign a monetary value to the NFT based on its Composite Trait Score. This table categorizes NFTs into different rarity or trait score bands, assigning higher buyback values to rarer NFTs. For instance, an NFT with a rarity score of 1 might be valued at $1000, while a score of 2 might be valued at $450. Tokens with scores above a certain threshold (e.g., 801-1000) would not have a buyback offer.

2216: Determine Buyback Offer terms including Buyback Offer price and Buyback Offer expiration

This step involves determining the terms of the Buyback Offer, including the Buyback Offer price (calculated at 2214) and the Buyback Offer expiration date.

### Input Information/Data

The determined Buyback Offer price.
Platform policies and guidelines on offer expiration.

### Output Information/Data

A complete set of Buyback Offer terms, including Buyback Offer price and expiration date.

### Sub-steps/Subsidiary Processes

Setting an expiration date based on platform policies or smart contract rules. The Buyback Offer Expiration is also established, creating a time-limited window in which the NFT holder can accept the buyback offer.
Finalizing the offer terms for presentation to the NFT holder.
   2218: Present Buyback Offer to holder of identified NFT in accordance with Buyback Offer terms

This step involves presenting the finalized Buyback Offer to the owner/holder of the identified NFT. The NFT holder is notified through the platform's interface, where they can review specific details about the Buyback Offer. The holder is then given the choice to accept or decline the buyback offer within the stipulated timeframe.

### Input Information/Data

The finalized Buyback Offer terms.

### Output Information/Data

The response of the NFT holder (acceptance or rejection of the offer).

### Sub-steps/Subsidiary Processes

Communicating the offer to the NFT holder through the platform.
Recording the holder's response to the offer in the system.
   2220: Buyback Offer accepted?

At this decision step the system assesses whether the NFT holder accepts or rejects the presented Buyback Offer.

### Possible Outcomes and Next Steps

Yes (Proceed to Step 2222): If the holder accepts the offer, the process moves to execute the necessary procedures for the transfer and payment.
No (End of Process): If the holder declines, the process concludes, and the NFT remains with its current holder.

Regardless of whether or not the user elects to accept or reject the buyback offer, the system logs the details relating to the presented Buyback Offer and the user's response.

2222: Smart contract executes NFT buyback transaction.

Upon acceptance of the Buyback Offer, this step involves the execution of smart contract procedures. These procedures facilitate the transfer of the NFT from the user's wallet to a designated system wallet or address and the corresponding payment (e.g., in a cryptocurrency such as USDC) to the user's wallet.

### Input Information/Data

The user's acceptance of the Buyback Offer.
The details of the NFT and the user's wallet address.

### Output Information/Data

The transfer of the NFT from the user's wallet to a designated system wallet/address.
The deposit of the Buyback Offer payment into the user's wallet.

### Sub-steps/Subsidiary Processes

Initiating the NFT transfer transaction on the blockchain.
Executing the payment transaction to the user's wallet.
Confirming the completion of both transactions.
   2224: Smart contract records Buyback Offer presentation and transaction details in database

This step involves the smart contract recording the details of the Buyback Offer presentation, the user's response. and the NFT buyback transaction (if executed) in a database.

### Input Information/Data

Details of the Buyback Offer presentation.
Transaction details including NFT transfer and payment.

### Output Information/Data

A recorded entry in the database containing all pertinent details of the buyback transaction. Sub-steps/Subsidiary Processes
Capturing and logging the transaction details.
Ensuring the accuracy and integrity of the recorded data.
Updating the blockchain and database to reflect the completed transaction.

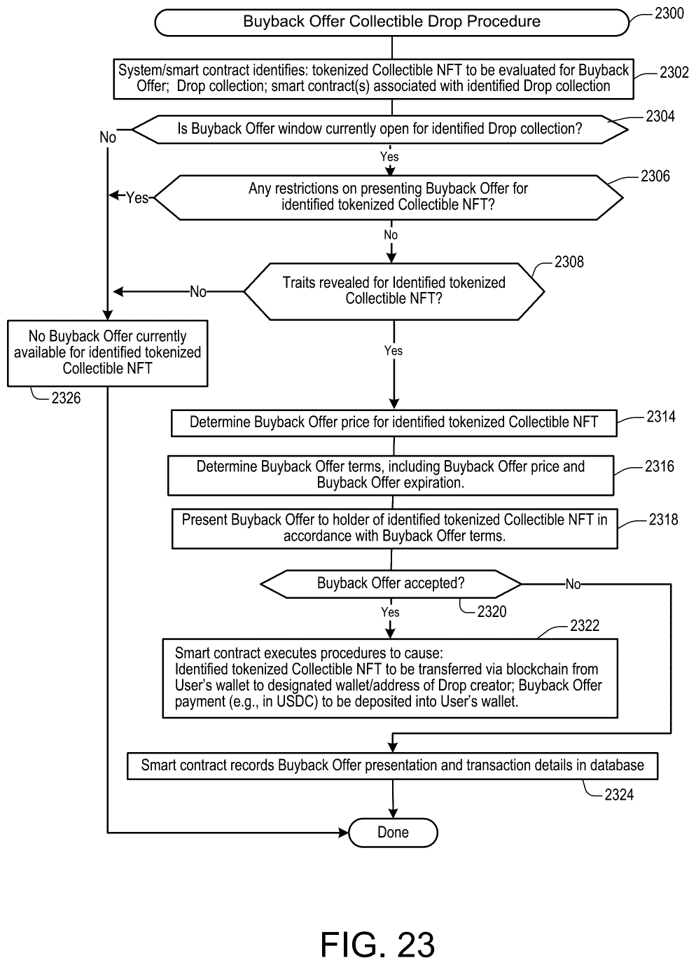

FIG. 23 shows an example of a Buyback Offer Collectible Drop Procedure 2300, demonstrating a specific embodiment executed by one or more components of the Colony Platform. This procedure showcases various functionalities and procedural flows relating to Tokenized Collectible Card Drops and associated automated buyback offer functionality and tokenized collectible card buyback functionality. Below is a description of the processes and procedural flows illustrated in the figure.

2302: System/smart contract identifies: tokenized Collectible NFT to be evaluated for Buyback Offer; Drop collection; smart contract(s) associated with identified Drop collection

This step involves the system or smart contract identifying the specific tokenized Collectible NFT that is to be evaluated for a Buyback Offer. It includes identifying the tokenized Collectible Drop collection to which the tokenized Collectible NFT belongs and the associated smart contract(s) that govern the tokenized Collectible Drop collection.

Sub-steps/Subsidiary Processes of this step may include:
Retrieving tokenized Collectible NFT data from the blockchain.
Identifying and associating the tokenized Collectible NFT with its collection.
Fetching and linking the smart contract details relevant to the tokenized Collectible NFT.
   2304: Is Buyback Offer window currently open for identified tokenized Collectible Drop collection?

This step involves determining if the current time falls within the predefined period when Buyback Offers are allowed for the identified tokenized Collectible Drop collection. This is a gating step, ensuring that buyback activities are conducted within the appropriate timeframe set for the collection.

### Criteria Analyzed

The current date and time.
The predefined Buyback Offer window period set in the tokenized Collectible Drop collection's smart contract.

### Possible Outcomes and Next Steps

Yes (Proceed to Step 2306): If the Buyback Offer window is open, the process moves to the next step to check for any restrictions on the tokenized Collectible NFT.
No (End of Process): If the window is not open, the process ends, and no buyback offer is made.
   2306: Any restrictions on presenting Buyback Offer for identified tokenized Collectible NFT?

This step assesses if there are any specific restrictions or conditions in the smart contract or the collection's rules that would prevent a Buyback Offer from being presented for the identified tokenized Collectible NFT.

For example, in one embodiment use case involving tokenized collectible trading cards, the system may check a local or remote database to determine if a physical card claim request has been submitted to redeem the physical collectible card which is linked to the identified tokenized collectible NFT. If the system detects this condition to be true, the system may temporarily block buyback offers from being generated and/or presented for the identified tokenized collectible NFT.

### Decision Evaluation

Determine if any restrictions apply to the identified tokenized Collectible NFT for a Buyback Offer.

### Criteria Analyzed

The terms and conditions outlined in the smart contract.
Any collection-specific rules or restrictions.

### Possible Outcomes and Next Steps

Yes (End of Process): If restrictions exist, the system informs the user that no Buyback Offer is currently available for identified tokenized Collectible NFT (2326).
No (Proceed to Step 2308): If no restrictions apply, the process moves to the next step to check if the traits of the tokenized Collectible NFT have been revealed.
   2308: Traits revealed for Identified tokenized Collectible NFT?

This step determines whether the traits or characteristics of the identified tokenized Collectible NFT have been revealed. The system may view the tokenized Collectible NFT's metadata on the blockchain to ascertain whether its traits are visible or hidden.

### Possible Outcomes and Next Steps

Yes (Proceed to Step 2310): If traits are revealed, the process moves to calculate the Composite Trait Score.
No (Proceed to Step 2326): If traits are not revealed, the system informs the user that no Buyback Offer is currently available for identified tokenized Collectible NFT (2326).

As noted previously, in at least some alternate embodiments, the system may be configured or designed to permit buyback offers to be generated and presented for tokenized Collectible NFTs whose traits are unrevealed.

2314: Determine Buyback Offer price for identified tokenized Collectible NFT

At this step, the system initiates procedures to determine the Buyback Offer value/price for the identified tokenized Collectible NFT. According to different embodiments, the system may employ various valuation techniques for determining the Buyback Offer value for a the identified tokenized Collectible NFT. Examples of valuation techniques may include, but are not limited to, one or more of the following (or combinations thereof):
Retrieving the Buyback Offer value from a Buyback Value data structure that has been populated with customized, predetermined buyback values specific to each tokenized collectible NFT in the tokenized collection. In one embodiment, the buyback offer value may be retrieved from the Buyback Value data using the unique token ID of the identified tokenized collectible NFT.
Dynamically determining the Buyback Offer value based on current market prices and/or historical sales data.

By way of illustration, one example methodology for dynamically determining the Buyback Offer value based on current market data may include:
Trait Analysis and Market Research: Once a tokenized Collectible NFT is revealed, the system analyzes its traits. This involves examining the unique characteristics, such as artwork, rarity, and other metadata. Concurrently, an online search is performed in real-time to determine the card's estimated market value. This might involve looking at sales listings and completed purchases on secondary marketplaces (e.g., eBay, Starstock.com, etc.).
Market Data Consideration: The platform compares the tokenized Collectible NFT's traits with physical collectible cards or assets with substantially similar properties, traits, or grading. Real-time and historical market/sales data are accessed to inform this comparison.
Dynamic Value Determination: The buyback value for the card is dynamically determined based on this market data research. This involves sophisticated algorithms that can adjust the buyback offer according to current market trends and the rarity of the tokenized Collectible NFT.
Smart Contract Update with Oracle Integration: The determined buyback value is then provided to the reveal/buyback contract. This may be achieved through the use of an oracle system, which feeds real-time data into the smart contract, allowing it to generate a buyback offer that reflects current market conditions.

Another example methodology for dynamically determining the Buyback Offer value based on current market data may include:
System deploys an automated backend scraper agent to acquire/retrieve latest market values after scraping through top secondary market platforms (e.g., eBay, Starstock.com, etc.).
System may dynamically adjust the scraped market values based on existing buyback pool, and creates a base version of buyback pool.
When user reveals the tokenized collectible NFT, the backend logic checks the real-time market value again based on backend logic and conditions to determine the Buyback Offer value to be presented to the user.
This implementation may be performed in near real-time. The system my be configured or designed to update the market values at periodic intervals. System may be configured or designed to scraping market data from specifically identified platforms (e.g., Ebay). Backend logic may be used to determine market value for a specific asset.

In embodiments where the Buyback Offer value is dynamically determined based on current market data, the system may adopt different implementation strategies, including, for example:
Implementation 1: In this approach, the system first ascertains the Buyback Offer value for an NFT through comprehensive market data research. This market-determined buyback value is then seamlessly integrated into the existing smart contract framework via an oracle. Consequently, the system formulates a Buyback Offer to acquire the NFT at the determined value. Notably, the existing smart contract is adept at leveraging Buyback Offer data from external sources. This capability allows it to create diverse Buyback Offers for various NFTs without the need for deploying additional smart contracts. This method enhances efficiency by utilizing the existing contract structure to adapt to fluctuating market conditions and offer values.
Implementation 2: In this alternative method, the system also begins by determining the Buyback Offer value for an NFT based on meticulous market data research. However, unlike the first approach, this strategy involves dynamically configuring and deploying (e.g., in near real-time) a new, dedicated buyback smart contract for each individual NFT. Each of these newly deployed contracts is specifically tailored with the Buyback Offer value pertinent to its respective NFT. This approach ensures that each NFT is associated with a distinct smart contract, uniquely configured with its corresponding Buyback Offer value. This implementation offers a more individualized and NFT-specific approach to buyback, allowing for tailored handling of each NFT within its unique market context.
   2316: Determine Buyback Offer terms including Buyback Offer price and Buyback Offer expiration

This step involves determining the terms of the Buyback Offer, including the Buyback Offer price (calculated at 2314) and the Buyback Offer expiration date.

### Input Information/Data

The determined Buyback Offer price.
Platform policies and guidelines on offer expiration.

### Output Information/Data

A complete set of Buyback Offer terms, including Buyback Offer price and expiration date. Sub-steps/Subsidiary Processes
Setting an expiration date based on platform policies or smart contract rules. The Buyback Offer Expiration is also established, creating a time-limited window in which the tokenized Collectible NFT holder can accept the buyback offer.
Finalizing the offer terms for presentation to the tokenized Collectible NFT holder.
   2318: Present Buyback Offer to holder of identified tokenized Collectible NFT in accordance with Buyback Offer terms

This step involves presenting the finalized Buyback Offer to the owner/holder of the identified tokenized Collectible NFT. The tokenized Collectible NFT holder is notified through the platform's interface, where they can review specific details about the Buyback Offer. The holder is then given the choice to accept or decline the buyback offer within the stipulated timeframe.

### Input Information/Data

The finalized Buyback Offer terms.

### Output Information/Data

The response of the tokenized Collectible NFT holder (acceptance or rejection of the offer).

### Sub-steps/Subsidiary Processes

Communicating the offer to the tokenized Collectible NFT holder through the platform.
Recording the holder's response to the offer in the system.
   2320: Buyback Offer accepted?

At this decision step the system assesses whether the tokenized Collectible NFT holder accepts or rejects the presented Buyback Offer.

### Possible Outcomes and Next Steps

Yes (Proceed to Step 2323): If the holder accepts the offer, the process moves to execute the necessary procedures for the transfer and payment.
No (End of Process): If the holder declines, the process concludes, and the tokenized Collectible NFT remains with its current holder.

Regardless of whether or not the user elects to accept or reject the buyback offer, the system logs the details relating to the presented Buyback Offer and the user's response.

2322: Smart contract executes tokenized Collectible NFT buyback transaction.

Upon acceptance of the Buyback Offer, this step involves the execution of smart contract procedures. These procedures facilitate the transfer of the tokenized Collectible NFT from the user's wallet to a designated Drop creator wallet/address and the corresponding payment (e.g., in a cryptocurrency such as USDC) to the user's wallet.

### Input Information/Data

The user's acceptance of the Buyback Offer.
The details of the tokenized Collectible NFT and the user's wallet address.

### Output Information/Data

Transfer of the tokenized Collectible NFT from the user's wallet to designated Drop creator wallet/address. Drop creator is new owner of tokenized Collectible NFT. Tokenized Collectible NFT is not burned.
Deposit of the Buyback Offer payment into the user's wallet.

### Sub-steps/Subsidiary Processes

Initiating the tokenized Collectible NFT transfer transaction on the blockchain.
Executing the payment transaction to the user's wallet.
Confirming the completion of both transactions.
   2324: Smart contract records Buyback Offer presentation and transaction details in database

This step involves the smart contract recording the details of the Buyback Offer presentation, the user's response. and the tokenized Collectible NFT buyback transaction (if executed) in a database.

### Input Information/Data

Details of the Buyback Offer presentation.
Transaction details including tokenized Collectible NFT transfer and payment.

### Output Information/Data

A recorded entry in the database containing all pertinent details of the buyback transaction.

### Sub-steps/Subsidiary Processes

Capturing and logging the transaction details.
Ensuring the accuracy and integrity of the recorded data.
Updating the blockchain and database to reflect the completed transaction.

### Composite Trait Score Calculations

As part of the buyback offer functionality, the Colony Platform is configured or designed to automatically and dynamically analyze a selected NFT collection (dependent on size and % of collection sold), and calculate individualized Composite Trait Scores (or Trait scores) for each NFT of the collection.

In at least one embodiment, the Composite Trait Score calculated for a given NFT may be based, at least in part. on the specific traits and attributes associated with that NFT. The probability of an attribute appearing in an NFT may be calculated by dividing the number of times that attribute appears in all NFTs in the collection by the total number of NFTs.

Below is a description of one example embodiment illustrating how a buyback offer smart contract of the Colony Platform may be configured or designed to calculate Composite Trait Scores for NFTs of a collection.
Count the occurrences of each attribute across all NFTs of the collection and store them in the attribute_frequencies HashMap. The key for this HashMap may be a string in the format trait_type:value, and the value may be the number of times this attribute occurs in the NFTs.
Store the attributes for each NFT in the nft_attributes HashMap. The key for this HashMap may be the token ID, and the value may be a vector of attributes in the format trait_type:value.
Iterate through the nft_attributes HashMap and calculate a Composite Trait Score for each NFT. The Composite Trait Score or composite trait score may represent an aggregate of the Composite Trait Scores for each attribute of the NFT.
For each attribute of the NFT collection, calculate the probability of the attribute appearing in an NFT. For example:

Probability=*attribute_frequencies.get(attr).unwrap( )as f64/total_nfts;

where attribute_frequencies.get(attr).unwrap( ) provides the frequency (number of occurrences) of the attribute, and total_nfts is the total number of NFTs. Dividing the frequency by the total number of NFTs gives the probability of the attribute appearing in an NFT.
Calculate the Composite Trait Score for each NFT attribute.

For example, using the attribute probability, the system may calculate the Composite Trait Score for that attribute as the negative base-2 logarithm of the probability: -probability.log2( )

In at least one embodiment, the base-2 logarithm (log2) is used because it measures the information content of an event in bits. The negative sign is used to make rarer attributes have higher scores. The rarer an attribute is, the lower its probability, and therefore, the higher its Composite Trait Score.
Aggregate (e.g., sum up) the Composite Trait Scores of all attributes in an NFT to get the total Composite Trait Score for that NFT. Calculating the Composite Trait Score in this way helps to ensure that NFTs with rarer attributes have higher Composite Trait Scores.

In some embodiments, the composite trait score may be calculated based the NFT's rarity score. Below is a description of an alternate methodology for calculating rarity scores for NFTs of a collection.
Gathering Data:
   Collect Metadata: A first step is to gather the metadata for every NFT in the collection. This metadata typically includes all the traits and attributes of each NFT.
   Metadata Structure: Ensure that the metadata is structured consistently across the collection, typically in a JSON format, with key-value pairs representing traits and their values.
Trait Analysis:
   Identify Unique Traits: Extract and list all unique traits and their possible values from the metadata. For example, in a character-based NFT collection, traits could include ‘hair color’, ‘eye color’, ‘accessories’, etc.
   Count Frequency: For each trait, count how many times each value appears across the collection. For instance, if ‘blue eyes’ is a trait value, count how many NFTs in the collection have blue eyes.
Rarity Calculation:
   Trait Rarity Score: Calculate the rarity score for each trait value. This is often done by taking the inverse of the frequency of the trait. For example, if ‘blue eyes’ appear in 10 out of 1000 NFTs, its rarity score could be 1/10 or 0.1.
   Overall Rarity Score: Combine the rarity scores of all traits for an NFT to determine its overall rarity. This can be done in several ways:
      Summing up all the individual trait rarity scores.
      Calculating the product of all the rarity scores for a compound effect (this amplifies the rarity of having multiple rare traits).
Normalization: Normalize these scores across the collection for comparability. The normalization method depends on the desired rarity scale.
Ranking the NFTs:
   Sorting by Rarity: Once each NFT has an overall rarity score, sort all NFTs in the collection based on these scores to rank them from most rare to least rare.
   Categorization (Optional): You can categorize NFTs into rarity tiers based on their scores, like ‘common’, ‘uncommon’, ‘rare’, ‘ultra-rare’, etc.
Considerations in Rarity Calculation:
   Trait Weighting: Decide if all traits are equally important or if some traits should carry more weight in the rarity calculation.
   Handling of Special Traits: Some traits might be special or unique (e.g., a one-of-a-kind trait). These should be handled carefully in the rarity algorithm to reflect their uniqueness.

### Colony Platform Buyback Logic

Let the variables be defined as follows:
RC(g): Recalibrated % for group g
p(g): Group Percent Allocation (the buyback percent)
ub(g): Group Upper Bound
lb(g): Group Lower Bound
Tp(G): Total Percent Buyback That May Be Executed Without Recalibration For A Set Of Groups
tm: Total Minted Tokens

For a set G of groups, these rules apply:
1. lb(g)≤ub(g)
2. lb(g)≥1
3. ub(g)≤tm
4. c=1 (or 100)

For a set G of groups, the formula for the total percent buyback that may be executed without recalibration is:

Tp(G)=Σ_{g∈G}p(g)·(min (tm, ub(g))−lb(g)+1) (1)

where tm is the total minted tokens and p(g) is the group percent allocation (the buyback percent).

The formula for a group's recalibrated percent of the contract may be expressed as:

$$RC ( g ) = p ( g ) * \frac{( max ( lb ( g ) + min ( tm , ub ( g ) ) - lb ( g ) + 1 , 0 ) )}{( lb ( g ) + ub ( g ) + 1 )} * \frac{1}{Tp ( G )} \qquad ( 2 )$$

The pseudo-math simplifies to:

$$( 3 )$$

$$Group ’ s Recalibrated Percent = \frac{\begin{matrix}Percent Allocated To Group * \\ \frac{Num Minted In Group Range}{Total Numbers In Group Range}\end{matrix}}{\begin{matrix}Total Buyabck Percent That \\ Would Be Executed Without Recalibration\end{matrix}}$$

### Buyback Value Configuration Parameters

FIGS. 13-19 illustrate representations of various types of NFT collection campaign configuration parameters and associated data relating to different example embodiments of NFT collection campaigns

FIG. 13 shows an example of a buyback offer value breakdown for a collection with 1000 tokens and the values that may be associated per token. Table 1B 1320 of FIG. 13 illustrates an example embodiment of a Buyback Value Table, which may be used to assign a monetary value for a given NFT based on the NFT's Composite Trait Score. This table categorizes NFTs into different rarity or trait score bands, assigning higher buyback values to rarer NFTs. For example, as illustrated in the example Buyback Value Table 1320:
an NFT with a Composite Trait Score of 1 has a predetermined buyback value of $1000;
an NFT with a Composite Trait Score of 3 has a predetermined buyback value of $360;
an NFT with a Composite Trait Score between 7-10 has a predetermined buyback value of $70;
an NFT with a Composite Trait Score between 26-50 has a predetermined buyback value of $25;
Tokens with scores above a certain threshold (e.g., 801-1000) would not have a buyback offer.

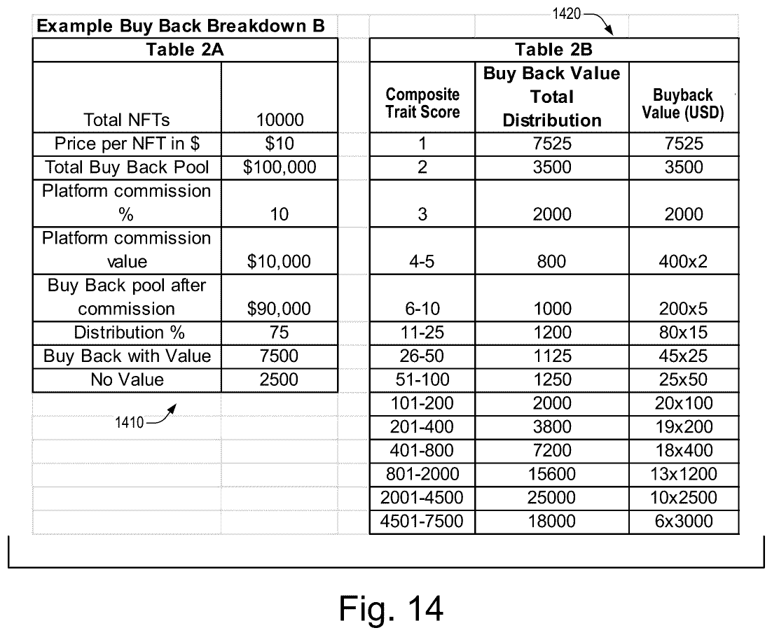

FIG. 14 shows an example of a buyback offer value breakdown for a collection with 10000 tokens and the values that may be associated per token. The initial mint cost per token may be $10 USD. Using the Buyback Value Table data of Table 1420 of FIG. 14, a smart contract may determine that an NFT having a composite trait score of 17 has a predetermined Buyback Offer value of $80.

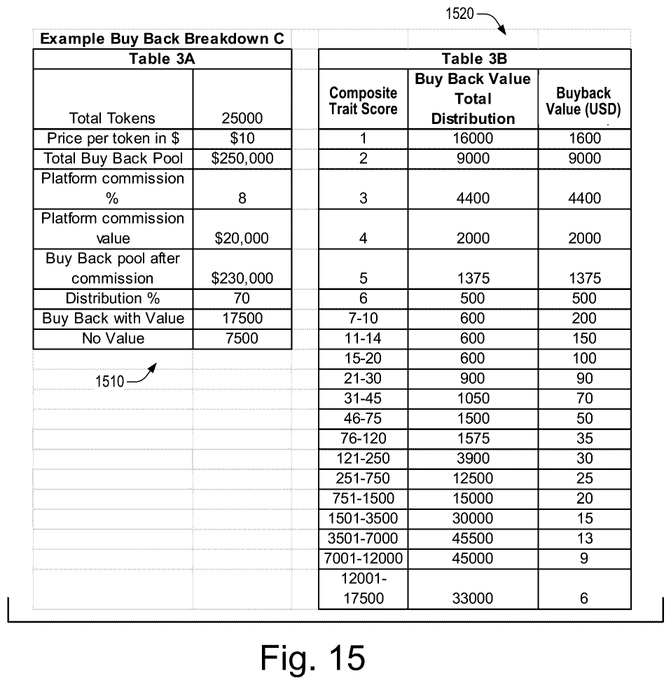

FIG. 15 shows an example of a buyback offer value breakdown for a collection with 25000 tokens and the values that may be associated per token. The initial mint cost per token may be $10 USD. Using the Buyback Value Table data of Table 1520 of FIG. 15, a smart contract may determine that an NFT having a composite trait score of 17 has a predetermined Buyback Offer value of $100; an NFT having a composite trait score of with the range of 76-120 has a predetermined Buyback Offer value of $35; NFTs having a composite trait score of greater than 17500 have a predetermined Buyback Offer value of $0.

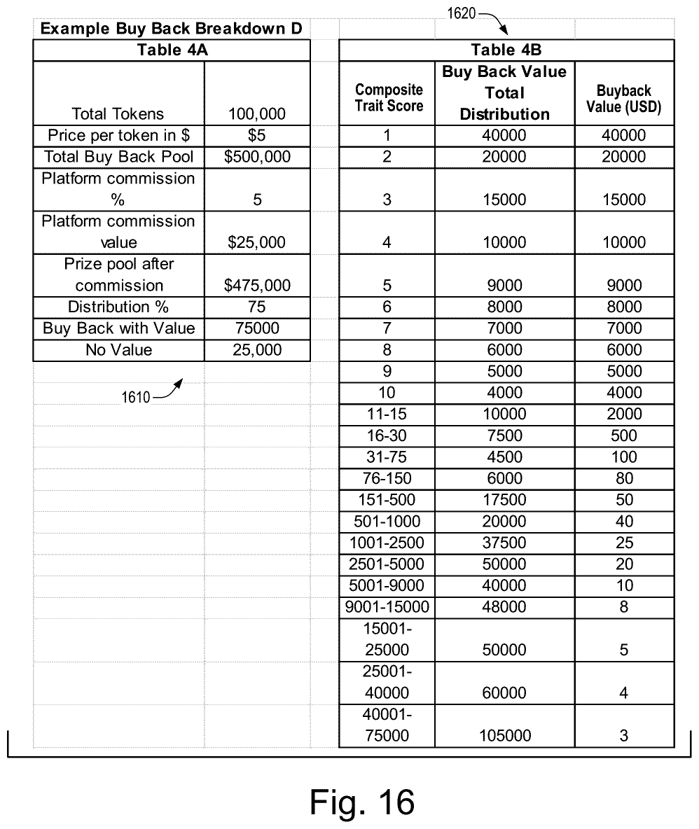

FIG. 16 shows an example of a buyback offer value breakdown for a collection with 100000 tokens and the values that may be associated per token. The initial mint cost per token may be $5 USD. Using the Buyback Value Table data of Table 1620 of FIG. 16, a smart contract may determine that an NFT having a composite trait score of 17 has a predetermined Buyback Offer value of $500; an NFT having a composite trait score of with the range of 151-500 has a predetermined Buyback Offer value of $50; NFTs having a composite trait score of greater than 7500 have a predetermined Buyback Offer value of $0.

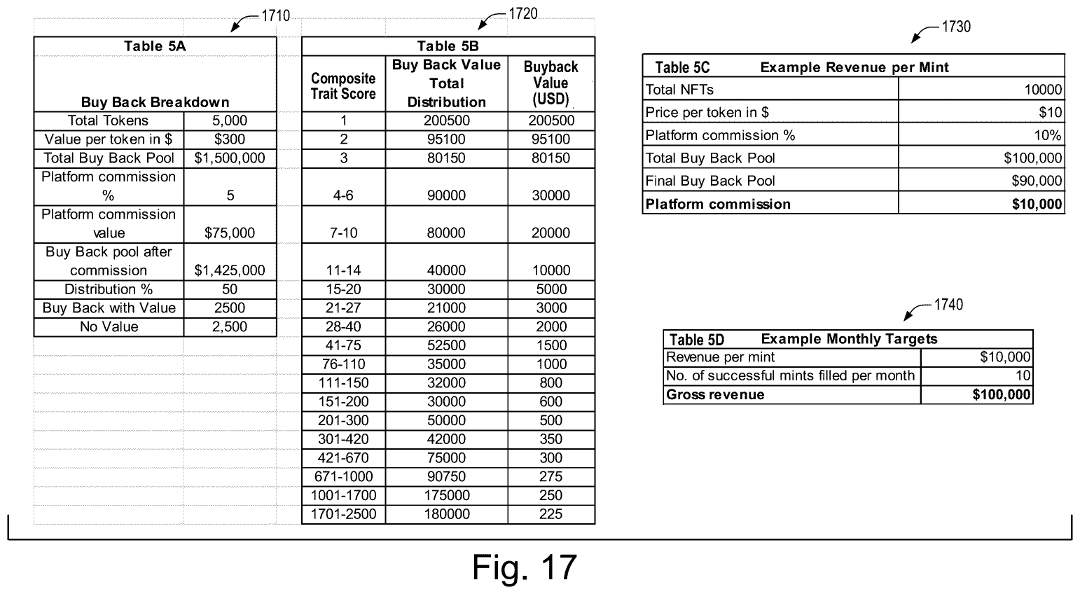

Tables 1710 of FIG. 17 shows an example of a buyback offer value breakdown for a collection with 5000 tokens, which is based on the buyback offer value data of Buyback Value Table 5B 1720. The initial mint cost per token may be $300 USD. Using the Buyback Value Table data of Table 1720 of FIG. 17, a smart contract may determine that an NFT having a composite trait score of 2 has a predetermined Buyback Offer value of $95,100; an NFT having a composite trait score of with the range of 76-110 has a predetermined Buyback Offer value of $1000; NFTs having a composite trait score of greater than 2500 have a predetermined Buyback Offer value of $0.

Table 1730 of FIG. 17 shows an example of a NFT campaign revenue structure tool which may be provided by the Colony Platform to enable NFT campaign creators and administrators to view predicted revenue projections and NFT campaign configuration parameters for a given NFT collection campaign. Table 1740 of FIG. 17 shows and example of a monthly gross revenue projection for the NFT collection.

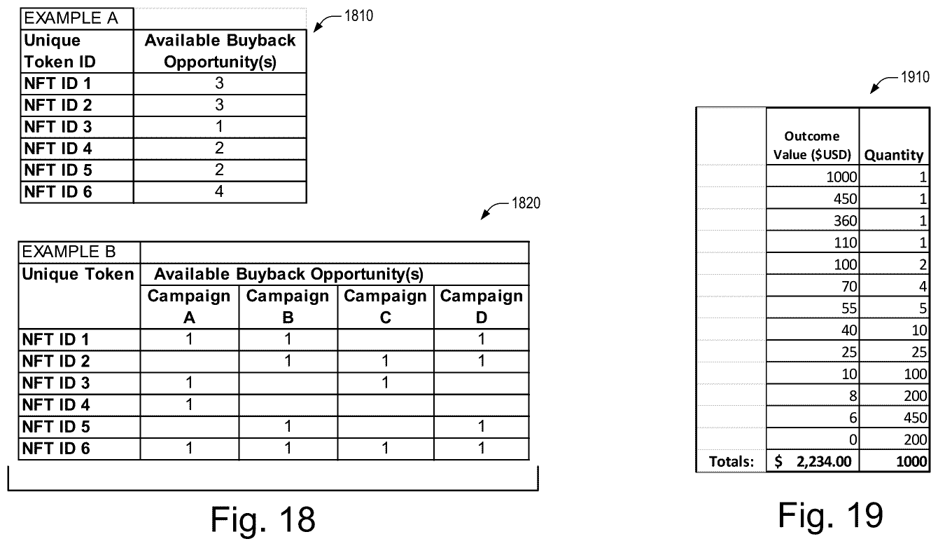

Table 1810 of FIG. 18 shows an example of NFT campaign configuration parameters relating to buyback offer opportunities for a given NFT. According to different embodiments, buyback offer opportunities for a given NFT may be accumulated and/or carried over for use in future promotional campaigns. In at least one embodiment, multiple Buyback Offer Opportunities for a given NFT may be permitted to be used in a given promotional campaign. In at least one embodiment, multiple Buyback Offer Opportunities for a given NFT may have pre-determined offer opportunities, which may or may not be able to be collected for future use. The buyback opportunities may be determined by the collection holder and may or may not be predetermined at the time of the mint. User may also not receive any buyback opportunities.

Table 1820 of FIG. 18 shows an example of NFT campaign configuration parameters relating to buyback offer opportunities for a given NFT. In at least one embodiment, buyback offer opportunities for a given NFT may be revealed (accepted or declined), accumulated and/or carried over for use in future promotional campaigns. In at least one embodiment, multiple buyback offer opportunities for a given NFT may have pre-determined offer opportunities, determined either at the initial mint or once the buyback reveal is initiated. Offers may have known or unknown values. Users may decline an offer hoping their next offer may have higher value. The value of incremental buyback offers may or may not be known. User may also not receive any buyback opportunities.

### Buyback Offer Outcome Pools

In another embodiment a pool of outcomes may be used. One example of this utilization may be as follows; a collection size of 1000 tokens, may have a pool of 1000 unique outcomes. These outcomes may be randomly assigned to each token. Once a token holder accepts the Buyback offer value, the corresponding outcome may be removed from the pool. It is also important to note that a holder may be given the opportunity to reject an outcome (also referred to as a Buyback offer value) and be given a new offer. In this embodiment, the holder may reject their first outcome, which may go back into the pool of outcomes and be offered another.

Pool of buyback offers: Outcomes may be predetermined and held in a pool of values within the server system. In this embodiment, outcomes are not randomized but predetermined based on the token's score. When a holder chooses to accept their Buyback offer, that outcome and funds associated may be removed from the total pool.

By way of illustration, company X may use a random number generator and oracle to create a pool of buyback outcomes that vary in value. In this embodiment, when the holder of a token reconnects to the smart contract, the token value has not yet been determined. The holder may choose to burn/discard their token before knowing the associated value. The value may then be determined at random, being chosen from a pool of pre-determined OR randomly generated outcomes. In this example, there is additional risk for the holder. They may receive 0 ETH or they may receive a greater amount than the established token value on the secondary market.

FIG. 19 shows an example Buyback Offer Outcome Pool embodiment representing domain of all possible buyback offers for a given promotional campaign.

### Example Use Case Illustrations

The buyback offer functionality of the Colony platform can be leveraged for marketing and promotional campaigns relating to NFT collections. This approach not only enhances the appeal of NFTs to potential buyers but also provides a unique angle for promotional strategies. Illustrative examples of use cases involving marketing and promotional campaigns:
Limited: Time Buyback Offers for New Launches: For new NFT collections, a limited: time enhanced buyback offer can be promoted. For example, within the first week of launch, the buyback offer might be set higher than the usual rate, encouraging early purchases and generating buzz around the launch.
Promotional Buyback Tiers Based on Engagement: The platform can introduce promotional tiers where the buyback offer value increases with specific user actions. For instance, sharing the NFT on social media or participating in community events can temporarily boost the buyback value of the NFT.
Seasonal or Event: Based Buyback Promotions: Aligning buyback offers with seasonal events or celebrations (like Christmas, Halloween, etc.) can create themed marketing campaigns. During these events, certain themed NFTs could have a higher buyback value.
Collaborations with Influencers or Brands: Collaborating with influencers or brands where exclusive NFTs are released with a special buyback offer can create a buzz. Influencers can promote these NFTs, highlighting the unique buyback offer as a key selling point.
Rewarding Loyalty with Improved Buyback Offers: Regular collectors or buyers can be rewarded with personalized buyback offers, enhancing loyalty and encouraging more engagement with the platform's collections.

### Example Illustration:

### Campaign Name: “Galactic Explorers NFT Collection”

Objective: To launch and Promote a New NFT Collection Themed Around Space Exploration.
Pre-Launch Teasers: Tease the collection on social media, highlighting the unique art and mentioning the security of investment provided by the buyback functionality.
Launch Event with Enhanced Buyback Offer: During the first week of the launch, offer an enhanced buyback rate, say 10% above the standard rate. Promote this limited-time offer vigorously across all platforms.
Engagement-Based Buyback Boosts: Announce that for every social media share, the buyback value of the NFT increases by a small percentage for a limited time. This encourages buyers to promote their purchase, creating organic marketing.
Seasonal Campaign—‘Stellar Halloween’: For Halloween, release a limited series of ‘spooky space’ themed NFTs. For these NFTs, offer a special Halloween buyback rate, higher than usual, valid till the end of October.
Influencer Collaboration: Partner with a popular science communicator or astronaut to release a special edition NFT. This NFT comes with a unique buyback guarantee and is promoted by the influencer.
Loyalty Rewards: For collectors who have previously purchased from the platform, offer an exclusive preview and a higher buyback rate for the first 24 hours of the launch.
Through these strategies, the Colony platform can effectively use its buyback offer functionality not just as a security feature but as a dynamic tool in marketing and promotional campaigns, adding a unique edge to NFT collections and enhancing their appeal in the market

### Example Walkthrough Embodiments of Colony NFT Mint Campaigns

Buyer connects crypto funded wallet to server system.

Buyer initiates smart contract and buys single (or multiple) digital ticket token(s)
Tokens may be ERC-721 or ERC-1155
Tokens have the ability to embody characteristics or traits that may be assigned values by smart contract(s). Each NFT may have a respective set of traits associated therewith.
   In one embodiment, based on these traits, each token may have a respective score or ranking which may be used to determine buyback offer value.
   In another embodiment buyback offer value may be automatically and/or dynamically determined using a random number generator (“RNG”) mechanism, which may be implemented by the smart contract or by a remote RNG system (e.g., blockchain oracle).
   In another embodiment, some or all tokens may have the same buyback offer value in perpetuity

According to different embodiments, one or more smart contract(s) disclosed herein may be deployed on various layer 1 or 2 blockchains including but not limited to:
Ethereum
Solana
Tezos
Flow
BNB
Polygon
Cardano
Immutable X
LRC
Etc.

In at least some embodiments, smart contracts may be upgradable or linked to a series of smart contracts which replace initial smart contract or may be based off a generic smart contract which engages with the server front-end for some or all logic.
In one embodiment, the token may be associated with a unique campaign with a finite period of time associated
In another embodiment, smart contract may be upgradeable and have an open cycle, with no clear date of completion for the buyback period
In another embodiment, each token has been assigned traits by the smart contract which are known and have assigned value, but not yet revealed at the time of mint.
In another embodiment, the smart contract has not assigned value and may do so upon reveal.
In another embodiment, the value in the smart contract for buyback has been assigned and is the same for each token. In this version the token holder may implement buyback offer value and the token back to the smart contract to be discarded/burned at any point. This pricing may be fixed or may change.
Buyer may choose to hold token in wallet and not immediately initiate reveal
Prior to reveal, user may choose to sell ticket token on secondary marketplace including but not limited to:
   Customized marketplaces
   OpenSea
   X2y2
   Blur.io
   Looksrare
   Etc.

### Selling of Unrevealed Token

In one embodiment the token owner connects to an NFT marketplace at which time they may get a prompt to “sell” at the price of their choice on the open (e.g., secondary) market.
In another embodiment, the owner may choose to sell their unrevealed ticket on a secondary NFT marketplace.

### Revealing of Token Traits

In one embodiment the owner connects crypto wallet which holds token to server system and initiates smart contract reveal procedure
In another embodiment, at the end of a promotional campaign cycle some or all tokens may be automatically revealed via smart contract. In at least one embodiment, initiation and/or execution of the reveal procedure(s) may be based on one or more predefined events and/or conditions.
Token Metadata properties may show token traits
   In one embodiment this may be a rarity ranking based on randomly assigned value via smart contract
   In another embodiment this may be a ranking based on specific traits
   In another embodiment, this maybe be traits and attributes based on images or art

### Reveal/Buyback Offer Smart Contract Mechanisms and Methodologies

In at least one embodiment, the system may be configured or designed to include functionality for enabling users (e.g., NFT owners) to connect to the server system and initiate a request to receive at least one buyback offer (comprising a buyback offer value) for an identified NFT in the user's wallet.
The may choose to exercise this option and have their token bought back for a predetermined value, based on rarity or traits
The “buyback offer value” may be monetary or another form of predetermined value or asset, such as an NFT
The “buyback offer value” may also be zero
In another embodiment of “buyback offer value” a smart contract may have a single value offer to any NFT from a specific collection
In another embodiment, the “buyback offer value” may be an exchange for a physical good
In another embodiment the “buyback offer value” may be an upgradeable token for future use
The token holder is not required to exercise their buyback option

In one embodiment the secondary value of the token may change, as buyback offer values and rankings are revealed

In one embodiment the server system may display campaign statistics that may include, but may not be limited to:
Number of NFTs bought
Number of token's revealed
Buyback offer values based on characterizations or traits
Buyback offer values based off predetermined rank
and/or other desired information relating to the promotional campaign
Buyback offer values withheld
   In another embodiment, when a holder decides to reveal token attributes, traits, rank or characterization, the predetermined value and buyback option may not be announced, until after the campaign cycle for reveal has ended. In at least one embodiment, this cycle may have a finite length—e.g., 1 week, 1 day, 3 days, 1 month, etc.
Holder may choose to connect to server system at any point through the campaign designated cycle length to initiate the reveal at any point during that cycle period.
When holder chooses in initiate reveal, they connect wallet that holds the digital token they bought from the server system OR a secondary marketplace
At any point during the campaign cycle, the owner may offer the unrevealed token for sale at any price they choose.
At any point during the campaign cycle, the owner may offer the revealed token with rarity for sale at any price they choose.
At the end of the campaign cycle some or all rarities may be revealed.
In one embodiment, after a designed timeframe post Reveal, the smart contract may allow holders to connect their crypto wallet that holds their token and initiate one or more request(s) to receive buyback offer(s) for one or more qualifying tokens in the user's wallet.

### Example Buyback Offer Methodologies & Mechanisms

In at least one embodiment, the NFT Buyback System may include a NFT Reveal/Buyback Offer Smart Contract which may be configured or designed to include functionality for enabling users (e.g., NFT owners) to connect their crypto wallet that holds their token and initiate one or more request(s) to receive buyback offer(s) for one or more qualifying tokens in the user's wallet.

### Buyback Contract V1

After reaching a server system, a crypto funded wallet is connected to the smart contract on the blockchain and may mint a token from the smart contract. There may be a reveal of traits, properties, and/or other attributes that may have a direct buyback offer value associated with them.

In one embodiment the holder may instantly reveal their token once it is minted while on the server system connected to the smart contract. They may be able to see the buyback offer value listed on the server system and may be able to make the choice if they may hold the token or send it back to the smart contract for the listed value. There may be a set and defined window of time that this buyback option may be available. If the period of time is a week, when 7 days commence, if the buyback option was not exercised it may be lost.

In another embodiment after the initial buyback period has commenced there may be a future period to exercise where values may or may not change. In this example, the holder may connect to the smart contract and see a new buyback offer value with the option to exercise.

### Buyback Contract V2

After reaching a server system, a crypto funded wallet is connected to the smart contract and minted a token from the smart contract. The token may be sent to the wallet, unrevealed and the holder may not know the traits and attributes associated until a later date. In this embodiment, some or all tokens may be revealed simultaneously by the smart contract by updating the metadata. The buyback offer values may be posted on the server system and holders may elect to exercise the buyback option in the smart contract during a given period of time.

### Buyback Contract V3

After reaching the server system, a crypto funded wallet is connected to the smart contract and mints a token. In this embodiment, the token is unrevealed and sent to the wallet. After a designated period of time, the smart contract refreshes the metadata and traits are revealed. The buyback offer values, are not only crypto value, but may be offered to trade for a new token. In this example, the holder may be able to decide if they may like to trade their current token for another token offered by the smart contract.

In another embodiment the reveal may be instant upon minting.

### Buyback Contract V4 With Unknown Value

After reaching a server system, a crypto funded wallet is connected to the smart contract on the blockchain and may mint a token from the smart contract.

In one embodiment the holder may instantly reveal their token once it is minted while on the server system connected to the smart contract. They may not be able to see the buyback offer value listed on the server system and may be able to make the choice if they may hold the token or send it back to the smart contract for the listed value. There may be a set and defined window of time that this buyback option may be available. If the period of time is a week, when 7 days commence, if the buyback option was not exercised it may be lost.

In another embodiment, holders may hold onto the buyback token that has an unknown or 0 value. Holders may be presented with a promotional opportunity once they have X number of these types of tokens. Buyback opportunities may be presented based on a number of variables: number of unknown or 0 value tokens, and the holder may have an opportunity to accept the buyback offer without knowing the value.

### Alternate Embodiments of Reveal and Buyback Offer Mechanisms

Partial Reveal: In one embodiment there may be a partial reveal of token traits. In this example, a holder may hold a token and know some of the traits associated with it, but not some or all. A token may have physical features that are known, but have a numerical component that is not yet known. This may drive speculation on value both current and future.

### Buyback in an Established Collection

The utility of a market maker buyback contract has the potential to be utilized in functionality for a collection of non-fungible tokens that has already been minted. In this example, the buyback contract may be enabled and holders may be able to send their token back for a pre-established value, set by the smart contract. In another embodiment, the value of the buyback may be randomized based on when the token holder reconnects.

As an example, Company X had a mint where tokens were minted for 0.1 ETH. A month later the value of the least desirable tokens based on traits has been established on the secondary market trading at 0.08, the most desirable are trading around 0.5 ETH. Company X believes the value of some or all tokens may increase to at least 0.2 over the coming weeks. The buyback smart contract may be configured to offer holders a flat buyback offer value to send the tokens back to the original smart contract or new contract or burned/discarded and receive 0.2 ETH in return. Utilizing the functionality of the Buyback Market maker smart contract, they may be able to set a new floor price of 0.2 ETH. The collection becomes deflationary and may have an increase in value to any tokens left on the market as it decreases in size.

Company X may also choose to increase the Buyback offer value at any point, the functionality of this may leave holders questioning their buyback strategy.

### Buyback Offer Value with RNG and Oracle Use: Pool of Outcomes

In another embodiment, company X may use a random number generator and oracle to create a pool of buyback outcomes that vary in value. In this embodiment, when the holder of a token reconnects to the smart contract, they may agree to send the token back to the smart contract and or generate a new smart contract burning initiation token, without knowing the offered buyback offer value. In this example, there is additional risk for the holder. They may receive 0 ETH or they may receive a greater amount than the established token value on the secondary market.

### Buyback offer value with RNG: Promotion Use and Extended Play

In another embodiment, once a collection is minted, the collection creator or company X may run a promotion or campaign based on a number of variables tied directly to the minted tokens. For instance, buyers may need X number of tokens from X collection to receive a “super token” which may then enter them into a promotion in which the prizes may vary from currency, NFT, or additional buyback offers.

In another embodiment, once a collection is minted, the collection creator or company X may run a promotion or campaign based on a number of variables tied directly to the minted tokens. For instance, users may need X number of tokens from X collection to receive a “super token” which may then trigger a buyback offer for some or all X tokens. The buyback offer value may be determined by an RNG facilitated from the Oracle from a set of predetermined outcomes and may vary in value. The user may hold onto these tokens past the promotional time period for the possibility of future promotional or campaign opportunities, i.e. jackpot drawings, collection promotions. If users are required to have 6 specific tokens to be granted a super token (for a promotion OR granted additional value): the buyback offer may be a token that is required to complete their collection OR users may opt to take the buyback offer, even when value may be unknown, to exit the current promotion.

Buyback methodology may be stored in a smart contract or a generic smart contract which engages with the DaP (server front-end) for some or all logic and outcomes. According to different embodiments:
There may be 1 to (infinite number) of reveals tied to a unique token within a minted collection and/or promotion.
Reveals may occur for several different reasons and may have different outcomes based on varied events.
The number of reveals may be pre-determined at the origination of a collection and or enabled during the life of a collection and outside of any set promotion parameters.

According to different embodiments:
A generic minting/reveal contract may be deployed which is reused in multiple collection/use cases.
A generic buyback contract may be deployed which is reused in multiple collection/use cases.
A generic minting/reveal/buyback contract may be deployed (One contract that does it all)
With the use of a generic smart contract, logic to trigger events may be called from the server front-end.
Initial smart contract may be configured to reveal the sequence of pre-determined reveals set at time of original token mint.
In a series of smart contracts which are linked, once new contract is initiated, the original smart contract is dissolved and token burned
Stored in data repository on the server promotion front-end, either pre-determined or once reveal mechanism is engaged a randomly generated value via embedded RNG (e.g., via blockchain oracle) is distributed based on prize/reveal structure

### Features and Future Utility of Held Tokens

In one embodiment, a minted token's buyback offer value may change in a future promotion cycle. After the initial buyback period has passed, if the token is still held and buyback has not been executed there may be an opportunity for a future buyback cycle with different values, based on different parameters (certain traits, entire collection, last 20 minted, randomly generated, etc.). This may also require a combination of multiple tokens or single token value.

### Tokenized Collectible NFT Drops

### Live Streaming of the Opening Physical Collectible Trading Card Packs

The process of live-streaming the opening of physical collectible trading card packs has become a notable trend on platforms like Twitch. The process typically involves:
Announcement and Sales-Influencers announce a card opening event on their platforms and may sell slots to their audience. Each slot represents a pack or a number of packs.
Live Streaming-The live stream is conducted on platforms like Twitch, where influencers open the packs on camera. The aim is to unveil rare or highly valued cards, adding a layer of excitement and engagement to the stream.
Card Ownership-Each pack opened is associated with a purchaser whose cards are theirs regardless of the value. The ownership is established before the live stream through the sale of slots.
Distribution-After the event, the cards are packaged and shipped to the respective purchasers. The logistics and accuracy of distribution are managed by tagging each pack with the purchaser's details or order number before opening.

The process of opening physical collectible trading card packs via live streaming platforms is not without its challenges, however. Various problems associated with current process include:
Ownership Issues:
   Ambiguity: There can be ambiguity regarding ownership, especially if there are discrepancies between the number of packs bought and the number of packs opened.
   Disputes: Disputes can arise if a valuable card is pulled and there are claims of ownership other than the designated purchaser.
   Documentation: There may not always be clear documentation of who owns which cards, especially in a chaotic or disorganized live stream setup.
Physical Distribution Problems:
   Shipping Delays: There may be significant delays in shipping the cards to the purchasers, which can be frustrating.
   Misdelivery: Cards may be delivered to the wrong purchaser, especially if there are many participants.
   Damage: Cards can get damaged during packaging or transit, diminishing their value.
Secondary Marketplace Challenges:
   Value Fluctuation: The value of cards can fluctuate rapidly in secondary markets, which can be a risk for both buyers and sellers.
   Transaction Fees: High transaction fees on secondary market platforms can eat into the profits of sellers.
   Scams: There is a risk of scams, with buyers potentially receiving counterfeit cards or not receiving their purchased cards at all.
Counterfeit and Verification Problems:
   Counterfeit Cards: The market is flooded with counterfeit cards, and distinguishing genuine from fake cards can be challenging, especially for inexperienced buyers.
   Verification: There are inadequate mechanisms for verifying the authenticity of cards, both during the live stream and on secondary market platforms. The onus often falls on the buyer to verify authenticity, which can be a daunting task.
   Misrepresentation: Sellers, including influencers, might unintentionally or intentionally misrepresent the authenticity or condition of cards, misleading buyers.

These problems present a complex set of challenges that require multi-faceted solutions to ensure a fair, transparent, and enjoyable experience for all participants in the live streaming card opening community.

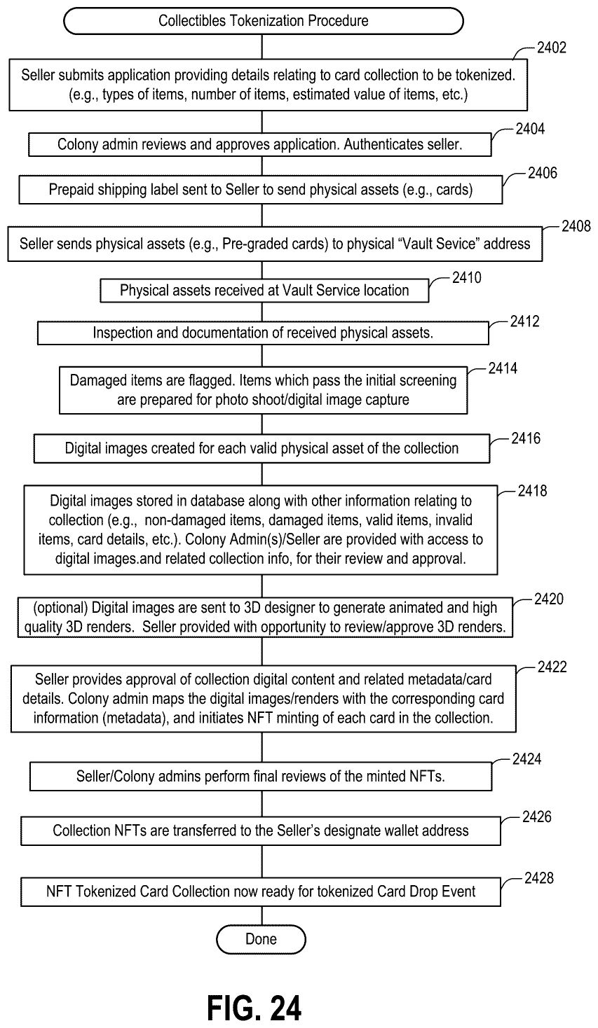

FIG. 24 shows an example embodiment of a Collectibles Tokenization Procedure. This procedure showcases various functionalities and procedural flows of the Colony Platform relating to tokenization of physical collectibles into NFTs. Below is a description of the processes and procedural flows illustrated in the figure.

2402: Seller Submits Application Providing Details Relating to Card Collection to be Tokenized. The initial step in the Collectibles Tokenization Procedure involves the seller submitting an online application to the Colony Platform for permission to launch a tokenized collectible Drop via the Colony Platform.

2404: Colony Admin Reviews and Approves Application. Authenticates Seller. Following the submission of the application, the Colony admin undertakes a meticulous review and approval process.

2406: Prepaid Shipping Label Sent to Seller to Send Physical Assets (e.g., Cards). A prepaid shipping label is sent to the seller, facilitating the sending of the physical collectible cards to the Colony Platform's designated location, commonly referred to as the “Vault Service.” This step marks the transition of the collectibles from the seller's possession to the Colony Platform. The prepaid shipping label simplifies the logistics for the seller and ensures the secure and efficient transportation of the collectibles.

2408: Seller Sends Physical Assets (e.g., Pre-graded Collectible Cards) to Physical “Vault Service” Address. In this step, the seller dispatches the physical collectibles, such as pre-graded collectible trading cards, to the Vault Service's address, using the prepaid shipping label.

2410: Physical Assets Received at Vault Service Location.

2412: Inspection and Documentation of Received Physical Assets. This step involves a meticulous inspection and documentation of the received physical assets. Each collectible item is thoroughly examined to assess its condition and authenticity. This process not only ensures the quality and integrity of the collectibles but also provides a detailed record of their state upon arrival at the Vault Service.

2414: Damaged Items Are Flagged. Items Which Pass the Initial Screening Are Prepared for Photo Shoot/Digital Image Capture. Following the inspection, items that are found to be damaged are flagged, and those that pass the initial screening are prepared for a professional photo shoot and digital image capture.

2416: Digital Images Created for Each Valid Physical Asset of the Collection. Digital images are created for each valid physical asset in the collection. These images are the result of the professional photo shoot and are processed to ensure high resolution and clarity. The digital images serve as the direct visual representation of the physical collectibles in the digital realm.

2418: Digital Images Stored in Database Along with Other Information Relating to Collection (e.g., Non-Damaged Items, Damaged Items, Valid Items, Invalid Items, Card Details, etc.). Colony Admin(s)/Seller Are Provided with Access to Digital Images and Related Collection Info for Their Review and Approval. This step involves storing the digital images along with comprehensive information about the collection in a secure database. The database includes details of non-damaged and damaged items, valid and invalid items, and specific card details. Both the Colony admins and the seller are provided with access to this database for review and approval.

2420: (Optional) Digital Images Are Sent to 3D Designer to Generate Animated and High-Quality 3D Renders. Seller Provided with Opportunity to Review/Approve 3D Renders. Optionally, the digital images may be sent to a 3D designer to create animated and high-quality 3D renders. The seller is involved in this process and is given the opportunity to review and approve the 3D renders.

2422: Seller Provides Approval of Collection Digital Content and Related Metadata/Card Details. Colony Admin Maps the Digital Images/Renders with the Corresponding Card Information (Metadata) and Initiates NFT Minting of Each Card in the Collection. After the creation of digital images or renders, the seller approves the digital content and related metadata or card details. Following this approval, the Colony admin maps these digital representations with the corresponding card information, forming a comprehensive metadata profile for each item. The admin then initiates the minting process, transforming these digital representations into NFTs. This step marks the actual creation of the NFTs, where each card in the collection is digitized and minted as a unique digital asset on the blockchain.

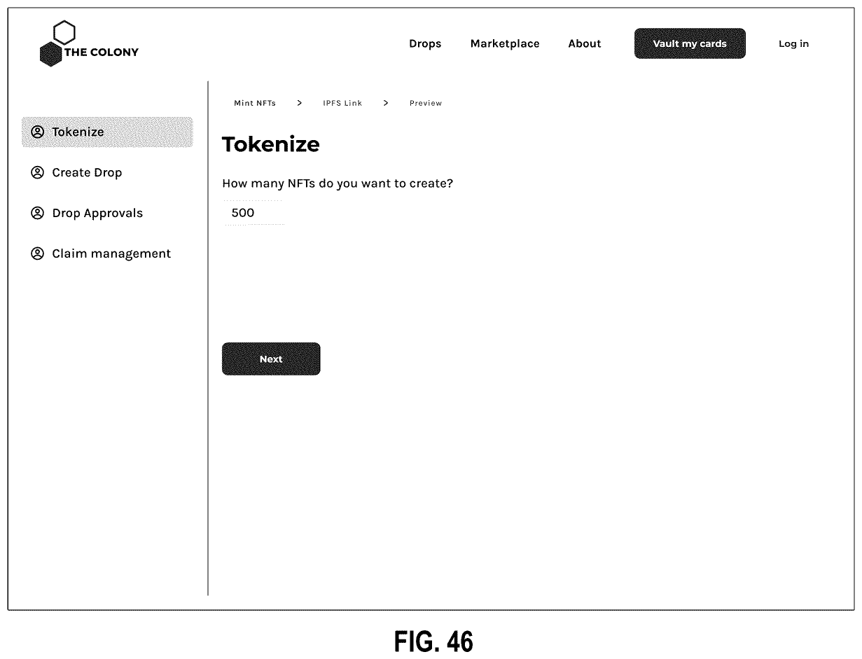

The Colony Platform enhances the process of creating tokenized collectible Card NFTs with a suite of intuitive administrative graphical user interfaces (GUIs). These interfaces streamline the various tasks involved in the process of configuring a tokenized Collectibles Drop event. For example, the Colony Platform provides various administrative graphical user interfaces (GUIs) for facilitating the process of mapping the digital card representations with the corresponding card information, and for minting and reviewing the tokenized collectible Card NFTs. Example screenshots of such GUIs are illustrated in FIGS. 46, 47 and 48.

2424: Seller/Colony Admins Perform Final Reviews of the Minted NFTs. The final review of the minted NFTs is performed by both the seller and the Colony admins. This step provides a quality control measure to ensure that the NFTs accurately reflect the physical collectibles and that their metadata is correct. Any discrepancies or issues identified are addressed at this stage.

2426: Collection NFTs Are Transferred to the Seller's Designate Wallet Address. Upon satisfactory completion of the final review process, the collection of tokenized collectible NFTs is transferred to the seller's designated wallet address. This transfer represents the final step in the tokenization process, officially placing the ownership of the NFTs in the seller's hands. The wallet address serves as a secure digital repository for the NFTs, providing the seller with control and management over their digital assets.

2428: NFT Tokenized Card Collection Now Ready for tokenized Card Drop Event. With the NFTs securely stored in the seller's wallet, the tokenized card collection is now ready for a tokenized Card Drop Event. This event represents the public release of the NFTs, where they are made available for purchase or trading on the NFT marketplace.

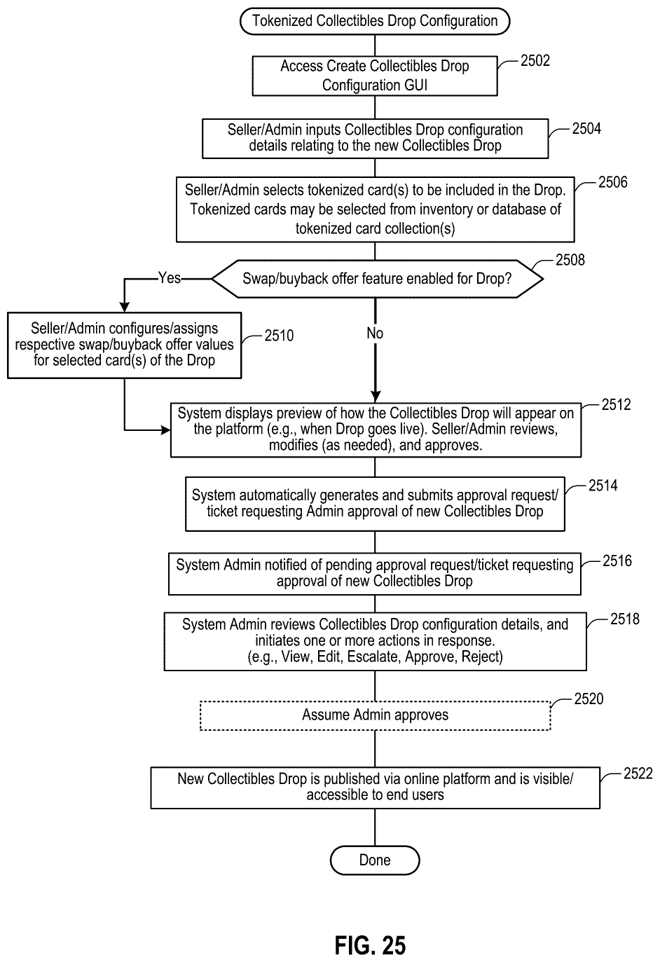

FIG. 25 shows an example embodiment of a Tokenized Collectibles Drop configuration process. This process showcases various functionalities and procedural flows of the Colony Platform relating to configuration of a tokenized Collectibles Drop event. Below is a description of the processes and procedural flows illustrated in the figure.

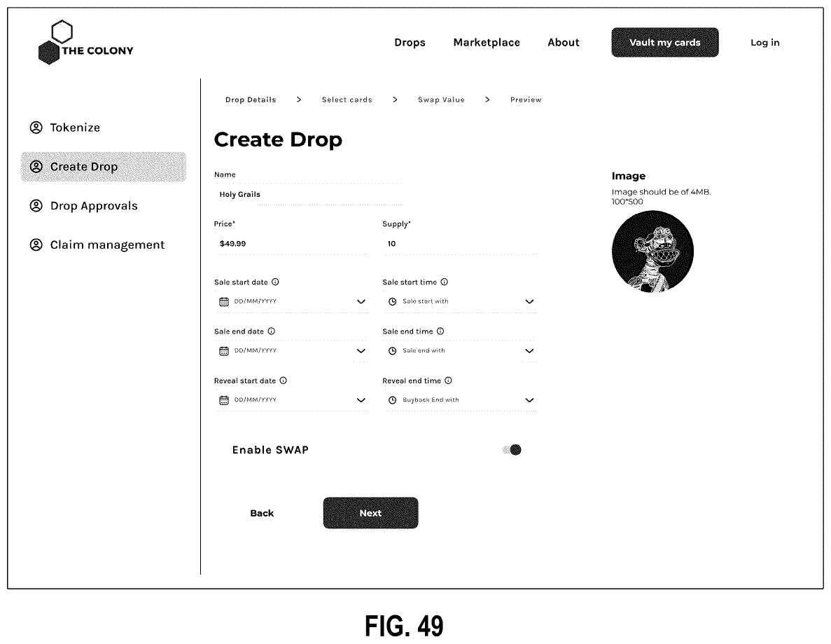

2502: Access Create Collectibles Drop Configuration GUI. The seller or admin initiates the Collectibles Drop process by accessing the Collectibles Drop Configuration GUI (e.g., FIG. 49). The GUI provides an interactive and user-friendly environment where sellers or admins may input and manage the various configuration parameters relating to the tokenized Collectibles Drop event. This interface typically includes options for inputting details like the name of the drop, descriptions, quantity of items, Buyback Offer values, and other relevant data.

2504: Seller/Admin Inputs Collectibles Drop Configuration Details Relating to the New Collectibles Drop. In this step, the seller or admin inputs detailed information about the new Collectibles Drop into the Colony Platform. This involves specifying various aspects of the drop, such as its name, description, the total number of items or tokens included, and pricing information.

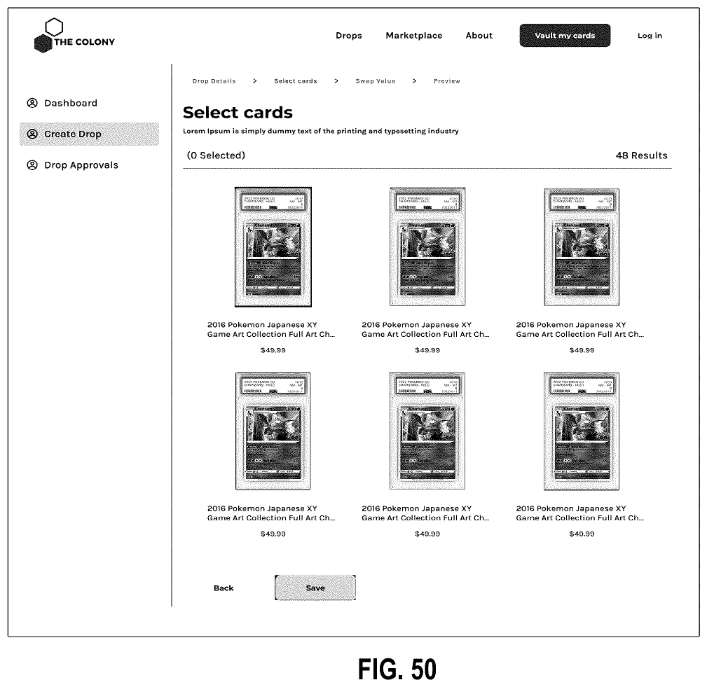

2506: Seller/Admin Selects Tokenized Card(s) to be Included in the Drop. The seller or admin accesses the Collectibles Selection GUI (e.g., FIG. 50) of the Colony Platform to select the specific tokenized cards to include in the Collectibles Drop. This selection is made from an inventory or database of available tokenized card collections. The choice of cards is a strategic decision that may significantly impact the drop's success.

2508: Swap/Buyback Offer Feature Enabled for Drop? In at least one embodiment, the Colony Platform provides functionality for enabling the Drop creator or admin to enable or disable swap/buyback offer functionality for the tokenized Collectibles Drop event. If enabled, this feature allows the system to automatically generate and present buyback offers to owners of the tokenized collectible card NFTs to purchase their NFTs, and to execute NFT buyback transactions, in accordance with the rules and parameters defined in the smart contract. This feature adds an element of flexibility and security for buyers, making the drop more attractive by providing instant liquidity.

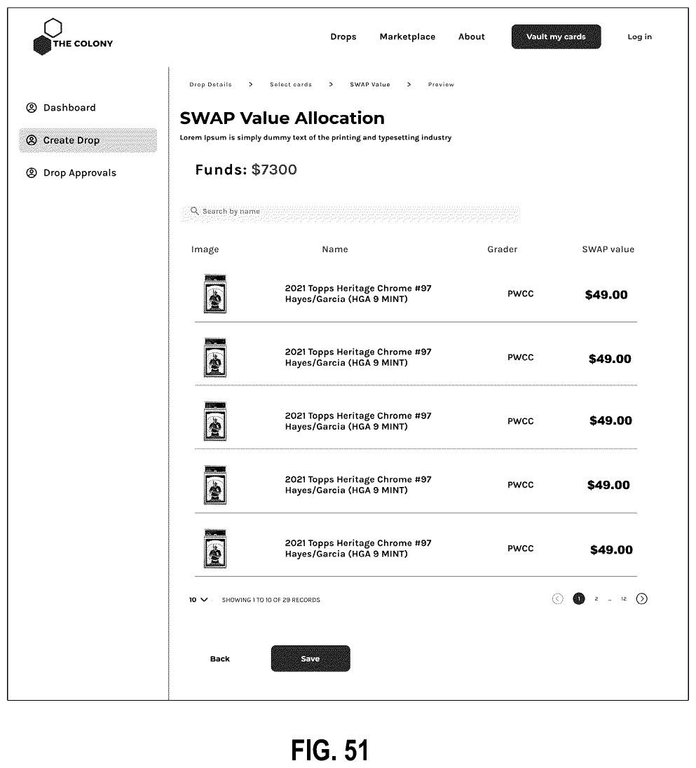

2510: Seller/Admin Configures/Assigns Respective Swap/Buyback Offer Values for Selected Card(s) of the Drop. In this step, if the swap/buyback offer feature is enabled, the seller or admin may access a SWAP Value Allocation GUI (e.g., FIG. 51) to configure/assign specific buyback offer values for each (or selected) tokenized collectible card NFTs in the collection.

In at least one alternate embodiment, the SWAP Value Allocation GUI may offer the option of selecting an automated/dynamic buyback offer pricing mechanism for one or more selected tokenized card NFTs in the collection, in which the system automatically and dynamically determines the buyback offer price based on current market data. This feature is described in more detail with respect to FIG. 23 of the drawings.

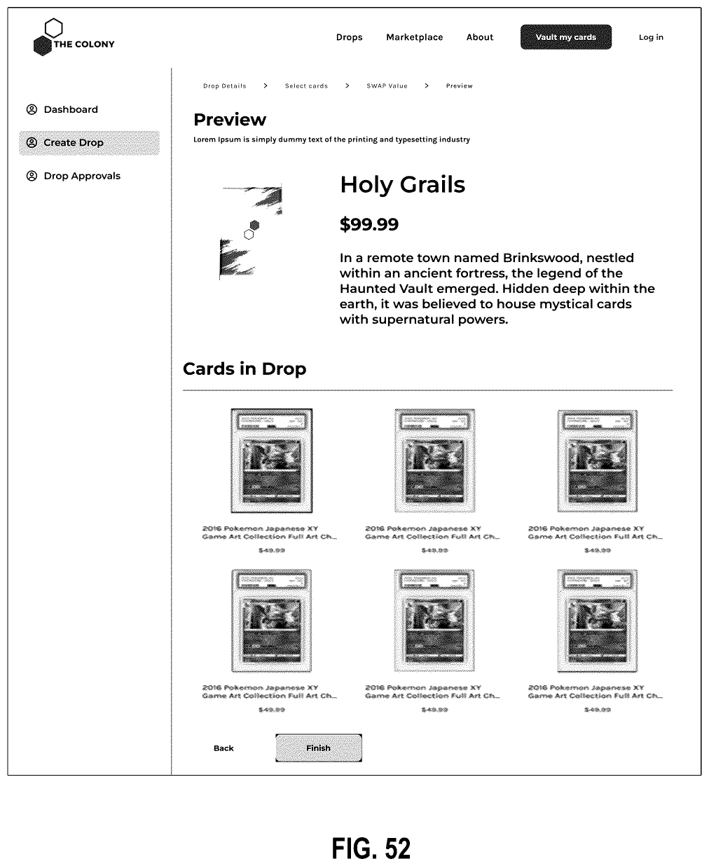

2512: System Displays Preview of How the Collectibles Drop Will Appear on the Platform. After configuring the details, the system generates a preview of how the Collectibles Drop will appear on the platform. An example of this is illustrated in FIG. 52. This preview is a helpful step as it allows the seller or admin to visualize and review the drop before it goes live. Any necessary modifications may be made at this stage to ensure that the drop is presented as intended and is appealing to potential participants.

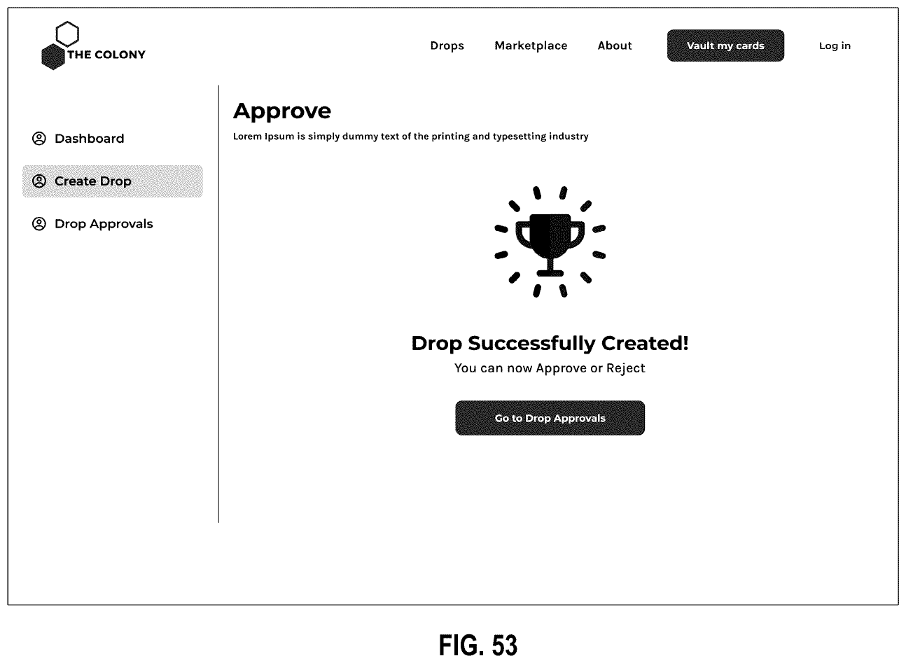

2514: System Automatically Generates and Submits Approval Request/Ticket Requesting Admin Approval of New Collectibles Drop. Following the preview, the system automatically generates an approval request or ticket for the new Collectibles Drop, which is submitted for administrative review. See, for example, FIG. 53. This automated step streamlines the approval process, ensuring that the drop has been thoroughly prepared and is ready for final review and approval by the platform's administrative team.

2516: System Admin Notified of Pending Approval Request/Ticket Requesting Approval of New Collectibles Drop. At this point, the system admin is notified of the pending approval request for the new Collectibles Drop. This notification is a desirable part of the workflow, alerting the admin to review the proposed drop and ensure it meets the platform's standards and requirements before it is made public.

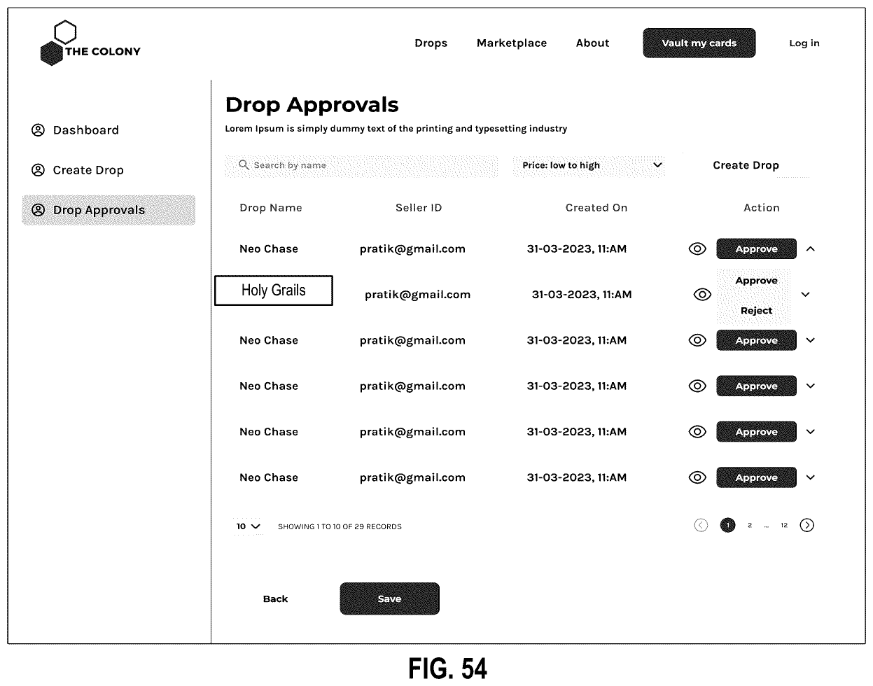

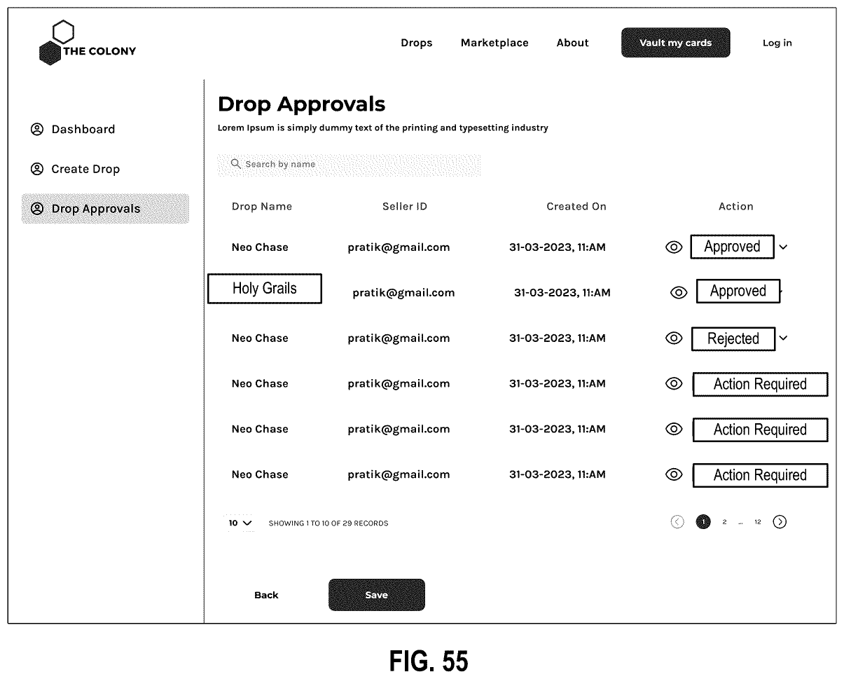

2518: System Admin Reviews Collectibles Drop Configuration Details and Initiates One or More Actions in Response. The system admin conducts a detailed review of the Collectibles Drop configuration details. This comprehensive assessment is helpful to ensure that the drop aligns with the platform's guidelines and market trends. Based on this review, the admin may take various actions, such as approving, editing, or rejecting the drop, to ensure it meets the required standards and appeals to the target audience. FIGS. 54 and 55 illustrate an example screenshots embodiment of an Admin Drop Approvals GUI, which is configured are designed to facilitate management of Drops requesting approvals.

2520: Assume Admin Approves. In this example flow, it is assumed that the admin approves the Collectibles Drop.

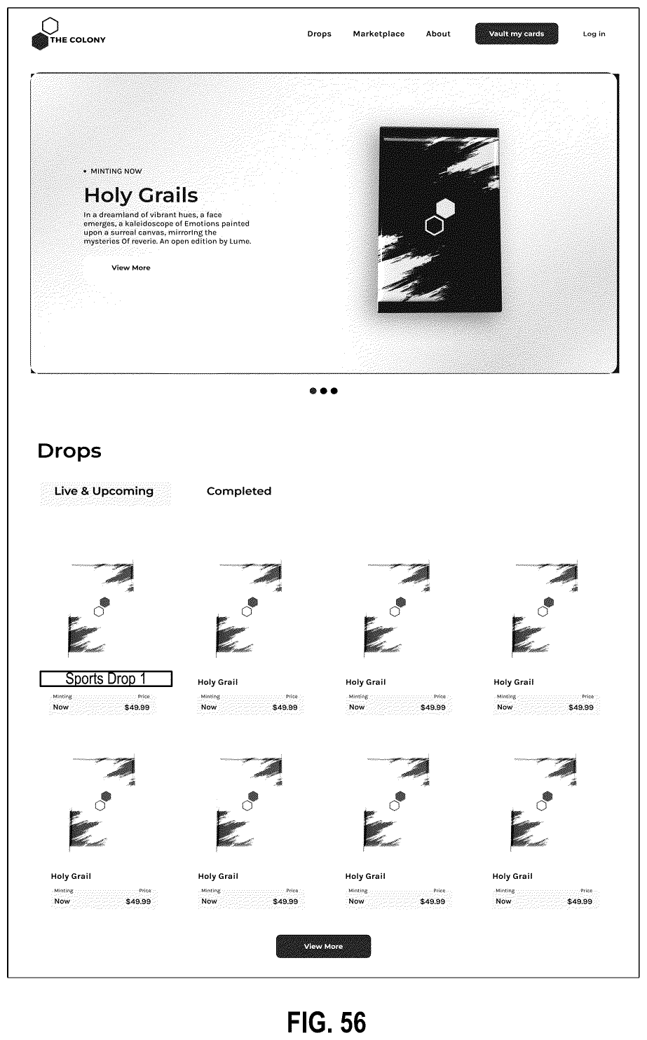

2522: New Collectibles Drop is Published via Online Platform and is Visible/Accessible to End Users. Upon admin approval, the new Collectibles Drop is published on the online platform (as illustrated, for example, in FIG. 56) making it visible and accessible to end users. This publication marks the official launch of the drop, introducing the curated collection of tokenized cards to the public. This step is helpful in attracting potential buyers and generating interest in the collection, signifying the successful completion of the drop configuration process.

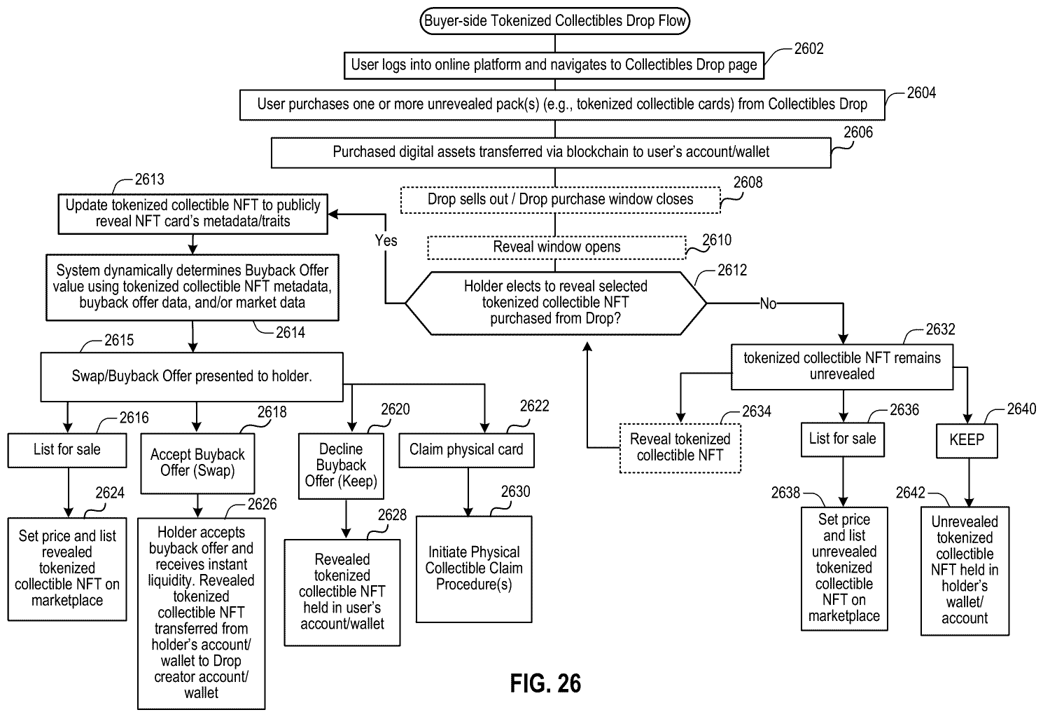

FIG. 26 shows an example embodiment of a Buyer-side Tokenized Collectibles Drop Flow. This flow showcases various functionalities and procedural flows of the Colony Platform relating to the tokenized Collectibles Drop Flow process for consumers/end users. Below is a description of the processes and procedural flows illustrated in the figure.

2602: User Logs Into Online Platform and Navigates to Collectibles Drop Page. This step marks the beginning of the user's interaction with the Colony Platform for tokenized collectibles. Here, the user logs into the platform using their credentials and navigates to the specific page dedicated to Collectibles Drops (e.g., FIG. 56). This page serves as a centralized hub where various collectibles drops are showcased, allowing users to browse through a diverse range of tokenized digital cards.

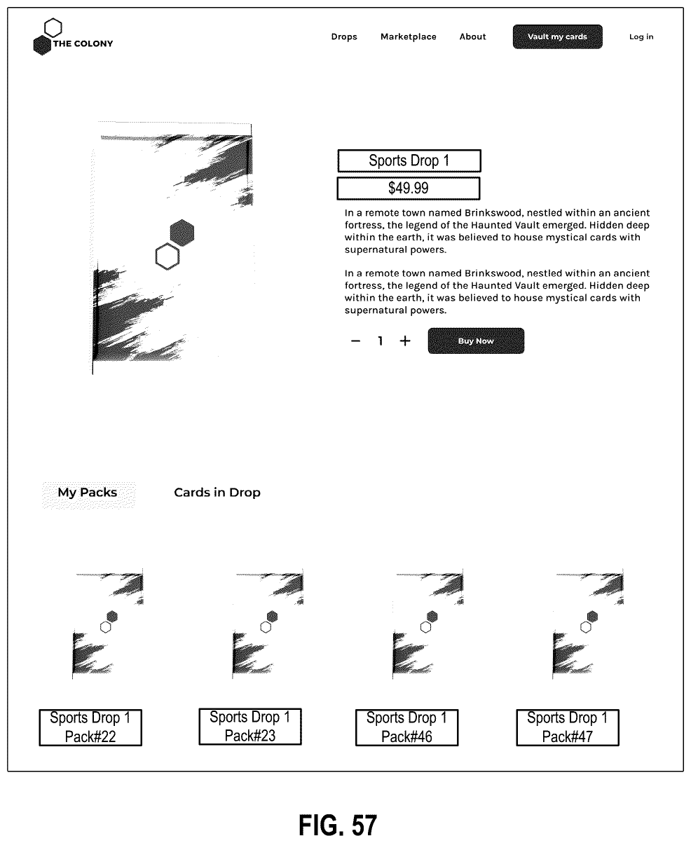

2604: User Purchases One or More Unrevealed Pack(s) (E.G. Tokenized Collectible Trading Cards) from Collectibles Drop. In this phase, users engage in the actual purchase of collectibles. They select and buy one or more unrevealed packs containing tokenized digital cards (e.g., via FIG. 57 GUI). Each pack corresponds to an unrevealed tokenized collectible card NFT, and represents a mystery, as the specific traits and details of the card is unknown until it is revealed. The purchase transaction is recorded on the blockchain.

2606: Purchased Digital Assets Transferred Via Blockchain to User's Account/Wallet. Following the purchase, the tokenized digital assets (cards) are transferred to the user's blockchain account or wallet. This transfer is facilitated through secure blockchain technology, ensuring the integrity and security of the transaction. The blockchain's immutable nature provides a reliable record of ownership, authenticity and provenance of these digital collectibles.

2608: Drop Sells Out / Drop Purchase Window Closes. This step signifies the conclusion of the sales phase of a particular collectibles drop. In at least one embodiment, the drop purchase window may be configured to automatically close once all the packs in the Drop are sold, or alternatively, may be configured to automatically close at a predetermined time/date. The closing of the purchase window marks the end of the availability of these specific collectibles for direct purchase from the platform. In at least one embodiment, after the closing of the drop purchase window, the system may be configured to allow a period of time to elapse before the opening of the reveal window. This provides tokenized collectible NFT holders with an opportunity to take advantage of market speculation.

2610: Reveal Window Opens. At a designated time/date the reveal window opens. This period allows users who have purchased the tokenized collectibles to reveal the traits and details of their tokenized collectible NFTs.

2612: Holder Elects to Reveal Selected Tokenized Collectible NFT Purchased from Drop? At this decision point, the system determines if the holder of the tokenized collectible NFT has initiated a request to reveal their tokenized NFT.

2613: Update Tokenized Collectible NFT to Publicly Reveal NFT Card's Metadata/Traits. If the holder has initiated a request to reveal their tokenized collectible NFT, the system initiates procedures for causing the tokenized NFT's traits, attributes and metadata to be publicly revealed.

2614: System Dynamically Determines Buyback Offer Value Using Tokenized Collectible NFT Metadata. In at least one embodiment. upon detecting that tokenized NFT's traits and attributes are publicly visible, the system may automatically initiate procedures for causing a buyback offer to be generated and presented to the holder of the revealed tokenized NFT. As part of this process, the dynamically determines a buyback offer value (or buyback offer price) for the revealed tokenized collectible NFT.

As previously described, the system may employ various valuation techniques for determining the Buyback Offer value for a the identified tokenized Collectible NFT, such as, for example, one or more of the following (or combinations thereof):
Determining the Buyback Offer value from predefined Buyback Value data configured within the smart contract;
Dynamically determining the Buyback Offer value based on current market data and/or historical sales data.

2615: Swap/Buyback Offer Presented to Holder. Holder has several options. In at least one embodiment, once the system has determined or calculated the buyback offer value for the identified tokenized collectible NFT, it may automatically initiate procedures for causing a buyback offer to be generated and presented to the holder of the revealed tokenized NFT. This step introduces a strategic decision-making aspect for the holder, providing the holder with several different options: List for tokenized NFT sale (2616), accept buyback offer (2618) receive instant liquidity, declined buyback offer (2620) and keep tokenized NFT, or initiate a request to claim the physical collectible card (2622).

2616 & 2624: List for Sale. Set Price and List Revealed Tokenized Collectible NFT on Marketplace. If the holder elects to list their revealed tokenized collectible NFT for sale, this option involves setting a price for the NFT and listing it on the Colony Platform marketplace (and/or other secondary marketplaces). This process allows holders to actively participate in the platform's secondary market, setting their desired price based on the perceived value of the collectible. The listing on the marketplace opens up opportunities for the NFT to be purchased by other enthusiasts and collectors, facilitating liquidity and trading within the community.

2618 & 2616: Accept Buyback Offer (Swap). In this option, if the holder decides to accept the buyback offer, it triggers the automatic execution of a tokenized NFT buyback (or swap) transaction in which the holder has agreed to sell the identified tokenized collectible NFT to the system for the buyback offer price. The smart contact executes the transfer of the tokenized Collectible NFT from the user's wallet to a designated Drop creator wallet/address, and the transfer of the Buyback Offer payment from a system controlled wallet to the user's wallet. In this way, the holder receives instant liquidity in exchange for the revealed tokenized collectible NFT being transferred from their account/wallet back to the drop creator's account/wallet.

2620 & 2628: Decline Buyback Offer (Keep). In this option, the holder elects to decline the buyback offer, and the revealed tokenized collectible NFT continues to be held in the holder's account/wallet.

2622 & 2630: Claim Physical Card. Initiate Physical Collectible Claim Procedure(s). For tokenized collectibles that have a corresponding vaulted physical collectible asset (e.g., such as physical collectible trading cards), this option involves the holder of the tokenized collectible NFT initiating a claim to take possession of the physical collectible asset that is linked to the tokenized collectible NFT. This process bridges the digital and physical aspects of collectibles, allowing holders to acquire a tangible representation of their digital assets. The claim procedure often involves verification of ownership, handling logistics, and ensuring the secure delivery of the physical collectible to the holder.

2632: Tokenized Collectible NFT Remains Unrevealed. Holder Has Several Options. In instances where the holder elects not to reveal the tokenized collectible NFT, the holder is presented with several different options: reveal tokenized collectible NFT (2634), list unrevealed tokenized collectible NFT for sale (2636), keep (2640) the tokenized NFT.

2634: User May Elect to Reveal Tokenized Collectible NFT. In one embodiment, the holder may elect at a later time to initiate a request to reveal the tokenized collectible NFT. This step allows holders to delay the revelation process, providing flexibility and control over the timing of uncovering their collectible's traits and characteristics. The decision to reveal may be influenced by market conditions, personal preferences, or strategic considerations.

2636 & 2638: List Unrevealed Tokenized Collectible NFT for Sale. Set Price and List Unrevealed Tokenized Collectible NFT on Marketplace. In this option, the holder may set a price for selling their unrevealed tokenized collectible NFT and listing it for sale on the marketplace. Listing an unrevealed NFT introduces an element of speculation and potential surprise for potential buyers, as the exact traits and characteristics of the collectible are not known until it is revealed. This process contributes to the dynamics of the secondary market, where the mystery of unrevealed collectibles may drive interest and trading activity.

2640 & 2642: User Keeps Unrevealed Tokenized Collectible NFT. Unrevealed Tokenized Collectible NFT Held in User's Wallet/Account. In option, the user elects to keep the unrevealed tokenized collectible NFT. It should be noted however, that in at least some embodiments, the system may automatically initiate the revealing of all unrevealed tokenized collectible NFTs in the Drop collection, in accordance with the rules and parameters defined in the smart contract.

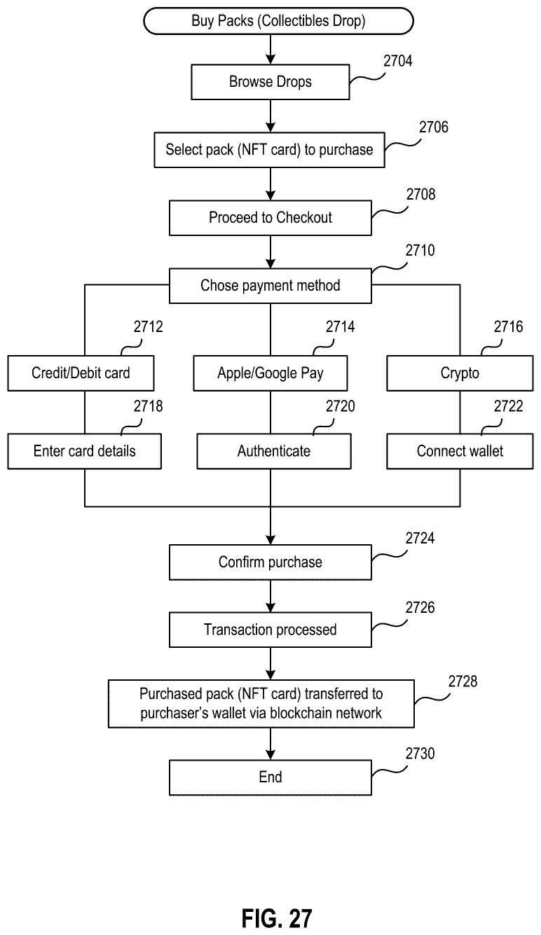

FIG. 27 shows an example embodiment of a Buy Packs (Collectibles Drop) Flow. This flow showcases various functionalities and procedural flows of the Colony Platform relating to the purchase of tokenized collectible NFTs by consumers/end users. Below is a description of the processes and procedural flows illustrated in the figure.

2704: Browse Drops. This step involves users exploring the available Collectibles Drops on the Colony Platform. Here, users may peruse a variety of tokenized collectible NFT packs, each potentially containing rare or unique digital cards. FIGS. 56, 57, and 58 illustrate example screenshots of Colony Platform GUIs which are configured or designed to facilitate the user in exploring and navigating through different live Drops and understand the specifics of each, including the theme, type of collectibles offered, and any unique attributes or rarity metrics associated with the NFTs.

2706: Select Pack (NFT Card) to Purchase. After browsing, a user selects specific tokenized collectible NFT pack(s) they wish to purchase (e.g., Sports Drop 1, FIG. 57). The selection process may involve reviewing detailed information about the pack, such as the number of cards, possible contents, rarity levels, and price.

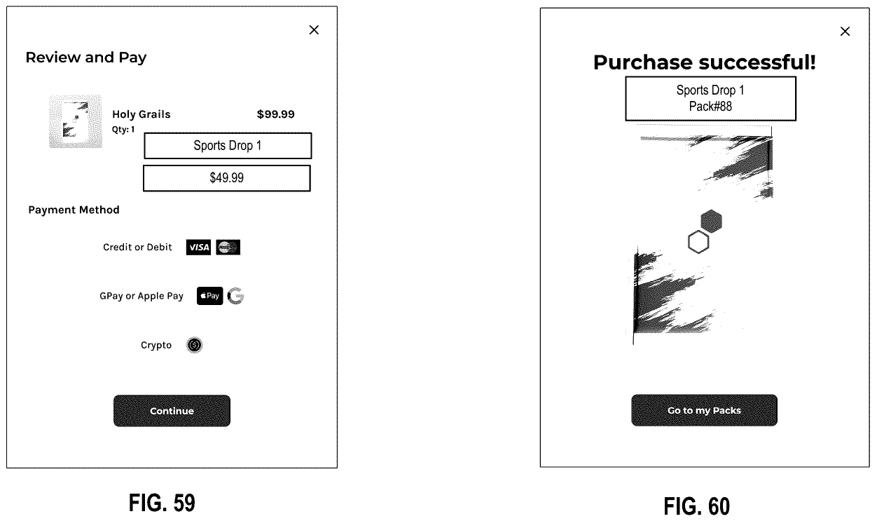

2708: Proceed to Checkout. Once a pack is selected, users proceed to the checkout process. This stage is where users review their selected items, confirm quantities, and prepare for payment. The checkout interface (e.g., FIG. 59) is designed to provide clear information about the selected items, total cost, and any additional fees or taxes.

2710-2716: Choose Payment Method. Users choose their preferred payment method. The Colony Platform offers multiple payment options to accommodate diverse user preferences and ensure accessibility. Options include credit/debit cards, Apple Pay or Google Pay, and cryptocurrencies. This flexibility in payment methods caters to a broad range of users, from traditional payment method users to crypto enthusiasts.

27218-2722: Enter Card Details, Authenticate, Connect Wallet. In this step, users enter their payment card details, authenticate their identity if required (e.g., Apple Pay or Google Pay), connect their digital wallet (for blockchain transactions).

2724: Confirm Purchase. At this step the user provides confirmation to execute the tokenized collectible NFT purchase transaction.

2726: Transaction Processed. Once the purchase is confirmed, the transaction is processed. This involves the secure transfer of funds from the user to the platform and marks the completion of the financial part of the collectible purchase process.

2728: Purchased Pack (NFT Card) Transferred to Purchaser's Wallet Via Blockchain Network. The final step in the process sees the purchased NFT pack transferred into the user's digital wallet via the blockchain network. This transfer ensures the secure and verifiable exchange of the digital asset. solidifying the user's ownership of the collectible NFT pack. The use of blockchain technology ensures transparency and authenticity.

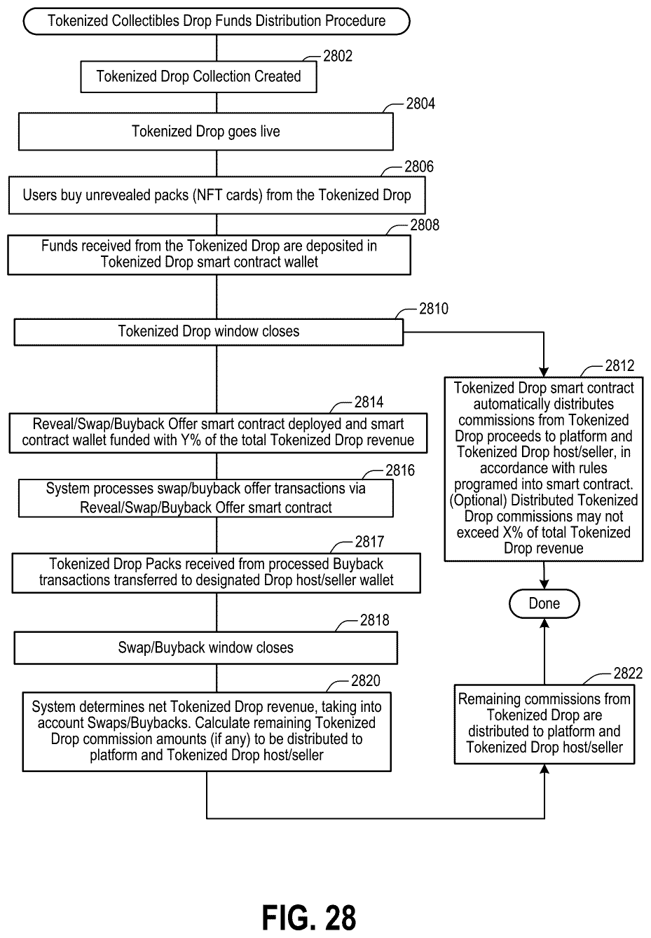

FIG. 28 shows an example embodiment of a tokenized Collectibles Drop Funds Distribution Procedure, illustrating various functionalities and procedural flows of the Colony Platform relating to the distribution of revenue generated from a tokenized Collectibles Drop, in accordance with predefined rules. Below is a description of the processes and procedural flows illustrated in the figure.

2802: Tokenized Collectible Drop Collection Created. At this initial stage, a tokenized Collectible Drop collection is created within the Colony Platform, as described previously with respect to FIGS. 24 and 25. This process involves configuring the parameters of the tokenized Collectible Drop collection, including configuring rules relating to the distributions of revenue generated from the tokenized Collectible Drop collection sales to various entities such as artists, creators, and administrators.

2804: Tokenized Drop goes live. In this phase, the tokenized Collectible Drop collection goes live and is opened to the public. This is when potential buyers can participate in the purchasing tokenized Collectible Packs (also referred to as “tokenized collectible NFTs”) from the Drop collection.

2806: Users Buy tokenized Collectible Packs from the live Drop. This step involves the actual transaction where users buy tokenized Collectible Packs from the Drop. Interested buyers interact with the smart contract associated with the tokenized Collectible Drop collection to purchase the tokenized Collectible Packs.

2808: Funds Received from the Tokenized Drop are Deposited in the Drop Smart Contract Wallet. Once users purchase the tokenized Collectible Packs, the funds received from these transactions are deposited into a dedicated smart contract wallet, known as the Drop smart contract wallet. This wallet is designed to hold the funds securely and manage them according to the predefined rules set within the smart contract. The funds in this wallet are used for various purposes, including funding the buyback offers and distributing commissions.

2810: Tokenized Drop Window Closes. After a specific period or once the tokenized Collectible Drop collection is fully minted, the purchase window closes. This marks the end of the live Drop phase, and no further Drop pack purchases can be made.

2812: Tokenized Drop Smart Contract Automatically Distributes Commissions. This process involves the smart contract calculating and distributing a portion of the earnings related to the sales of tokenized Collectible Packs to the admin's and creator's designated wallets in accordance with predefined rules configured into the smart contract. In at least one embodiment, the predefined rules configured into the smart contract may specify that only a predetermined percentage (e.g., 25%) of the tokenized Collectible Pack purchase revenue is allowed to be distributed to the admin/creators before the closing of the buyback window. The system holds the remaining percentage (e.g., 75%) of the tokenized Collectible Pack purchase revenue in reserve to be used for funding payment of accepted buyback offer transactions and other related expenses, in accordance with predefined rules configured into the smart contract.

2814: Reveal/Buyback Offer Smart Contract Deployed and Smart Contract Wallet Funded with Y % of Total Tokenized Drop Revenue. In this step, a separate smart contract, specifically for the reveal and buyback offer, is deployed. This smart contract is funded with a certain percentage (denoted as Y %) of the total purchase revenue (e.g., 75%). The percentage allocated is used to manage the buyback offers and other related transactions.

2816: System Processes Swap/Buyback Offer Transactions via Reveal/Buyback Offer Smart Contract. This process involves the system processing tokenized Pack buyback transactions, which are funded using the portion of the tokenized Collectible Drop revenue that was deposited into the Reveal/Buyback Offer Smart Contract Wallet.

2817: Tokenized Drop Packs received from processed Buyback Offer transactions transferred to designated Drop host/seller wallet. As part of the processing of the tokenized Pack buyback transactions, the tokenized Packs (or NFTs) which are bought back from the users are automatically transferred to a designated Drop host/seller wallet, in accordance with predefined rules configured into the smart contract.

2818: Buyback Window Closes. Following the processing of swap/buyback offers, the buyback window closes. This marks the end of the period during which tokenized Collectible Pack holders can opt to sell their tokenized Collectible Packs back to the platform under the buyback scheme.

2820: System Determines Net Tokenized Drop Revenue Taking into Account Buyback Transactions. After the closure of the buyback window, the system calculates the net purchase revenue, taking into account all transactions, including all tokenized Collectible Pack buyback transactions.

2822: Remaining Commissions from Tokenized Drop are Distributed to Platform and Artists. In response to detecting the close of the buyback offer window, the smart contract automatically calculates the net purchase revenue and distributes any remaining commissions from the net purchase revenue to the appropriate wallet addresses, in accordance with predefined rules configured into the smart contract. This step may also include the distribution of earnings from transactions other than sales, such as royalties from secondary sales.

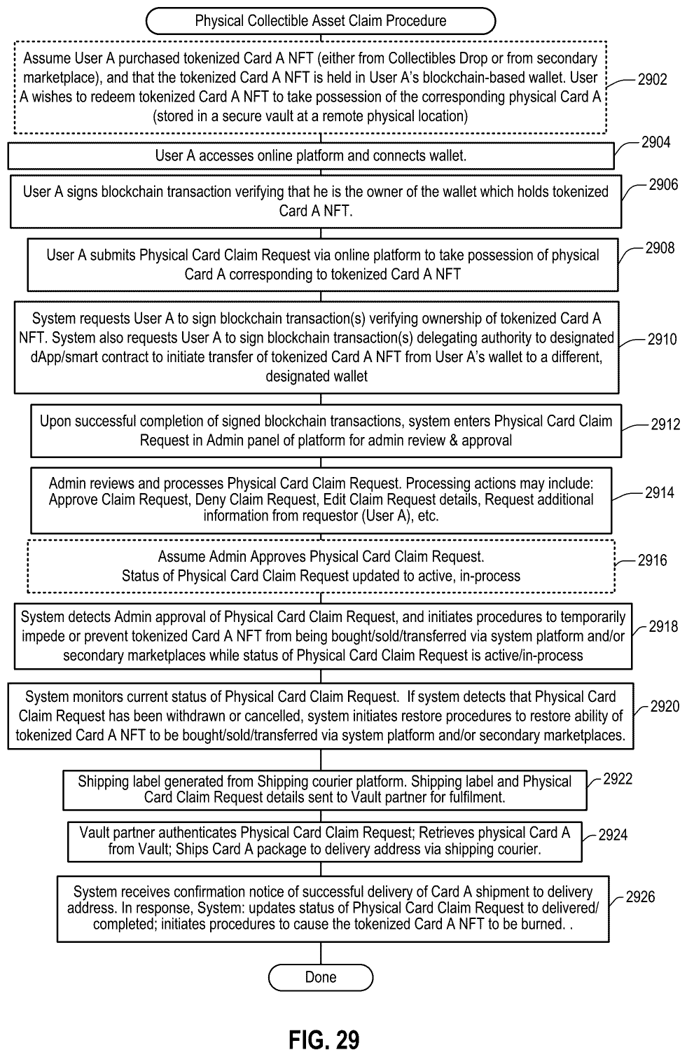

FIG. 29 shows an example embodiment of a Physical Collectible Asset Claim Procedure. This procedure showcases various functionalities and procedural flows of the Colony Platform relating to the process of an owner of a tokenized collectible NFT taking possession of the corresponding physical collectible asset. Below is a description of the processes and procedural flows illustrated in the figure.

2902: Assume User A purchased tokenized Card A NFT (either from Collectibles Drop or from secondary marketplace) and that the tokenized Card A NFT is held in User A's blockchain-based wallet. User A wishes to redeem tokenized Card A NFT to take possession of the corresponding physical Card A (stored in a secure vault at a remote physical location). This step serves as the starting point of the Physical Collectible Asset Claim Procedure. Here, it is assumed that User A, an owner of a tokenized collectible NFT (specifically, tokenized Card A NFT), has acquired this asset either through a Collectibles Drop or via a secondary marketplace transaction. The tokenized Card A NFT is securely stored in User A's blockchain-based wallet. The objective of User A is to redeem this digital asset to claim the corresponding physical collectible (Card A), which is securely held at a remote vault location.

2904: User A accesses online platform and connects wallet. In this step, User A engages with the Colony Platform's online interface. The action involves accessing the platform, through a web or mobile application, and subsequently connecting their blockchain-based wallet to the platform. This connection is necessary for the platform to verify User A's ownership of the tokenized Card A NFT and to initiate further steps in the Physical Collectible Asset Claim Procedure.

2906: User A signs blockchain transaction verifying that he is the owner of the wallet which holds tokenized Card A NFT. This signature acts as a digital verification, affirming that User A is the legitimate owner of the wallet that contains the tokenized Card A NFT.

2908: User A submits Physical Card Claim Request via online platform to take possession of physical Card A corresponding to tokenized Card A NFT. In this step, User A actively participates in the claim process by submitting a Physical Card Claim Request through the online platform. This request is a formal declaration of intent to take possession of the physical collectible (Card A) that corresponds to their tokenized Card A NFT. The submission process involves filling out a form or providing specific instructions within the platform interface, detailing the request and including necessary payment details for shipping the physical asset.

2910: System requests User A to sign blockchain transaction(s) verifying ownership of tokenized Card A NFT. System also requests User A to sign blockchain transaction(s) delegating authority to designated dApp/smart contract to initiate transfer of tokenized Card A NFT from User A's wallet to a different designated wallet. This step further fortifies the security and integrity of the asset claim process. The system requests User A to sign additional blockchain transactions, serving two purposes: (1) further verification of ownership over the tokenized Card A NFT, and (2) delegation of authority to a designated decentralized application (dApp) or smart contract. This delegation is desirable for transferring the NFT from User A's wallet to another specified wallet, which is part of the procedure in managing the claim for the physical asset.

2912: Upon successful completion of signed blockchain transactions system enters Physical Card Claim Request in Admin panel of platform for admin review & approval. Once User A successfully completes the requested blockchain signature transactions, the system automatically updates the Physical Card Claim Request status in the platform's Admin panel. This step involves the administrative side of the platform, where the submitted request is queued for review and approval by the platform's administrators. This process is helpful for ensuring that the claim request adheres to the platform's policies and is legitimate. The admin review may involve verifying the details of the request, the ownership of the NFT, and the eligibility for claiming the physical asset.

2914: Admin reviews and processes Physical Card Claim Request. Processing actions may include: Approve Claim Request, Deny Claim Request, Edit Claim Request details, Request additional information from requestor (User A) etc. In this step, the platform's administrator takes an active role in processing the Physical Card Claim Request submitted by User A. The review process encompasses a range of potential actions, depending on the assessment of the request. These actions may include approving the claim request (thereby allowing the claim procedure to proceed), denying the request (if it doesn't meet certain criteria or is found to be illegitimate), editing the details of the request for accuracy or completeness, or requesting additional information from User A to clarify or supplement the claim request. This step is helpful in ensuring the integrity and efficiency of the claim process.

2916: Assume Admin Approves Physical Card Claim Request. Status of Physical Card Claim Request updated to active in-process. This step presupposes that the admin has approved the Physical Card Claim Request. Following this approval, the status of the request is updated to reflect that it is now active and in-process. This status update is a pivotal moment in the claim procedure, signifying that the request has passed the necessary administrative checks and is moving forward in the process. The active in-process status triggers a series of subsequent actions within the system to facilitate the physical delivery of the claimed collectible (Card A).

2918: System detects Admin approval of Physical Card Claim Request and initiates procedures to temporarily impede or prevent tokenized Card A NFT from being bought/sold/transferred via system platform and/or secondary marketplaces while status of Physical Card Claim Request is active/in-process. Upon detection of the admin's approval, the system initiates a helpful safeguard procedure. This procedure involves temporarily restricting any buying, selling, or transferring of the tokenized Card A NFT on both the Colony Platform and any connected secondary marketplaces. This measure is intended to maintain the integrity of the claim process by ensuring that the NFT remains stationary and unaltered during the active phase of the physical asset claim. This temporary impediment is a security feature that prevents any potential complications or fraud during the claim process.

2920: System monitors current status of Physical Card Claim Request. If system detects that Physical Card Claim Request has been withdrawn or cancelled, system initiates restore procedures to restore ability of tokenized Card A NFT to be bought/sold/transferred via system platform and/or secondary marketplaces. This step involves the system's continuous monitoring of the status of the Physical Card Claim Request. Should the system detect any changes, such as the withdrawal or cancellation of the request, it is programmed to initiate a restoration procedure. This procedure would reverse the temporary restrictions imposed on the tokenized Card A NFT, thereby restoring its ability to be traded or transferred. This restoration ensures that the NET's market activities may resume normally in cases where the physical claim is no longer proceeding.

2922: Shipping label generated from Shipping courier platform. Shipping label and Physical Card Claim Request details sent to Vault partner for fulfilment. Once the Physical Card Claim Request is active and in-process, the next logistical step is initiated. This involves the generation of a shipping label from a shipping courier platform. This label, along with the details of the Physical Card Claim Request, is sent to the Vault partner responsible for the physical storage of the collectible. The Vault partner plays a role in the fulfillment process, as they are tasked with the physical handling and dispatch of the collectible (Card A) to User A.

2924: Vault partner authenticates Physical Card Claim Request; Retrieves physical Card A from Vault; Ships Card A package to delivery address via shipping courier. This step marks the active involvement of the Vault partner in the claim process. The Vault partner, upon receiving the shipping label and claim request details, first authenticates the request to ensure its legitimacy. Following successful authentication, the partner retrieves the specific physical collectible (Card A) from their vault storage. The collectible is then packaged and dispatched to the delivery address specified by User A, using the provided shipping label and courier service. This step it involves the physical handling and secure transportation of the collectible, ensuring it reaches User A safely and accurately.

2926: System receives confirmation notice of successful delivery of Card A shipment to delivery address. In response System: updates status of Physical Card Claim Request to delivered/completed; initiates procedures to cause the tokenized Card A NFT to be burned. In the final step of the procedure, the system receives a confirmation notice indicating the successful delivery of the physical Card A to User A's specified delivery address. Upon receiving this notice, the system updates the status of the Physical Card Claim Request to reflect that it has been successfully delivered and completed. Additionally, the system initiates a procedure to burn the tokenized Card A NFT. This burning process effectively removes the digital token from circulation, signifying the completion of the claim process and the transfer of ownership from a digital to a physical format. This final step marks the resolution of the claim process, with User A now in possession of the physical collectible and the corresponding tokenized collectible NFT being removed from circulation on the blockchain.

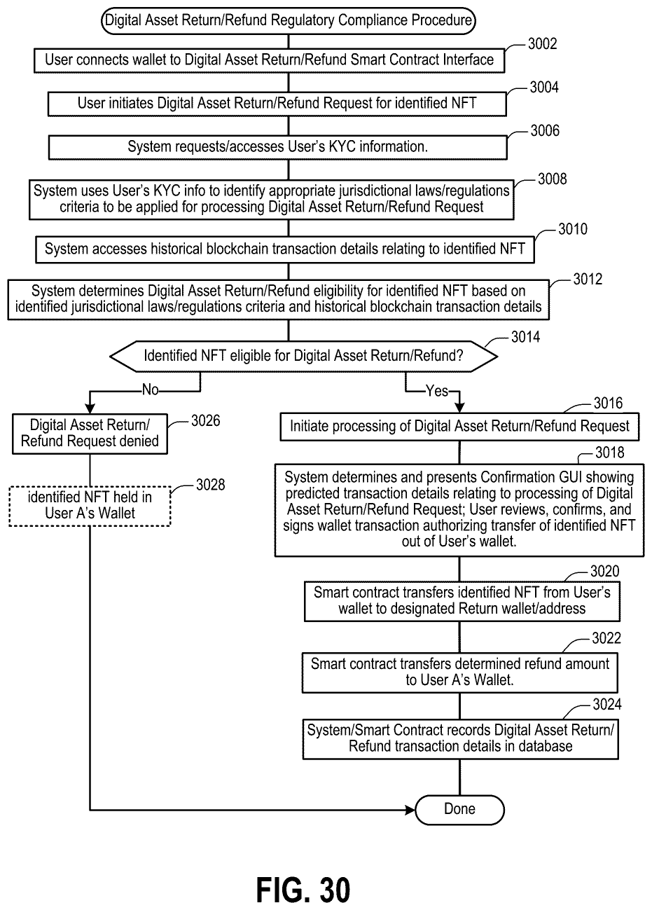

FIG. 30 shows an example embodiment of a Digital Asset Return/Refund Regulatory Compliance Procedure. This procedure showcases various functionalities and procedural flows of the Colony Platform relating to the process of refunding a consumer for the purchase of a digital asset in compliance with consumer protection laws and regulations. Below is a description of the processes and procedural flows illustrated in the figure.

3002: User connects wallet to Digital Asset Return/Refund Smart Contract Interface In this initial step, the user engages with the Colony Platform by connecting their digital wallet to the Digital Asset Return/Refund Smart Contract Interface. This connection is desirable for initiating the return or refund process for a purchased NFT (Non-Fungible Token). The wallet connection ensures that the user's identity and ownership of the NFT are securely verified, laying the groundwork for the subsequent steps in the refund process.

3004: User initiates Digital Asset Return/Refund Request for identified NFT After successfully connecting their wallet, the user initiates a return or refund request for a specific NFT. This action involves the user identifying the NFT from the user's digital wallet and formally requesting a refund through the platform's interface. In some embodiments, the user may be required to identify a reason for requesting the refund.

3006: System requests/accesses User's KYC information The system may request or access the user's Know Your Customer (KYC) information. KYC is a helpful component in regulatory compliance, involving the verification of a customer's identity to prevent fraud and comply with anti-money laundering laws. In this context, the KYC information helps the platform verify the user's identity and ensure that the return/refund request is legitimate. This step also ensures that the refund process adheres to the legal and regulatory requirements specific to the user's jurisdiction.

3008: System uses User's KYC info to identify appropriate jurisdictional laws/regulations criteria to be applied for processing Digital Asset Return/Refund Request Using the KYC information, the system identifies the jurisdictional laws and regulations applicable to the user. This is a helpful step as digital asset transactions often have varied legal implications across different jurisdictions. By identifying the relevant jurisdictional laws and regulations, the system ensures that the return/refund process complies with the specific consumer protection laws and regulations governing digital asset transactions in the user's region.

3010: System accesses historical blockchain transaction details relating to identified NFT The system retrieves the historical transaction details of the identified NFT from the blockchain. This includes data such as the minting date and time, sale history, and any transfer records associated with the NFT. These details are helpful for establishing the provenance and transaction history of the digital asset, which are helpful factors in assessing the eligibility of the NFT for a refund.

3012: System determines Digital Asset Return/Refund eligibility for identified NFT based on identified jurisdictional laws/regulations criteria and historical blockchain transaction details In this step, the system evaluates the return/refund eligibility of the identified NFT. This determination is based on a comprehensive analysis that includes the jurisdictional laws and regulations (identified in step 3008) and the historical blockchain transaction details of the NFT (gathered in step 3010). The system assesses factors such as the time elapsed since the purchase, the nature of the transaction, and any usage of the NFT's benefits to decide if the refund request meets the established criteria.

According to different embodiments, the system may consider various criteria to determine the eligibility for a return/refund, including, for example, one or more of the following (or combinations thereof):
Time Window for Returning a Digital Purchase: The system will check if the return request falls within the EU's mandated 14-day cooling-off period, which allows consumers to cancel and return online purchases for a full refund within this time frame without providing any reason.
Blockchain Transaction History: The platform will review the blockchain transaction ledger to verify the date and time of the NFT purchase, ensuring the return request is within the legal time window. The immutable nature of blockchain records provides a clear and tamper-proof transaction history.
Original Purchaser Verification: The system will confirm whether the consumer requesting the return is the original purchaser of the NFT. This is helpful because the right to return typically applies to the original buyer, as stipulated in EU consumer protection laws.
Consumption of NFT Content: The system will investigate if any of the NFT's content has been consumed. According to EU regulations, if the consumer has begun downloading or streaming online digital content and acknowledged at the time of purchase that they would lose their right to withdrawal, they may not be eligible for a refund.
Original Purchase Agreement Terms: The terms and conditions of the original purchase agreement will be reviewed to see if the consumer waived any rights at the time of purchase. This may include waiver clauses where the consumer agrees to lose their right to withdrawal upon the commencement of the digital content download or use.
Additional Criteria:
   The system may also consider whether the NFT has been transferred or sold to another user, as the return policy typically applies to direct transactions between the original buyer and the seller.
   The nature of the NET content will be evaluated. For example, if the NFT includes a license to use digital content that cannot be returned or has a one-time use, it may affect refund eligibility.
   Any modifications made to the NFT by the consumer post-purchase may void the right to return, as the digital asset would no longer be in its original condition.
   If the NFT was purchased as part of a package or bundle, the terms of return may differ, especially if parts of the bundle have been used or are non-refundable.

3014: Identified NFT eligible for Digital Asset Return/Refund? This decision point is where the system investigates whether the identified NFT is eligible for a return/refund based on the assessments made in the previous steps. If the NFT meets all the required criteria for a refund, including compliance with relevant laws and regulations and adherence to the platform's refund policy, the process moves forward to the next step. If the NFT is deemed ineligible for a refund, the request is denied, and the NFT remains in the user's wallet.

3016: Initiate processing of Digital Asset Return/Refund Request Upon confirming the eligibility of the NFT for a return/refund, the system initiates the processing of the request. This involves a series of steps to facilitate the refund, including the preparation of transaction details for the user's review and the transfer of the NFT out of the user's wallet.

3018: System determines and presents Confirmation GUI showing predicted transaction details relating to processing of Digital Asset Return/Refund Request; User reviews, confirms, and signs wallet transaction authorizing transfer of identified NFT out of User's wallet In this step, the system presents a Confirmation Graphical User Interface (GUI) to the user. This GUI displays the predicted details of the refund transaction, including the amount to be refunded and any associated fees. The user is expected to review these details, confirm their accuracy, and then sign a wallet transaction to authorize the transfer of the identified NFT out of their wallet.

3020: Smart contract transfers identified NFT from User's wallet to designated Return wallet/address Following the user's authorization, a smart contract facilitates the transfer of the identified NFT from the user's wallet to a designated return wallet or address. This transfer is an automated process, securely executed by the smart contract on the blockchain. The return wallet or address is controlled by the platform or an appointed intermediary, responsible for handling returned digital assets.

3022: Smart contract transfers determined refund amount to User A's Wallet Concurrent with the transfer of the NFT, the smart contract also processes the refund transaction. The predetermined refund amount, as agreed upon in the Confirmation GUI, is transferred to User A's wallet. This transaction is securely executed on the blockchain, ensuring the integrity and traceability of the refund.

3024: System/Smart Contract records Digital Asset Return/Refund transaction details in database the final step in the refund process involves the system or smart contract recording the details of the return/refund transaction in a database. This recording includes information about the returned NFT, the refund amount, and any relevant transaction timestamps. This step is helpful for maintaining a comprehensive record of all refund transactions, which is important for audit purposes, regulatory compliance, and maintaining transparency in the platform's operations. The recorded data serves as an immutable record of the transaction, contributing to the integrity and accountability of the platform's refund process.

FIGS. 31-65 illustrate example screenshots of various graphical user interfaces (GUIs) of the Colony Platform. The Colony Platform GUIs include different Admin (Back End) GUIs and Front End (User) GUIs which are configured or designed to facilitate activities conducted on the Colony Platform.

In at least one embodiment, the Colony Platform is configured or designed to provide creators, artists, and administrators with access to a variety of different Backend graphical user interfaces (“Backend GUIs”) which are specifically configured or designed to facilitate the carrying out of backend system related tasks. Examples of such Backend GUIs are illustrated and described respect to FIGS. 31-37 and 46-55 of the drawings.

In at least one embodiment, the Colony Platform is configured or designed to provide end users with access to a variety of different Front End graphical user interfaces (“Front End GUIs”) which are specifically configured or designed to facilitate the carrying out of front end related tasks. Examples of such front End GUIs are illustrated and described respect to FIGS. 38-45 and 56-65 of the drawings.

FIG. 31 illustrates an example screenshot of an Admin NFT collection creation GUI.

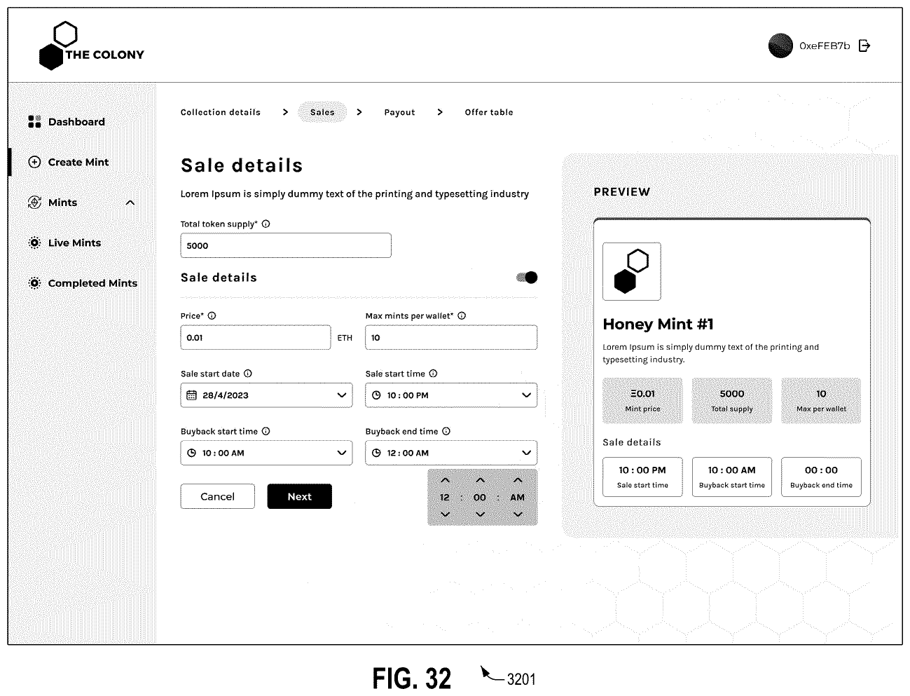

FIG. 32 illustrates an example screenshot of details for configuring Mint and related NFT sales/reveal/buyback time windows.

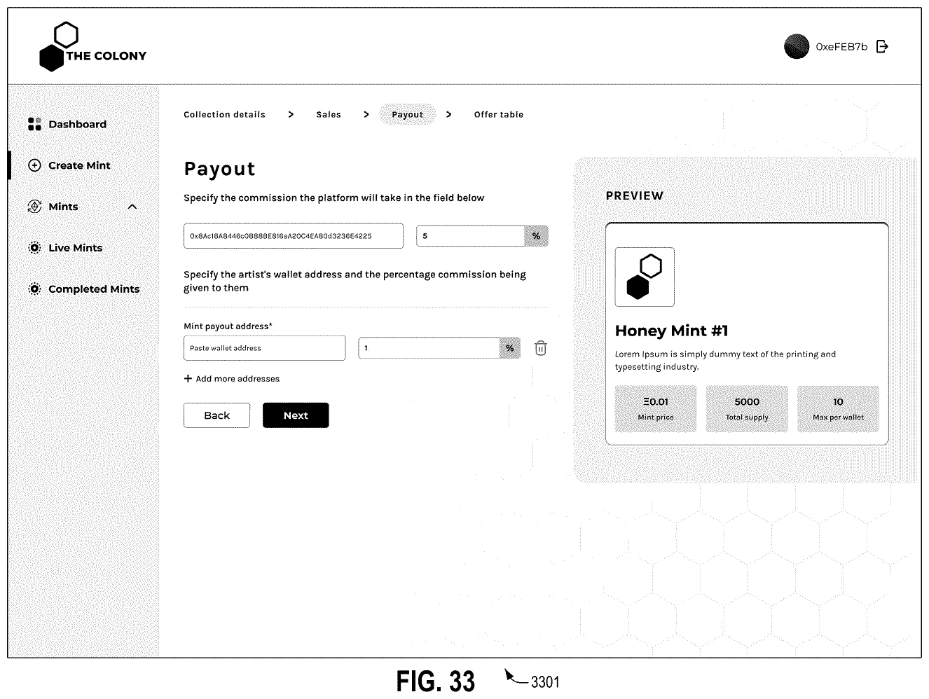

FIG. 33 illustrates an example screenshot of details for configuring Mint commission and wallet details for payouts.

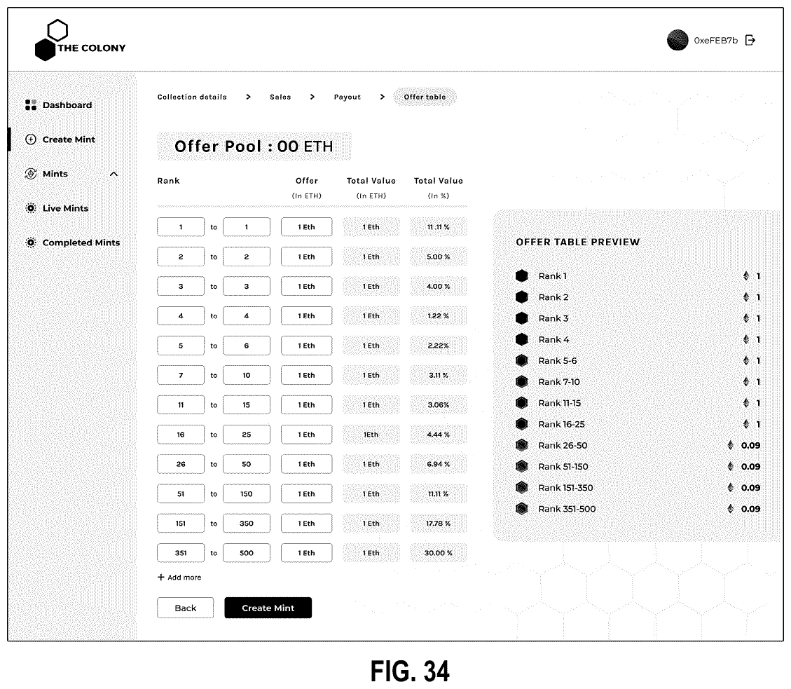

FIG. 34 illustrates an example screenshot of a GUI for configuring buyback offer pool values.

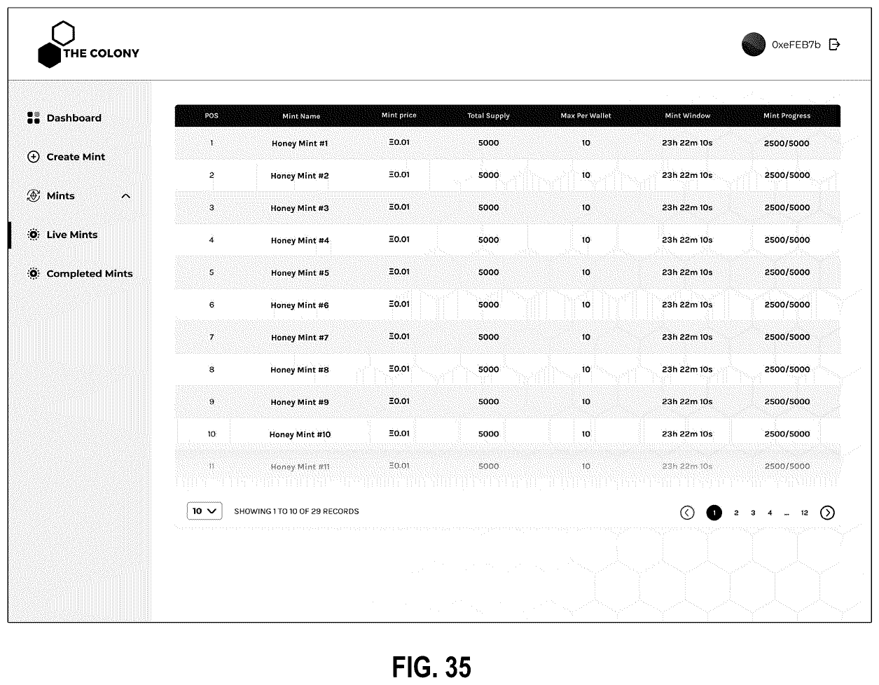

FIG. 35 illustrates an example screenshot of an Admin GUI listing all live mints on the platform.

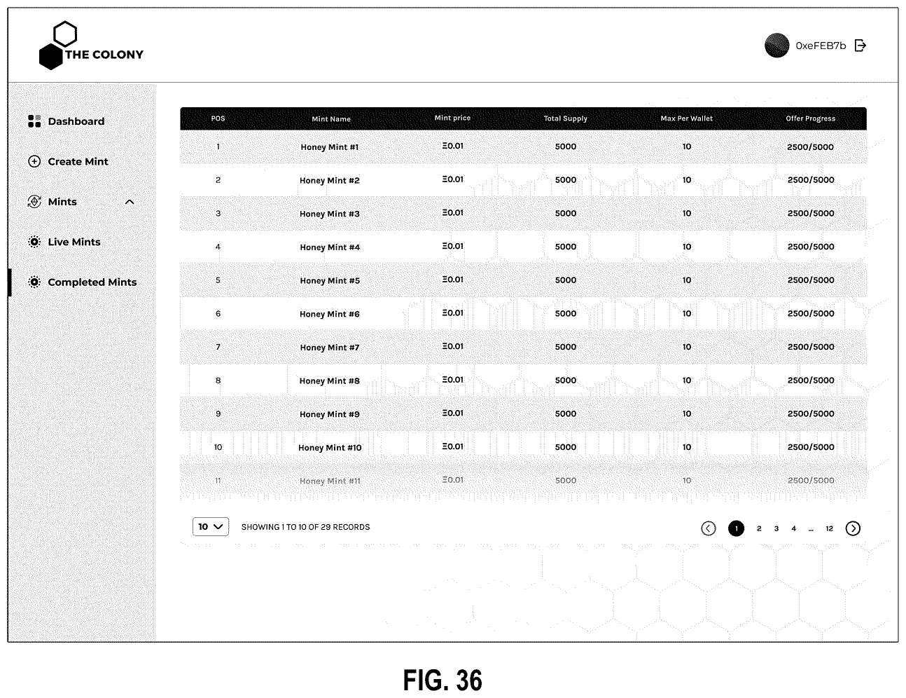

FIG. 36 illustrates an example screenshot of an Admin GUI listing all completed mints (with the buyback period closed).

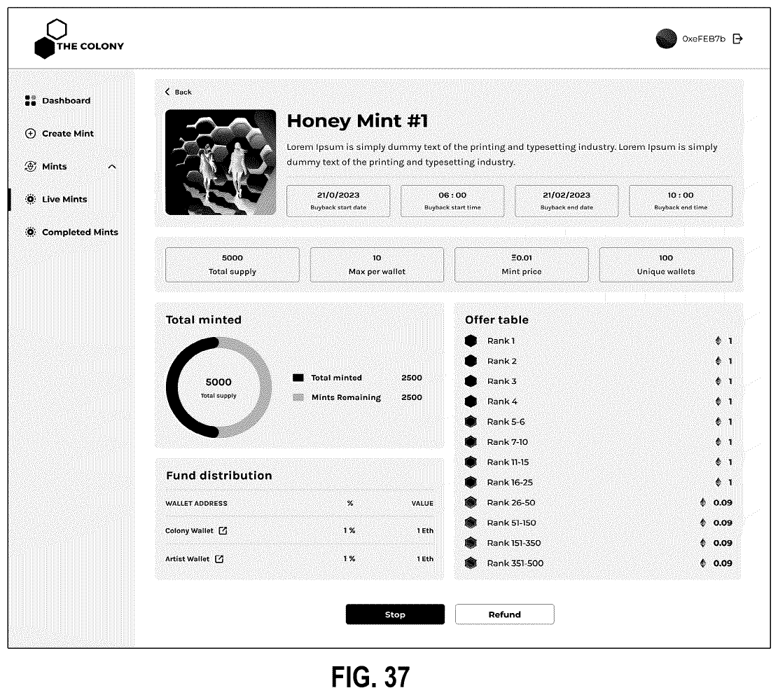

FIG. 37 illustrates an example screenshot of a Mint Collection Analytics Page on the Admin GUI.

FIG. 38 illustrates an example screenshot of an active live mints GUI on the Front End.

FIG. 39 illustrates an example screenshot of a Front End GUI showing collections from which a user has purchased NFTs.

FIG. 40 illustrates an example screenshot of a live mint details page on the Front End GUI.

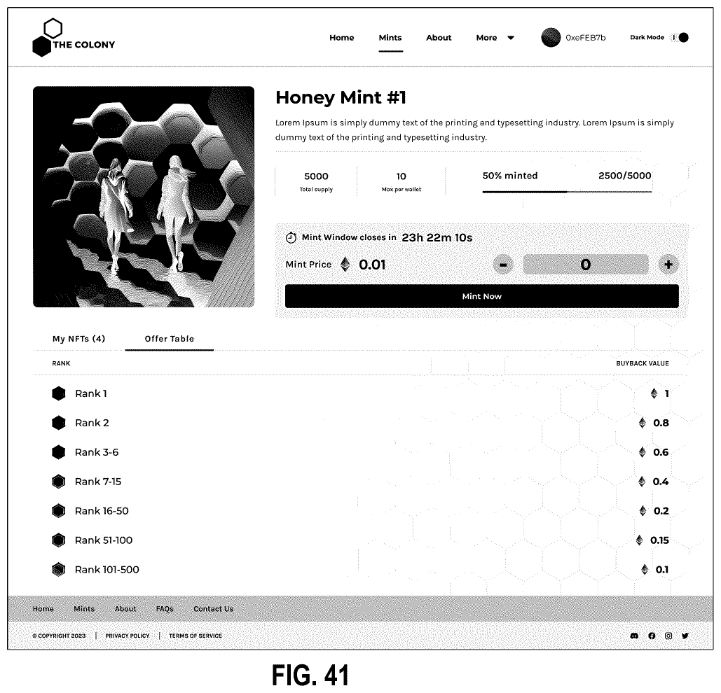

FIG. 41 illustrates an example screenshot of a live mint details page on the Front End GUI showing a buyback offer for rarity ranked 10.

FIG. 42 illustrates an example screenshot of a live mint details page on the Front End GUI, showing the mint is closed, and the reveal is open.

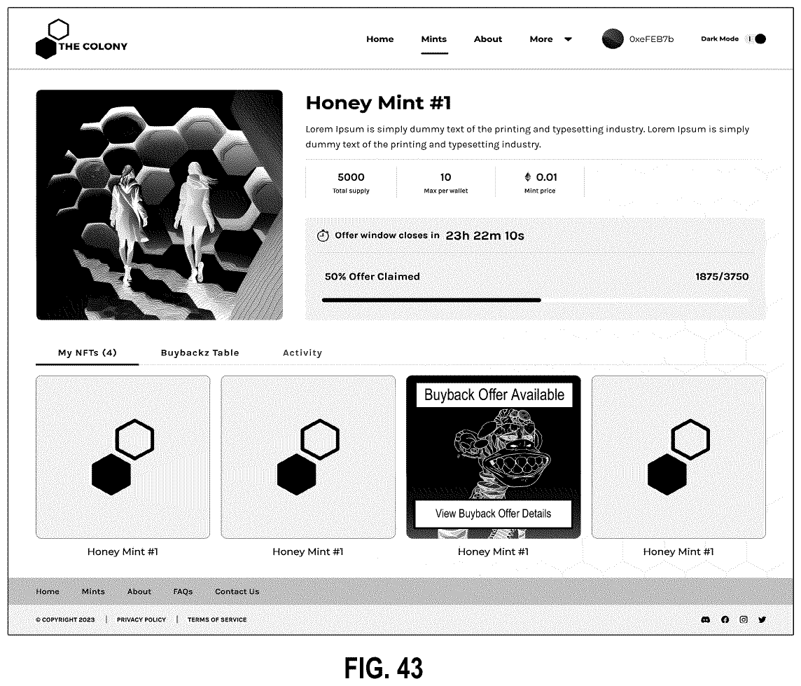

FIG. 43 illustrates an example screenshot of a Front End GUI with the mint closed and buyback offer period open.

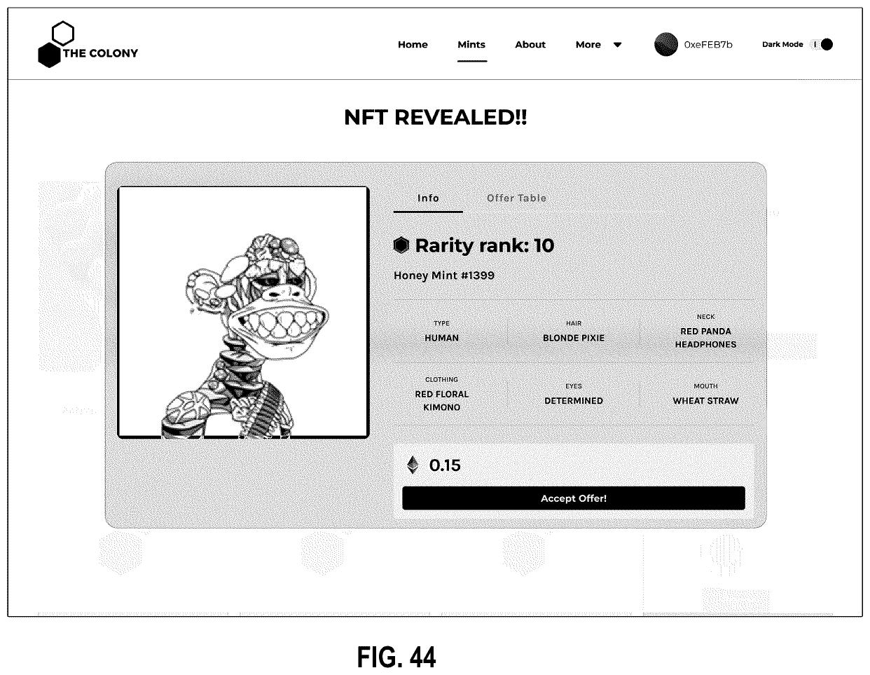

FIG. 44 illustrates an example screenshot of an NFT buyback offer details page on the Front End GUI.

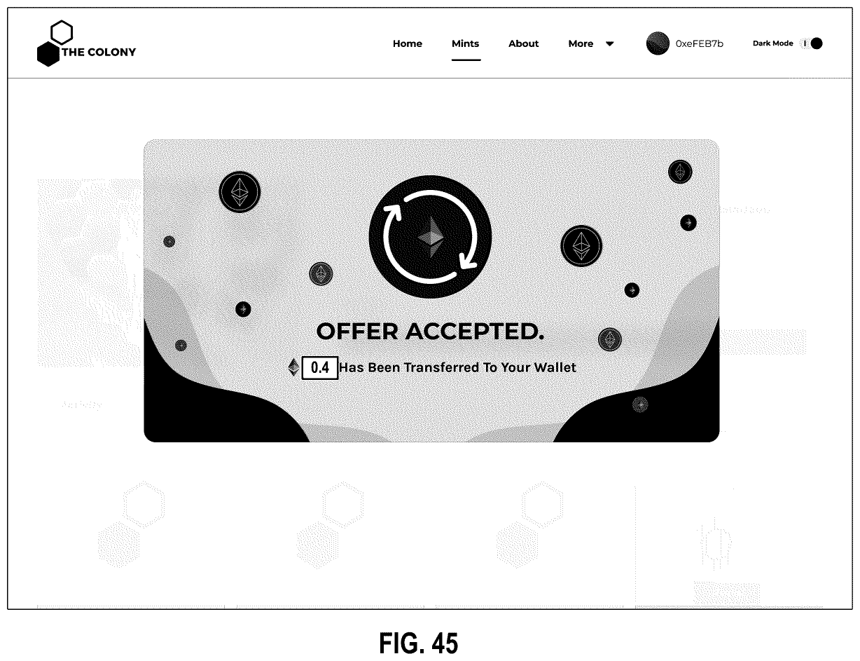

FIG. 45 illustrates an example screenshot of a notification of a successful NFT buyback transaction on the Front End GUI.

FIG. 46 illustrates an example screenshot of an Admin collectibles GUI for the creation of tokenized collectible NFTs.

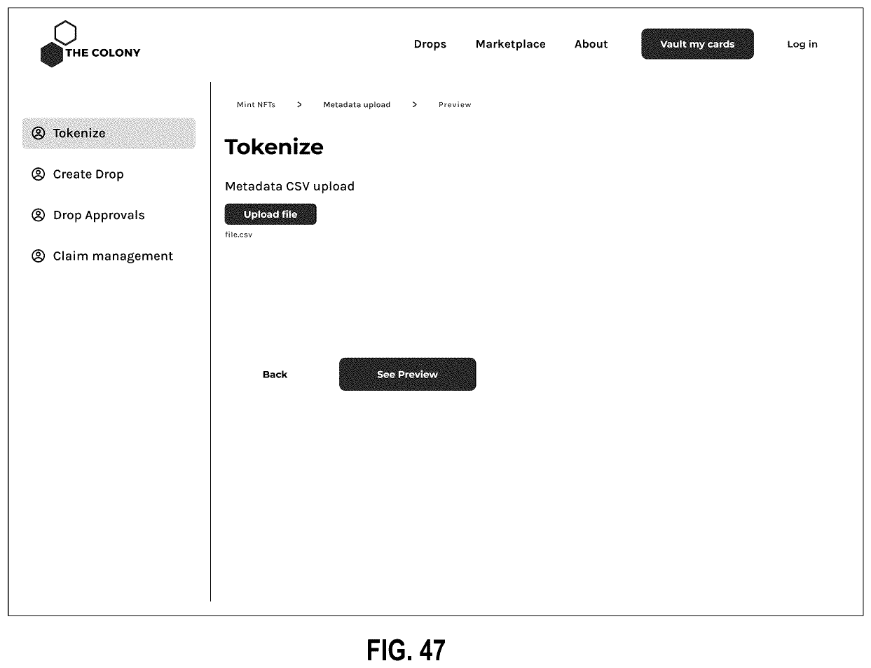

FIG. 47 illustrates an example screenshot of an Admin collectibles GUI image upload page for tokenized collectible NFTs.

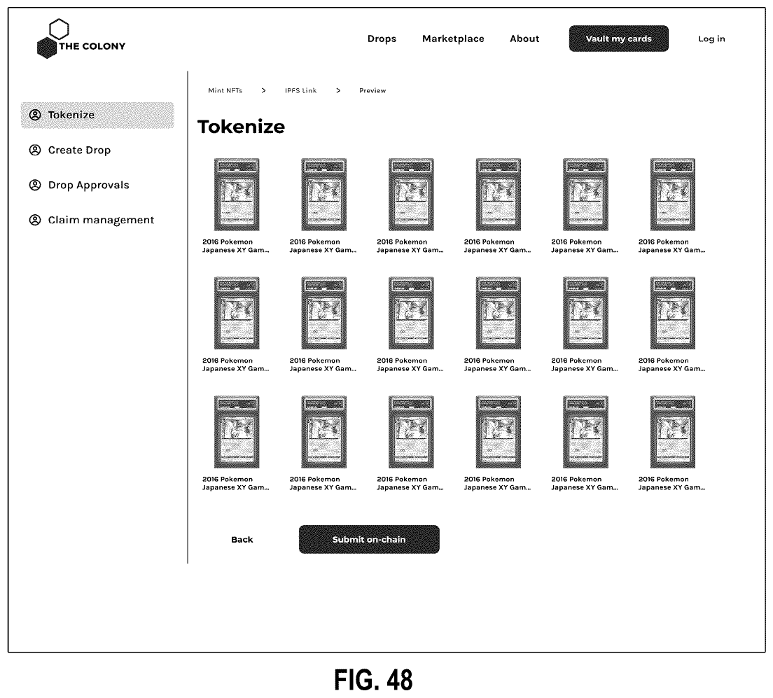

FIG. 48 illustrates an example screenshot of a review GUI on the Admin collectibles GUI.

FIG. 49 illustrates an example screenshot of an Admin collectibles GUI for the creation of a tokenized collectible drop.

FIG. 50 illustrates an example screenshot of an Admin collectibles GUI for selecting cards for a tokenized collectible drop.

FIG. 51 illustrates an example screenshot of an Admin collectibles GUI for configuring customized buyback offer values for tokenized collectible NFTs.

FIG. 52 illustrates an example screenshot of an Admin collectibles GUI preview of a tokenized collectible drop page.

FIG. 53 illustrates an example screenshot of an Admin collectibles GUI for the approval of a tokenized drop collection.

FIG. 54 illustrates an example screenshot of an Admin collectibles GUI for managing tokenized drop collections requesting approval.

FIG. 55 illustrates an example screenshot of an Admin collectibles GUI for managing tokenized drop collections.

FIG. 56 illustrates an example screenshot of a Front End collectibles GUI for browsing live and upcoming drops.

FIG. 57 illustrates an example screenshot of a Front End collectibles GUI showing details of a live drop collection.

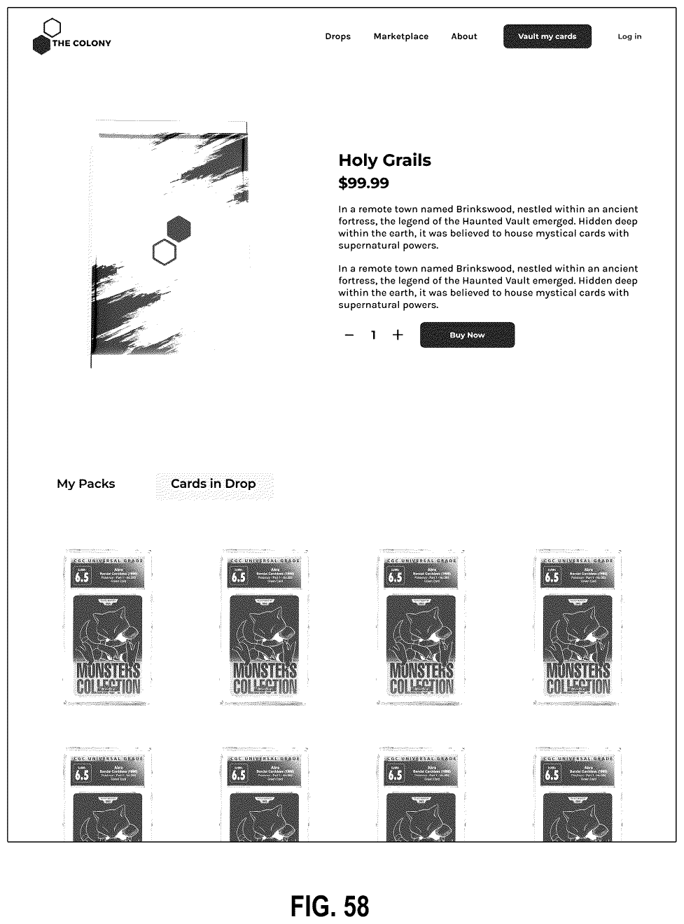

FIG. 58 illustrates an example screenshot of a Front End collectibles GUI showing all cards in a live drop collection.

FIG. 59 illustrates an example screenshot of a Front End collectibles GUI checkout page.

FIG. 60 illustrates an example screenshot of a Front End collectibles GUI for tokenized collectible NFT purchase confirmation.

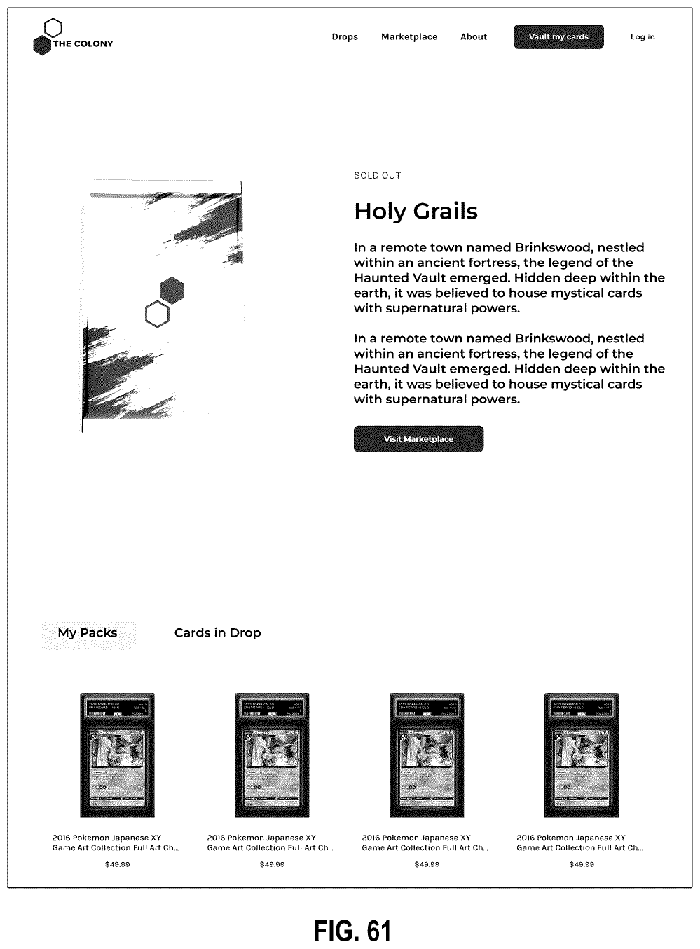

FIG. 61 illustrates an example screenshot of a Front End collectibles GUI for a sold-out scenario in a collectibles drop page.

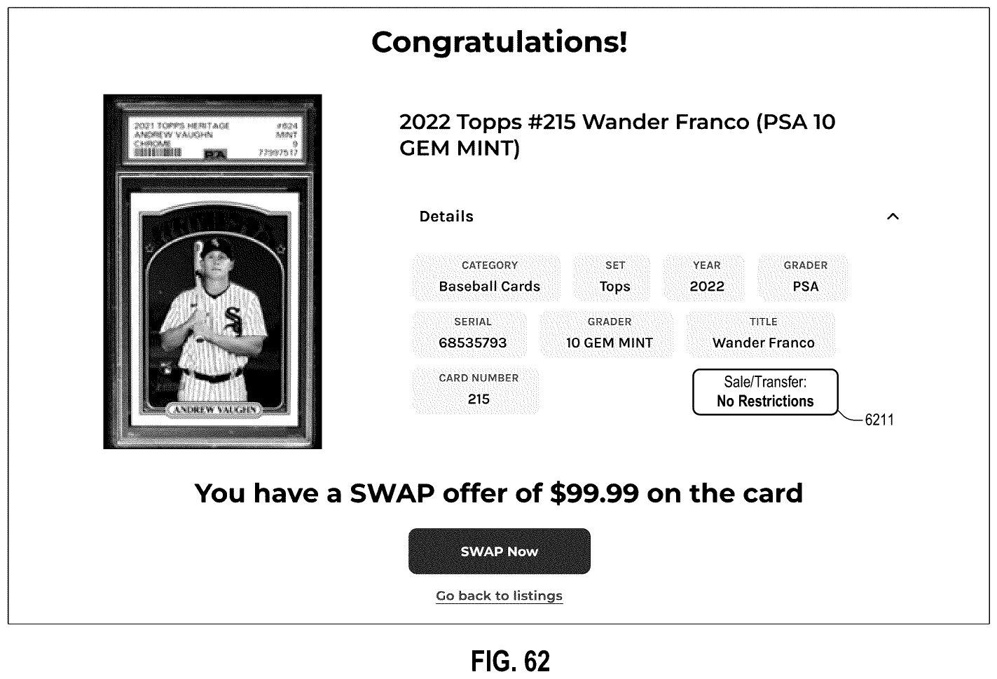

FIG. 62 illustrates an example screenshot of a Front End collectibles GUI for the reveal of a purchased tokenized collectible NFT and automatic presentation of a buyback offer.

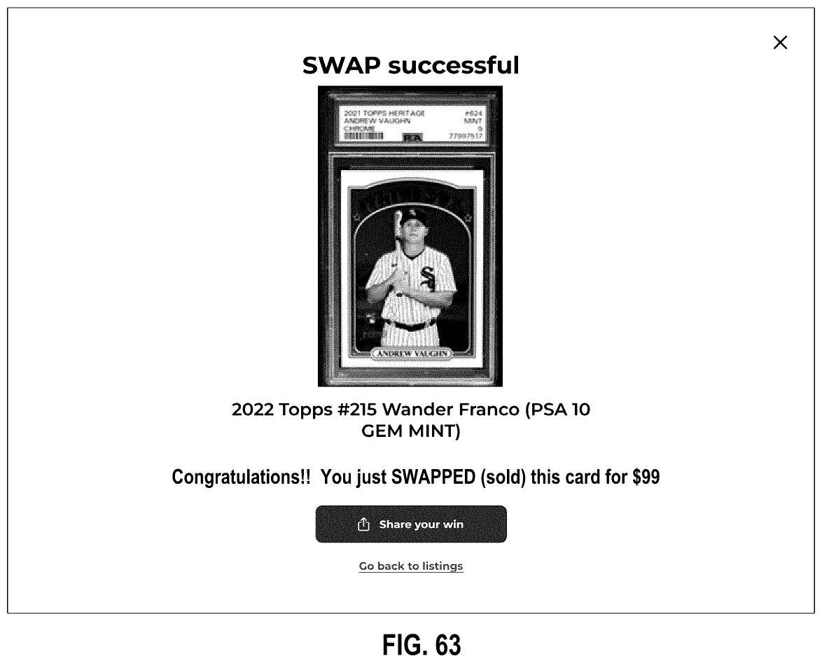

FIG. 63 illustrates an example screenshot of a Front End collectibles GUI for a confirmation of a successful buyback transaction of a tokenized collectible NFT.

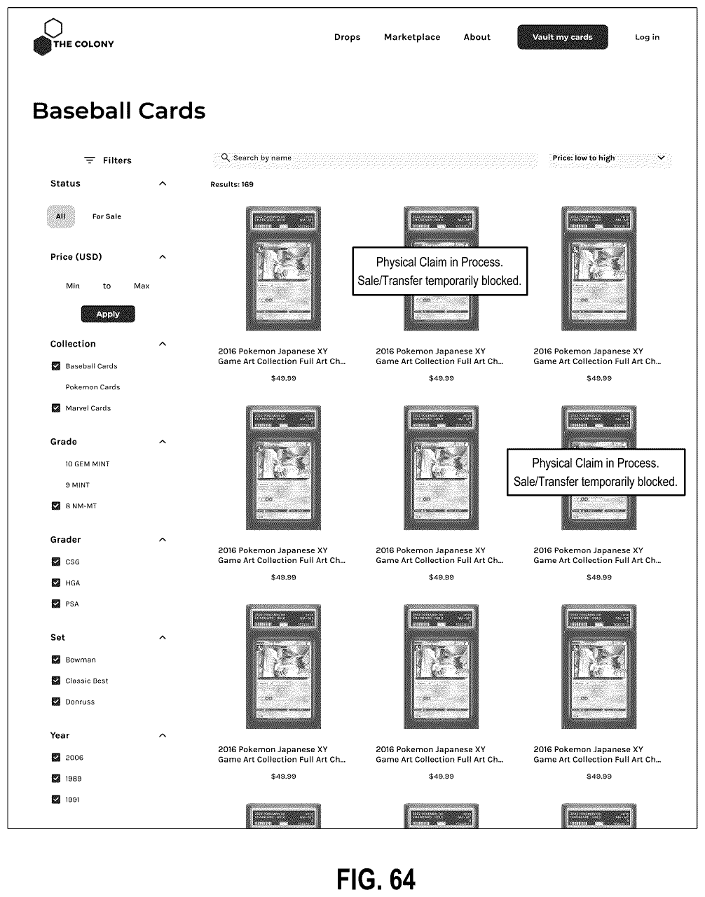

FIG. 64 illustrates an example screenshot of a Front End collectibles GUI for the tokenized collectible NFT marketplace.

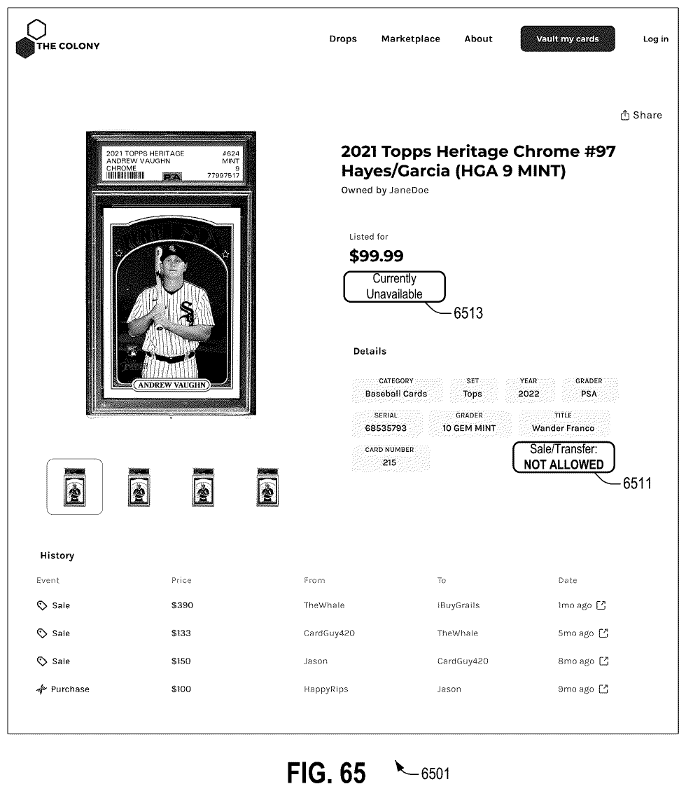

FIG. 65 illustrates an example screenshot of a Front End collectibles GUI for marketplace item details of a listed tokenized collectible NFT.

The Artist/Creator Portal is a platform designed to facilitate the minting, management, and swapping of NFTs. It offers a comprehensive suite of features, including wallet connectivity, analytics, and a unique swap mechanism.

### Example Technical Specifications:

Platform Compatibility: The portal is built to operate on the Ethereum and Polygon blockchains.
Wallet Connectivity:
   Users can connect their cryptocurrency wallets to the portal.
   Supported wallets include, but are not limited to, Metamask, Wallet Connect, Trust Wallet, etc.
   The portal provides a list of commonly used wallets for user convenience.
Minting Process:
   Users can initiate a minting process by selecting “Create a mint”.
   Fields required during the minting process include: Mint name, Mint description, Mint start/end dates and times, Swap window start/end dates and times, Commission percentage, Royalty percentage, Mint supply, Max mint per wallet, Additional wallets for fund distribution, Metadata and art upload, and Swap table value setting.
Swap Mechanism:
   The swap window is a designated time frame during which users can view the swap value of their minted NFTs.
   Swap values vary based on the rarity of the NFT.
   Users can choose to swap their NFTs for the indicated value during this window. Upon a successful swap, the corresponding NFT is burned, and funds are deposited into the user's account.
Commission and Royalty System:
   Artists can allocate commission percentages to one or multiple wallet addresses.
   The total commission across all addresses is capped at 25%, ensuring that a minimum of 75% of mint funds are directed to the swap pool.

### Security and Privacy:

Wallet Security:
   Users connect their cryptocurrency wallets directly, ensuring that their funds remain secure.
   The platform does not store user funds.
Smart Contract Audits: All smart contracts associated with the portal are audited by accredited third-party vendors to ensure security and reliability.
Data Protection:
   User data, especially wallet information, is protected through robust encryption and security protocols.
   Uploaded metadata and art are safeguarded through encryption measures.

### Interoperability and Token Standards:

Blockchain Compatibility: The portal is designed to be compatible with multiple blockchains.
Token Standards:
   The portal can handle various token standards.
   Artists/creators specify the desired token type (e.g., ERC-20, ERC-721) during the mint creation process.

### Unique Selling Points and Differentiators:

Swap Mechanism: The portal introduces a unique swap mechanism based on NFT rarity, allowing users to potentially gain value from their minted NFTs.
Comprehensive Wallet Support: The portal offers extensive wallet connectivity options, catering to a broad user base.
Multi-Blockchain Support: Unlike many platforms that are restricted to a single blockchain, this portal is versatile and can operate across multiple EVM chains.

The Master Admin Portal (e.g., FIGS. 31-37) is a centralized control interface designed for the designated administrators of the Artist/Creator platform. It offers a suite of features to manage users, mints, and monitor platform analytics.
Authentication and Authorization:
   Access:
      Initial access to the Master Admin Portal is reserved for the co-founders.
      Master admins (co-founders) have the capability to create additional admin accounts.
   Roles & Permissions:
      Master Admins: Have full control over the portal, including creating new admin accounts.
      Admins: Limited to managing users and mints. They cannot create new admin accounts.
User and Mint Management:
   Notifications:
      Email alerts are sent out when an admin creates, edits, or deletes a mint.
      All actions are logged for traceability.
   Mint Modifications:
      Title and description of mints can be edited at any time.
      Changes to mint price or swap table necessitate the deletion and recreation of the mint.
      Upon deletion, all funds are refunded to users, with the platform absorbing associated gas fees.
Dashboard & Analytics:
   Visualization: The dashboard provides both graphical (charts and graphs) and numerical data representations.’
   Data Export: Admins can export dashboard data in both PDF and CSV formats for further analysis.
Audit & Activity Logs:
   Logging Mechanism:
      Every admin action is logged to ensure accountability and traceability.
      Logs provide evidence of actions, detailing who performed what action and when.
   Log Retention & Access:
      Logs may be retained indefinitely.
      Only master admins have access to these logs.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A computerized method for executing a buyback offer in a blockchain-based Non-Fungible token (NFT) collection system, the method comprising:
Identifying an NFT within a blockchain network for evaluation of a buyback offer;
Determining whether a buyback offer window is open for the NFT collection associated with the identified NFT:
Assessing any restrictions on presenting a buyback offer for the identified NFT;
Determining whether traits of the identified NFT are revealed;
Calculating a Composite Trait Score for the identified NFT based on its traits and metadata;
Accessing Buyback Value Table data from an associated smart contract, the data including predetermined values or offer prices indexed based on composite trait score values;
Determining a buyback offer price for the identified NFT using the Composite Trait Score and the Buyback Value Table data;
Determining terms of the buyback offer including the buyback offer price and expiration date;
Presenting the buyback offer to the holder of the identified NFT in accordance with the determined terms;
Receiving a response from the NFT holder regarding acceptance or rejection of the buyback offer; and
Executing a buyback transaction via a smart contract upon acceptance of the buyback offer, including transferring the NFT to a designated wallet and transferring a buyback payment to the NFT holder's wallet.

2. The method of claim 1, wherein identifying the NFT includes retrieving NFT data from the blockchain.

3. The method of claim 1, further comprising analyzing the current date and time against a predefined buyback offer window period set in the NFT collection's smart contract.

4. The method of claim 1, wherein assessing restrictions includes analyzing terms and conditions outlined in the smart contract and any collection-specific rules.

5. The method of claim 1, wherein determining whether traits are revealed includes viewing the NFT's metadata on the blockchain.

6. The method of claim 1, wherein calculating the Composite Trait Score includes applying a scoring algorithm to the NFT's traits and metadata.

7. The method of claim 1, wherein determining the buyback offer price includes utilizing a scoring system that reflects the rarity and uniqueness of the NFT's traits.

8. The method of claim 1, wherein determining the terms of the buyback offer includes setting an expiration date based on platform policies or smart contract rules.

9. The method of claim 1, further comprising communicating the buyback offer to the NFT holder through a platform interface.

10. The method of claim 1, wherein executing the buyback transaction includes initiating the NFT transfer transaction on the blockchain and confirming completion of the payment transaction.

11. A computerized system for executing buyback offers in a blockchain-based Non-Fungible token (NFT) collection environment, the system comprising:
A blockchain network configured to identify NFTs within an NFT collection for buyback offer evaluation;
A timing mechanism to determine the open status of a buyback offer window for the NFT collection;
A restriction assessment module to evaluate any restrictions on presenting a buyback offer for identified NFTs;
A trait revelation assessment module to determine the revelation status of traits for the identified NFTs;
A scoring engine configured to calculate a Composite Trait Score for the identified NFTs based on their traits and metadata;
A smart contract interface to access Buyback Value Table data, which includes predetermined values or offer prices indexed based on Composite Trait Score values;
A buyback offer calculation module to determine a buyback offer price for the identified NFTs using the Composite Trait Score and the Buyback Value Table data;
A terms determination module to establish the terms of the buyback offer including the buyback offer price and expiration date:
An offer presentation interface to present the buyback offer to the holder of the identified NFT in accordance with the determined terms;
A response reception module to receive the NFT holder's acceptance or rejection of the buyback offer; and
A transaction execution module to execute the buyback transaction upon acceptance of the buyback offer, including mechanisms for transferring the NFT to a designated wallet and transferring a buyback payment to the NFT holder's wallet.

12. The system of claim 1, wherein the blockchain network includes a data retrieval module for fetching NFT data.

13. The system of claim 1, wherein the timing mechanism is further configured to analyze the current date and time against a predefined buyback offer window period set in the NFT collection's smart contract.

14. The system of claim 1, wherein the restriction assessment module analyzes terms and conditions outlined in the smart contract and any collection-specific rules.

15. The system of claim 1, wherein the trait revelation assessment module includes a metadata analysis component for viewing the NFT's metadata on the blockchain.

16. The system of claim 1, wherein the scoring engine applies a scoring algorithm to quantify the NFT's traits and metadata.

17. The system of claim 1, wherein the buyback offer calculation module utilizes a scoring system that reflects the rarity and uniqueness of the NFT's traits.

18. The system of claim 1, wherein the terms determination module sets an expiration date based on platform policies or smart contract rules.

19. The system of claim 1, wherein the offer presentation interface communicates the buyback offer through a platform interface.

20. A computerized method for managing a tokenized collectibles drop in a blockchain-based online platform. comprising:
initiating a user login to an online platform, wherein the user navigates to a tokenized collectibles drop page;
enabling the user to purchase one or more unrevealed packs, each pack comprising at least one tokenized collectible trading card, wherein the purchase is recorded on a blockchain;
transferring the purchased digital assets to the user's blockchain account or wallet;
closing the drop purchase window upon selling out of the collectibles drop or reaching a predetermined time. thereby concluding the sales phase of the collectibles drop;
opening a reveal window at a designated time or date, enabling users to reveal traits and details of their purchased tokenized collectible NFTs;
presenting the user with an option to reveal the purchased tokenized collectible NFT;
updating the tokenized collectible NFT to publicly reveal the NFT card's metadata and traits upon user's election to reveal;
dynamically determining a buyback offer value for the revealed tokenized collectible NFT based on its metadata;
presenting a swap/buyback offer to the user for the revealed tokenized collectible NFT;
providing the user with options to list the revealed tokenized collectible NFT for sale, accept the buyback offer. decline the buyback offer, or initiate a claim for the corresponding physical collectible;
executing a buyback transaction, wherein the tokenized collectible NFT is transferred from the user's wallet to a designated wallet upon acceptance of the buyback offer, and a payment is transferred to the user's wallet;
maintaining the revealed tokenized collectible NFT in the user's wallet if the buyback offer is declined; and
initiating a claim procedure for the corresponding physical collectible if elected by the user.
